(19) United States
(12) Patent Application Publication
(10) Pub. No.: US 2020/0285997 A1
(43) Pub. Date: Sep. 10, 2020

(54) NEAR REAL-TIME DETECTION AND CLASSIFICATION OF MACHINE ANOMALIES USING MACHINE LEARNING AND ARTIFICIAL INTELLIGENCE

(71) Applicant: ioCurrents, Inc., Seattle, WA (US)

(72) Inventors: Bhaskar Bhattacharyya, Seattle, WA (US); Samuel Friedman, Seattle, WA (US); Cosmo King, Bellevue, WA (US); Kiersten Henderson, Seattle, WA (US)

(21) Appl. No.: 16/808,106

(22) Filed: Mar. 3, 2020

Related U.S. Application Data
(60) Provisional application No. 62/813,659, filed on Mar. 4, 2019.

(51) Int. Cl. G06N 20/00; G06N 7/00

(52) U.S. Cl. CPC G06N 20/00; G06N 7/00

(57) ABSTRACT

A method of determining anomalous operation of a system includes: capturing a stream of data representing sensed (or determined) operating parameters of the system over a range of operating states, with a stability indicator representing whether the system was operating in a stable state when the operating parameters were sensed; determining statistical properties of the stream of data, including an amplitude-dependent parameter and a variance thereof over time parameter for an operating regime representing stable operation; determining a statistical norm for the statistical properties that distinguish between normal operation and anomalous operation of the system; responsive to detecting that normal and anomalous operation of the system can no longer be reliably distinguished, determining new statistical properties to distinguish between normal and anomalous system operation; and outputting a signal based on whether a concurrent stream of data representing sensed operating parameters of the system represent anomalous operation of the system.

### CROSS-REFERENCE TO RELATED APPLICATIONS

This application claims the benefit of provisional U.S. Application No. 62/813,659, filed Mar. 4, 2019 and entitled “SYSTEM AND METHOD FOR NEAR REAL-TIME DETECTION AND CLASSIFICATION OF MACHINE ANOMALIES USING MACHINE LEARNING,” which is hereby incorporated by reference in its entirety.

### BACKGROUND

### Technical Field

The present disclosure relates to the field of anomaly detection in machines, and more particularly to use of machine learning for near real-time detection of engine anomalies.

### Description of the Related Art

Machine learning has been applied to many different problems. One problem of interest is the analysis of sensor and context information, and especially streams of such information, to determine whether a system is operating normally, or whether the system itself, or the context in which it is operating is abnormal. This is to be distinguished from operating normally under extreme conditions. The technology therefore involves decision-making to distinguish normal from abnormal (anomalous), in the face of noise, and extreme cases.

In many cases, the data is multidimensional, and some context is available only inferentially. Further, decision thresholds should to be sensitive to impact of different types of errors, e.g., type I, type II, type III and type IV.

Anomaly detection is a method to identify whether or not a metric is behaving differently than it has in the past, taking into account trends. This is implemented as one-class classification since only one class (normal) is represented in the training data. A variety of anomaly detection techniques are routinely employed in domains such as security systems, fraud detection and statistical process monitoring.

Anomaly detection methods are described in the literature and used extensively in a wide variety of applications in various industries. The available techniques comprise (Chandola et al., 2009; Olson et al., 2018; Kanarachos et al., 2017; Zheng et al., 2016): classification methods that are rule-based, or based on Neural Networks (see, en.wikipedia.org/wiki/Neural_network), Bayesian Networks (see, en.wikipedia.org/wiki/Bayesian_network), or Support Vector Machines (see, en.wikipedia.org/wiki/Support-vector_machine); nearest neighbor based methods, (see, en.wikipedia.org/wiki/Nearest_neighbour_distribution) including k-nearest neighbor (see, en.wikipedia.org/wiki/K-nearest_neighbors_algorithm) and relative density; clustering based methods (see, en.wikipedia.org/wiki/Cluster_analysis); and statistical and fuzzy set-based techniques, including parametric and non-parametric methods based on histograms or kernel functions.

In pattern recognition, the k-nearest neighbors algorithm (k-NN) is a non-parametric method used for classification and regression. In both cases, the input consists of the k closest training examples in the feature space. The output depends on whether k-NN is used for classification or regression: In k-NN classification, the output is a class membership. An object is classified by a plurality vote of its neighbors, with the object being assigned to the class most common among its k nearest neighbors (k is a positive integer, typically small). If k=1, then the object is simply assigned to the class of that single nearest neighbor. In k-NN regression, the output is the property value for the object. This value is the average of the values of its k nearest neighbors. k-NN is a type of instance-based learning, or lazy learning, where the function is only approximated locally and all computation is deferred until classification. The k-NN algorithm is among the simplest of all machine learning algorithms. Both for classification and regression, a useful technique can be used to assign weight to the contributions of the neighbors, so that the nearer neighbors contribute more to the average than the more distant ones. For example, a common weighting scheme consists in giving each neighbor a weight of 1/d, where d is the distance to the neighbor. The neighbors are taken from a set of objects for which the class (for k-NN classification) or the object property value (for k-NN regression) is known. This can be thought of as the training set for the algorithm, though no explicit training step is required. The k-NN algorithm is that it is sensitive to the local structure of the data.

Zhou et al. (2006) describes issues involved in characterizing ensemble similarity from sample similarity. Let Ω denote the space of interest. A sample is an element in the space Ω. Suppose that α∈Ω and β∈Ω are two samples, the sample similarity function is a two-input function k(α, β) that measures the closeness between α and β. An ensemble is a subset of Ω that contains multiple samples. Suppose that [symbol] {α₁, . . . , α_{M}}, with αᵢ∈Ω, and [symbol] ={β₁, . . . , β_{N}}, with βⱼ∈Ω, are two ensembles, where M and N are not necessarily the same, the ensemble similarity is a two-input function k( [symbol] , [symbol] ) that measures the closeness between [symbol] and [symbol] . Starting from the sample similarity k(α, β), the ideal ensemble similarity k( [symbol] , [symbol] ) should utilize all possible pairwise similarity functions between all elements in [symbol] and [symbol] . All these similarity functions are encoded in the so-called Gram matrix. Examples of ad hoc construction of the ensemble similarity function k( [symbol] , [symbol] ) include taking the mean or median of the cross dot product, i.e., the upper right corner of the above Gram matrix. An ensemble [symbol] is thought of as a set of i.i.d. realizations from an underlying probability distribution [symbol] (α). Therefore, the ensemble similarity is an equivalent description of the distance between two probability distributions, i.e., the probabilistic distance measure. By denoting the probabilistic distance measure by J( [symbol] , [symbol] ), we have k( [symbol] , [symbol] )=J( [symbol] , [symbol] ).

Probabilistic distance measures are important quantities and find their uses in many research areas such as probability and statistics, pattern recognition, information theory, communication and so on. In statistics, the probabilistic distances are often used in asymptotic analysis. In pattern recognition, pattern separability is usually evaluated using probabilistic distance measures such as Chernoff distance or Bhattacharyya distance because they provide bounds for probability of error. In information theory, mutual information, a special example of Kullback-Leibler (KL) distance or relative entropy is a fundamental quantity related to channel capacity. In communication, the KL divergence and Bhattacharyya distance measures are used for signal selection. However, there is a gap between the sample similarity function k(α, β) and the probabilistic distance measure J( [symbol] , [symbol] ). Only when the space Ω is a vector space say Ω= [symbol] ^{d} and the similarity function is the regular inner product k(α, β)=α^{T}β, the probabilistic distance measures J coincide with those defined on [symbol] ^{d}. This is due to the equivalence between the inner product and the distance metric.

∥α−β∥²=α^{T}α−2α^{T}β+β^{T}β=k(α,α)−2k(α,β)+k(β,β).

This leads to consideration of kernel methods, in which the sample similarity function k(α,β) evaluates the inner product in a nonlinear feature space R^{f}.

k(α,β)=φ(α)^{T}φ(β), (1)

where φ: Ω→ [symbol] ^{f} is a nonlinear mapping, where f is the dimension of the feature space. This is the so-called “kernel trick”. The function k(α,β) in Eq. (1) is referred to as a reproducing kernel function. The nonlinear feature space is referred to as reproducing kernel Hilbert space (RKHS) [symbol] ^{k} induced by the kernel function k. For a function to be a reproducing kernel, it must be positive definite, i.e., satisfying the Mercer's theorem. The distance metric in the RKHS can be evaluated

∥ϕ(α)−ϕ(β)∥²=Φϕα)^{T}ϕ(α)−2ϕ(α)^{T}ϕ(β)+ϕ(β)^{T}ϕ(β)=k(α,α)−2k(α,β)+k(β,β) (2)

Suppose that N(x;μ,Σ₁) with x∈ [symbol] ^{d} is a multivariate Gaussian density defined as N(x;μ,Σ₁)=1/(√((2π)^{d} |E| exp{−½(x−μ)^{T}Σ⁻¹(x−μ)},
where x∈ [symbol] ^{d} and |⋅| is matrix determinant. With p₁(x)=N(x;μ₁,Σ₁) and p₂(x)=N(x;μ₂,Σ₂), the tables below list some probabilistic distances between two Gaussian densities.
When the covariance matrices for two densities are the same, i.e., Σ₁=Σ₂=Σ, the Bhattacharyya distance and the symmetric divergence reduce to the Mahalanobis distance: J_{M}=J_{D}=8J_{B}:

| Distance Type | Definition |
|---|---|
| Chernoff distance [22] | J_{C}(p₁, p₂) = −log{∫ₓ p₁^{α}^{₂} (x)p₂^{α}^{₁} (x) dx} |
| Bhattacharyya distance | J_{B}(p₁, p₂) = −log{∫ₓ [p₁(x) p₂(x)]^{1/2} dx} |
| [23] | |
| Matusita distance [24] | ${J}_{T} ( {p}_{1} , {p}_{2} ) = {\{ {\int }_{x}^{ } {[ \sqrt{{p}_{1} ( x )} - \sqrt{{p}_{2} ( x )} ]}^{2} d x \}}^{1 / 2}$ |
| KL divergence [3] | ${J}_{R} ( {p}_{1} \vert \vert {p}_{2} ) = {\int }_{x} {p}_{1} ( x ) log \{ \frac{{p}_{1} ( x )}{{p}_{2} ( x )} \} d x$ |
| Symmetric KL divergence [3] | ${J}_{D} ( {p}_{1} , {p}_{2} ) = {\int }_{x} [ {p}_{1} ( x ) - {p}_{2} ( x ) ] log \frac{{p}_{1} ( x )}{{p}_{2} ( x )} d x$ |
| Patrick-Fisher distance | J_{P}(p₁, p₂) = {∫ₓ [p₁(x)π₁ − p₂(x)π₂]² dx}^{1/2} |
| [25] | |
| Lissack-Fu distance | J_{L}(p₁, p₂) = ∫ₓ \|p₁(x)π₁ − p₂(x)π₂\|^{α}^{₁} [p₁(x)π₁ + |
| [26] | p₂(x)π₂]^{α}^{₂} dx |
| Kolmogorov distance | J_{K}(p₁, p₂) = ∫ₓ \|p₁(x)π₁ − p₂(x)π₂\| dx |
| [27] | |

| Distance Type | Analytic Expression |
|---|---|
| Chernoff distance | $\begin{matrix}{J}_{C} ( {p}_{1} , {p}_{2} ) = \frac{1}{2} {α}_{1} {{{α}_{2} ( {μ}_{1} - {μ}_{2} )}^{T} [ {α}_{1} {Σ}_{1} + {α}_{2} {Σ}_{2} ]}^{- 1} \\ ( {μ}_{1} - {μ}_{2} ) + \frac{1}{2} log \frac{\vert {α}_{1} {Σ}_{1} + {α}_{2} {Σ}_{2} \vert}{{\vert {Σ}_{1} \vert}^{{α}_{1}} {\vert {Σ}_{2} \vert}^{{α}_{2}}}\end{matrix}$ |
| Bhattacharyya distance | $\begin{matrix}{J}_{B} ( {p}_{1} , {p}_{2} ) = \frac{1}{8} {{( {μ}_{1} - {μ}_{2} )}^{T} [ \frac{1}{2} ( {Σ}_{1} + {Σ}_{2} ) ]}^{- 1} \\ ( {μ}_{1} - {μ}_{2} ) + \frac{1}{2} log \frac{\vert \frac{1}{2} ( {Σ}_{1} + {Σ}_{2} ) \vert}{{\vert {Σ}_{1} \vert}^{1 / 2} {\vert {Σ}_{2} \vert}^{1 / 2}}\end{matrix}$ |
| KL divergence | $\begin{matrix}{J}_{R} ( {p}_{1} \vert \vert {p}_{2} ) = \frac{1}{2} {( {μ}_{1} - {μ}_{2} )}^{T} {Σ}_{2}^{- 1} ( {μ}_{1} - {μ}_{2} ) + \\ \frac{1}{2} log \frac{\vert {Σ}_{2} \vert}{\vert {Σ}_{1} \vert} + \frac{1}{2} tr [ {Σ}_{1} {Σ}_{2}^{- 1} - {I}_{d} ]\end{matrix}$ |
| Symmetric KL divergence | $\begin{matrix}{J}_{D} ( {p}_{1} , {p}_{2} ) = \frac{1}{2} {( {μ}_{1} - {μ}_{2} )}^{T} ( {Σ}_{1}^{1} + {Σ}_{2}^{1} ) ( {μ}_{1} - {μ}_{2} ) + \\ \frac{1}{2} tr [ {Σ}_{1}^{1} {Σ}_{2} + {Σ}_{2}^{1} {Σ}_{1} - 2 {I}_{d} ]\end{matrix}$ |
| Patrick-Fisher distance | $\begin{matrix}{J}_{P} ( {p}_{1} , {p}_{2} ) = {[ {( 2 π )}^{d} \vert 2 {Σ}_{1} \vert ]}^{- 1 / 2} + \\ {[ {( 2 π )}^{d} \vert 2 {Σ}_{2} \vert ]}^{- 1 / 2} - {[ {( 2 π )}^{d} \vert {Σ}_{1} + {Σ}_{2} \vert ]}^{- 1 / 2} \\ exp \{ - \frac{1}{2} {( {μ}_{1} - {μ}_{2} )}^{T} {( {Σ}_{1} + {Σ}_{2} )}^{- 1} ( {μ}_{1} - {μ}_{2} ) \}\end{matrix}$ |
| Mahalanobis distance | J_{M}(p₁, p₂) = (μ₁ − μ₂)^{T} Σ⁻¹(μ₁ − μ₂) |

[1] P. Devijver and J. Kittler, Pattern Recognition: A Statistical Approach. Prentice Hall International, 1982.
[2] R. O. Duda, P. E. Hart, and D. G. Stork, Pattern Classification. Wiley-Interscience, 2001.
[3] T. M. Cover and J. A. Thomas, Elements of Information Theory. Wiley, 1991.
[4] T. Kailath, “The divergence and Bhattacharyya distance measures in signal selection,” IEEE Trans. on Communication Technology, vol. COM-15, no. 1, pp. 52-60, 1967.
[5] J. Mercer, “Functions of positive and negative type and their connection with the theory of integral equations,” Philos. Trans. Roy. Soc. London, vol. A 209, pp. 415-446, 1909.
[6] N. Aronszajn, “Theory of reproducing kernels,” Transactions of the American Mathematics Society, vol. 68, no. 3, pp. 337-404, 1950.
[7] B. Schölkopf, A. Smola, and K.-R. Müller, “Nonlinear component analysis as a kernel eigenvalue problem,” Neural Computation, vol. 10, no. 5, pp. 1299-1319, 1998.
[8] G. Baudat and F. Anouar, “Generalized discriminant analysis using a kernel approach,” Neural Computation, vol. 12, no. 10, pp. 2385-2404, 2000.
[9] F. Bach and M. I. Jordan, “Kernel independent component analysis,” Journal of Machine Learning Research, vol. 3, pp. 1-48, 2002.
[10] Bach, Francis R., and Michael I. Jordan. “Learning graphical models with Mercer kernels.” In Advances in Neural Information Processing Systems, pp. 1033-1040. 2003.
[11] R. Kondon and T. Jebara, “A kernel between sets of vectors,” International Conference on Machine Learning (ICML), 2003.
[12] Z. Zhang, D. Yeung, and J. Kwok, “Wishart processes: a statistical view of reproducing kernels,” Technical Report KHUSTCS401-01, 2004.
[13] V. N. Vapnik, The Nature of Statistical Learning Theory. Springer-Verlag, New York, ISBN 0-387-94559-8, 1995.
[14] H. Lodhi, C. Saunders, J. Shawe-Taylor, N. Cristianini, and C. Watkins, “Text classification using string kernels,” Journal of Machine Learning Research, vol. 2, pp. 419-444, 2002.
[15] R. Kondor and J. Lafferty, “Diffusion kernels on graphs and other discrete input spaces,” ICML, 2002.
[16] C. Cortes, P. Haffner, and M. Mohri, “Lattice kernels for spoken-dialog classification,” ICASSP, 2003.
[17] T. Jaakkola and D. Haussler, “Exploiting generative models in discriminative classifiers,” NIPS, vol. 11, 1999.
[18] K. Tsuda, M. Kawanabe, G. RAtsch, S. Sonnenburg, and K. Müller, “A new discriminative kernel from probabilistic models,” NIPS, vol. 14, 2002.
[19] M. Seeger, “Covariances kernel from Bayesian generative models,” NIPS, vol. 14, pp. 905-912, 2002.
[20] M. Collins and N. Duffy, “Convolution kernels for natural language,” NIPS, vol. 14, pp. 625-632, 2002.
[21] L. Wolf and A. Shashua, “Learning over sets using kernel principal angles,” Journal of Machine Learning Research, vol. 4, pp. 895-911, 2003.
[22] H. Chernoff, “A measure of asymptotic efficiency of tests for a hypothesis based on a sum of observations,” Annals of Mathematical Statistics, vol. 23, pp. 493-507, 1952.
[23] A. Bhattacharyya, “On a measure of divergence between two statistical populations defined by their probability distributions,” Bull. Calcutta Math. Soc., vol. 35, pp. 99-109, 1943.
[24] K. Matusita, “Decision rules based on the distance for problems of fit, two samples and estimation,” Ann. Math. Stat., vol. 26, pp. 631-640, 1955.
[25] E. Patrick and F. Fisher, “Nonparametric feature selection,” IEEE Trans. Information Theory, vol. 15, pp. 577-584, 1969.
[26] T. Lissack and K. Fu, “Error estimation in pattern recognition via L-distance between posterior density functions,” IEEE Trans. Information Theory, vol. 22, pp. 34-45, 1976.
[27] B. Adhikara and D. Joshi, “Distance discrimination et resume exhaustif,” Publs. Inst. Statis., vol. 5, pp. 57-74, 1956.
[28] P. Mahalanobis, “On the generalized distance in statistics,” Proc. National Inst. Sci. (India), vol. 12, pp. 49-55, 1936.
[29] T. Hastie, R. Tibshirani, and J. Friedman, The Elements of Statistical Learning: Data Mining, Inference, and Prediction. Springer-Verlag, New York, 2001.
[30] M. Tipping, “Sparse kernel principal component analysis,” Neural Information Processing Systems, 2001.
[31] L. Wolf and A. Shashua, “Kernel principal angles for classification machines with applications to image sequence interpretation,” IEEE Computer Society Conference on Computer Vision and Pattern Recognition, 2003.
[32] T. Jebara and R. Kondon, “Bhattarcharyya and expected likelihood kernels,” Conference on Learning Theory (COLT), 2003.
[33] N. Vasconcelos, P. Ho, and P. Moreno, “The Kullback-Leibler kernel as a framework for discriminant and localized representations for visual recognition,” European Conference on Computer Vision, 2004.
[34] P. Moreno, P. Ho, and N. Vasconcelos, “A Kullback-Leibler divergence based kernel for svm classfication in multimedia applications,” Neural Information Processing Systems, 2003.
[35] G. Shakhnarovich, J. Fisher, and T. Darrell, “Face recognition from long-term observations,” European Conference on Computer Vision, 2002.
[36] K. Lee, M. Yang, and D. Kriegman, “Video-based face recognition using probabilistic appearance manifolds,” IEEE Computer Society Conference on Computer Vision and Pattern Recognition, 2003.
[37] T. Jebara, “Images as bags of pixels,” Proc. of IEEE International Conference on Computer Vision, 2003.
[38] M. Turk and A. Pentland, “Eigenfaces for recognition,” Journal of Cognitive Neutoscience, vol. 3, pp. 72-86, 1991.
[39] K. V. Mardia, J. T. Kent, and J. M. Bibby, Multivariate Analysis. Academic Press, 1979.
[40] M. E. Tipping and C. M. Bishop, “Probabilistic principal component analysis,” Journal of the Royal Statistical Society, Series B, vol. 61, no. 3, pp. 611-622, 1999.

A support vector data description (SVDD) method based on radial basis function (RBF) kernels may be used, while reducing computational complexity in the training phase and the testing phase for anomaly detection. The advantages of support vector machines (SVMs) is that generalization ability is improved by proper selection of kernels. Mahalanobis kernels exploit the data distribution information more than RBF kernels do. Trinh et al. 2017 develop an SVDD using Mahalanobis kernels with adjustable discriminant thresholds, with application to anomaly detection in a real wireless sensor network data set. An SVDD method aims to estimate a sphere with minimum volume that contains all (or most of) the data. It is also generally assumed that these training samples belong to an unknown distribution.
[1] M. Xie, S. Han, B. Tian, and S. Parvin, “Anomaly detection in wireless sensor networks: A survey,” Journal of Network and Computer Applications, vol. 34, no. 4, pp. 1302-1325, 2011. [Online]. Available: dx.doi.org/10.1016/j.jnca.2011.03.004
[2] A. Sharma, L. Golubchik, and R. Govindan, “Sensor faults: Detection methods and prevalence in real-world datasets,” ACM Transactions on Sensor Networks (TOSN), vol. 6, no. 3, p. 23, 2010.
[3] J. Ilonen, P. Paalanen, J. Kamarainen, and H. Kalviainen, “Gaussian mixture pdf in one-class classification: computing and utilizing confidence values,” in Pattern Recognition, 2006. ICPR 2006. 18th International Conference on, vol. 2. IEEE, 2006, pp. 577-580.
[4] D. A. Clifton, S. Hugueny, and L. Tarassenko, “Novelty detection with multivariate extreme value statistics,” Journal of signal processing systems, vol. 65, no. 3, pp. 371-389, 2011.
[5] K. P. Tran, P. Castagliola, and G. Celano, “Monitoring the Ratio of Two Normal Variables Using Run Rules Type Control Charts,” International Journal of Production Research, vol. 54, no. 6, pp. 1670-1688, 2016.
[6] K. P. Tran, P. Castagliola, and G. Celano, “Monitoring the Ratio of Two Normal Variables Using EWMA Type Control Charts,” Quality and Reliability Engineering International, 2015, in press, DOI: 10.1002/qre.1918.
[7] V. Chandola, A. Banerjee, and V. Kumar, Anomaly Detection. Boston, Mass.: Springer US, 2016, pp. 1-15.
[8] K. P. Tran and K. P. Tran, “The Efficiency of CUSUM schemes for monitoring the Coefficient of Variation,” Applied Stochastic Models in Business and Industry, vol. 32, no. 6, pp. 870-881, 2016.
[9] K. P. Tran, P. Castagliola, and G. Celano, “Monitoring the Ratio of Population Means of a Bivariate Normal distribution using CUSUM Type Control Charts,” Statistical Papers, 2016, in press, DOI: 10.1007/s00362-016-0769-4.
[10] K. P. Tran, P. Castagliola, and N. Balakrishnan, “On the performance of shewhart median chart in the presence of measurement errors,” Quality and Reliability Engineering International, 2016, in press, DOI: 10.1002/qre.2087.
[11] K. P. Tran, “The efficiency of the 4-out-of-5 Runs Rules scheme for monitoring the Ratio of Population Means of a Bivariate Normal distribution,” International Journal of Reliability, Quality and Safety Engineering, 2016, in press, DOI: 10.1142/S0218539316500200.
[12] K. P. Tran, “Run Rules median control charts for monitoring process mean in manufacturing,” Quality and Reliability Engineering International, 2017, in press, DOI: 10.1002/qre.2201.
[13] T. V Vuong, K. P Tran, and T. Truong, “Data driven hyperparameter optimization of one-class support vector machines for anomaly detection in wireless sensor networks,” in Proceedings of the 2017 International Conference on Advanced Technologies for Communications, 2017.
[14] L. Billy, N. Wijerathne, B. K. K. Ng, and C. Yuen, “Sensor fusion for public space utilization monitoring in a smart city,” IEEE Internet of Things Journal, 2017.
[15] S. Rajasegarar, C. Leckie, and M. Palaniswami, “Hyperspherical cluster based distributed anomaly detection in wireless sensor networks,” Journal of Parallel and Distributed Computing, vol. 74, no. 1, pp. 1833-1847, 2014. [Online]. Available: dx.doi.org/10.1016/j.jpdc. 2013.09.005
[16] D. M. J. Tax and R. P. W. Duin, “Support Vector Data Description,” Machine Learning, vol. 54, no. 1, pp. 45-66, 2004.
[17] Z. Feng, J. Fu, D. Du, F. Li, and S. Sun, “A new approach of anomaly detection in wireless sensor networks using support vector data description,” International Journal of Distributed Sensor Networks, vol. 13, no. 1, p. 1550147716686161, 2017.
[18] V. N. Vapnik, Statistical Learning Theory, 1998, vol. pp.
[19] S. Abe, “Training of support vector machines with mahalanobis kernels,” Artificial Neural Networks: Formal Models and Their Applications—ICANN 2005, pp. 750-750, 2005.
[20] E. Maboudou-Tchao, I. Silva, and N. Diawara, “Monitoring the mean vector with mahalanobis kernels,” Quality Technology & Quantitative Management, pp. 1-16, 2016.
[21] B. Schölkopf, J. C. Platt, J. Shawe-Taylor, A. J. Smola, and R. C. Williamson, “Estimating the support of a high-dimensional distribution,” Neural computation, vol. 13, no. 7, pp. 1443-1471, 2001.
[22] W.-C. Chang, C.-P. Lee, and C.-J. Lin, “A revisit to support vector data description,” Dept. Comput. Sci., Nat. Taiwan Univ., Taipei, Taiwan, Tech. Rep, 2013.
[23] B. Scholkopf, “The kernel trick for distances,” Advances in Neural Information Processing Systems 13, vol. 13, pp. 301-307, 2001.
[24] J. Shawe-Taylor and N. Cristianini, Kernel methods for pattern analysis. Cambridge university press, 2004.
[25] M. M. Breunig, H.-P. Kriegel, R. T. Ng, and J. Sander, “Lof: identifying density-based local outliers,” in ACM sigmod record, vol. 29, no. 2. ACM, 2000, pp. 93-104.
[26] A. Theissler and I. Dear, “Autonomously determining the parameters for svdd with rbf kernel from a one-class training set.”
[27] J. Mockus, Bayesian approach to global optimization. theory and applications. Springer Science & Business Media, 2012, vol. 37.
[28] P. Buonadonna, D. Gay, J. M. Hellerstein, W. Hong, and S. Madden, “TASK: Sensor network in a box,” Proceedings of the Second European Workshop on Wireless Sensor Networks, EWSN 2005, vol. 2005, pp. 133-144, 2005.
[29] S. G. Johnson, “The nlopt nonlinear-optimization package,” ab-initio.mit.edu/nlopt.

Gillespie et al. (2017) describe real-time analytics at the edge: identifying abnormal equipment behavior and filtering data near the edge for internet of things applications. A machine learning technique for anomaly detection uses the SAS® Event Stream Processing engine to analyze streaming sensor data and determine when performance of a turbofan engine deviates from normal operating conditions. Sensor readings from the engines are used to detect asset degradation and help with preventative maintenance applications. A single-class classification machine learning technique, called SVDD, is used to detect anomalies within the data. The technique shows how each engine degrades over its life cycle. This information can then be used in practice to provide alerts or trigger maintenance for the particular asset on an as-needed basis. Once the model was trained, the score code was deployed on to a thin client device running SAS® Event Stream Processing, to validate scoring the SVDD model on new observations and simulate how the SVDD model might perform in Internet of Things (IoT) edge applications.

IoT processing at the edge, or edge computing, pushes the analytics from a central server to devices close to where the data is generated. As such, edge computing moves the decision making capability of analytics from centralized nodes closer to the source of the data. This can be important for several reasons. It can help to reduce latency for applications where speed is critical. And it can also reduce data transmission and storage costs through the use of intelligent data filtering at the edge device. In Gillespie et al.'s case, sensors from a fleet of turbofan engines were evaluated to determine engine degradation and future failure. A scoring model was constructed to be able to do real-time detection of anomalies indicating degradation.

SVDD is a machine learning technique that can be used to do single-class classification. The model creates a minimum radius hypersphere around the training data used to build the model. The hypersphere is made flexible through the use of Kernel functions (Chaudhuri et al. 2016). As such, SVDD is able to provide a flexible data description on a wide variety of data sets. The methodology also does not require any assumptions regarding normality of the data, which can be a limitation with other anomaly detection techniques associated with multivariate statistical process control. If the data used to build the model represents normal conditions, then observations that lie outside of the hypersphere can represent possible anomalies. These might be anomalies that have previously occurred or new anomalies that would not have been found in historical data. Since the model is trained with data that is considered normal, the model can score any observation as abnormal even if it has not seen an abnormal example before.

To train the model, data from a small set of engines within the beginning of the time series that were assumed to be operating under normal conditions were sampled. The SVDD algorithm was constructed using a range of normal operating conditions for the equipment or system. For example, a haul truck within a mine might have very different sensor data readings when it is traveling on a flat road with no payload and when it is traveling up a hill with ore. However, both readings represent normal operating conditions for the piece of equipment. The model was trained using the svddTrain action from the svdd action set within SAS Visual Data Mining and Machine Learning. The ASTORE scoring code generated by the action was then saved to be used to score new observations using SAS Event Stream Processing on a gateway device. A Dell Wyse 3290 was set up with Wind River Linux and SAS Event Stream Processing (ESP). An ESP model was built to take the incoming observations, score them using the ASTORE code generated by the VDMML program and return a scored distance metric for each observation. This metric could then be used to monitor degradation and create a flag that could trigger an alert if above a specified threshold.

The results from Gillespie et al. revealed that each engine has a relatively stable normal operating state for the first portion of its useful life, followed by a sloped upward trend in the distance metric leading up to a failure point. This upward trend in the data indicated that the observations move further and further from the centroid of the normal hypersphere created by the SVDD model. As such, the engine operating conditions moved increasingly further from normal operating behavior. With increasing distance indicating potential degradation, an alert can be set to be triggered if the scored distance begins to rise above a pre-determined threshold or if the moving average of the scored distance deviates a certain percentage from the initial operating conditions of the asset. This can be tailored to the specific application that the model is used to monitor.

Brandsaeter et al. (2017) provide an on-line anomaly detection methodology applied in the maritime industry and propose modifications to an anomaly detection methodology based on signal reconstruction followed by residuals analysis. The reconstructions are made using Auto Associative Kernel Regression (AAKR), where the query observations are compared to historical observations called memory vectors representing normal operation. When the data set with historical observations grows large, the naive approach where all observations are used as memory vectors will lead to unacceptable large computational loads, hence a reduced set of memory vectors should be intelligently selected. The residuals between the observed and the reconstructed signals are analyzed using standard Sequential Probability Ratio Tests (SPRT), where appropriate alarms are raised based on the sequential behavior of the residuals. Brandsaeter et al. employ a cluster based method to select memory vectors to be considered by the AAKR, which reduces computation time; a generalization of the distance measure, which makes it possible to distinguish between explanatory and response variables; and a regional credibility estimation used in the residuals analysis, to let the time used to identify if a sequence of query vectors represents an anomalous state or not, depend on the amount of data situated close to or surrounding the query vector. The anomaly detection method was tested for analysis of operation of marine diesel engine in normal operation, and the data was manually modified to synthesize faults.

Anomaly detection refers to the problem of finding patterns in data that do not conform to expected behavior (Chandola et al., 2009). In other words, anomalies can be defined as observations, or subset of observations, which are inconsistent with the reminder of the data set (Hodge and Austin, 2004; Barnett et al., 1994). Depending on the field of research and application, anomalies are also often referred to as outliers, discordant observations, exceptions, aberrations, surprises, peculiarities or contaminants (Hodge and Austin, 2004; Chandola et al., 2009). Anomaly detection is related to, but distinct from noise removal (Chandola et al., 2009).

The fundamental approaches to the problem of anomaly detection can be divided into three categories (Hodge and Austin, 2004; Chandola et al., 2009):

Supervised anomaly detection. Availability of a training data set with labelled instances for normal and anomalous behavior is assumed. Typically, predictive models are built for normal and anomalous behavior, and unseen data are assigned to one of the classes.

Unsupervised anomaly detection. Here, the training data set is not labelled, and an implicit assumption is that the normal instances are far more frequent than anomalies in the test data. If this assumption is not true, then such techniques suffer from high false alarm rate.

Semi-supervised anomaly detection. In semi-supervised anomaly detection, the training data only includes normal data. A typical anomaly detection approach is to build a model for the class corresponding to normal behavior and use the model to identify anomalies in the test data. Since the semi-supervised and unsupervised methods do not require labels for the anomaly class, they are more widely applicable than supervised techniques.

Ahmad et al. (2017) discuss unsupervised real-time anomaly detection for streaming data. Streaming data inherently exhibits concept drift, favoring algorithms that learn continuously. Furthermore, the massive number of independent streams in practice requires that anomaly detectors be fully automated. Ahmad et al. propose an anomaly detection technique based on an online sequence memory algorithm called Hierarchical Temporal Memory (HTM). They define an anomaly as a point in time where the behavior of the system is unusual and significantly different from previous, normal behavior. An anomaly may signify a negative change in the system, like a fluctuation in the turbine rotation frequency of a jet engine, possibly indicating an imminent failure. An anomaly can also be positive, like an abnormally high number of web clicks on a new product page, implying stronger than normal demand. Either way, anomalies in data identify abnormal behavior with potentially useful information. Anomalies can be spatial, where an individual data instance can be considered anomalous with respect to the rest of data, independent of where it occurs in the data stream, or contextual, if the temporal sequence of data is relevant; i.e., a data instance is anomalous only in a specific temporal context, but not otherwise. Temporal anomalies are often subtle and hard to detect in real data streams. Detecting temporal anomalies in practical applications is valuable as they can serve as an early warning for problems with the underlying system.

Streaming applications impose unique constraints and challenges for machine learning models. These applications involve analyzing a continuous sequence of data occurring in real-time. In contrast to batch processing, the full dataset is not available. The system observes each data record in sequential order as it is collected, and any processing or learning must be done in an online fashion. At each point in time we would like to determine whether the behavior of the system is unusual. The determination is preferably made in real-time. That is, before seeing the next input, the algorithm must consider the current and previous states to decide whether the system behavior is anomalous, as well as perform any model updates and retraining. Unlike batch processing, data is not split into train/test sets, and algorithms cannot look ahead. Practical applications impose additional constraints on the problem. In many scenarios the statistics of the system can change over time, a problem known as concept drift.

Some anomaly detection algorithms are partially online. They either have an initial phase of offline learning or rely on look-ahead to flag previously-seen anomalous data. Most clustering-based approaches fall under the umbrella of such algorithms. Some examples include Distributed Matching-based Grouping Algorithm (DMGA), Online Novelty and Drift Detection Algorithm (OLINDDA), and Multi-class learNing Algorithm for data Streams (MINAS). Another example is self-adaptive and dynamic k-means that uses training data to learn weights prior to anomaly detection. Kernel-based recursive least squares (KRLS) also violates the principle of no look-ahead as it resolves temporarily flagged data instances a few time steps later to decide if they were anomalous. However, some kernel methods, such as EXPoSE, adhere to our criteria of real-time anomaly detection.

For streaming anomaly detection, the majority of methods used in practice are statistical techniques that are computationally lightweight. These techniques include sliding thresholds, outlier tests such as extreme studentized deviate (ESD, also known as Grubbs') and k-sigma, changepoint detection, statistical hypotheses testing, and exponential smoothing such as Holt-Winters. Typicality and eccentricity analysis is an efficient technique that requires no user-defined parameters. Most of these techniques focus on spatial anomalies, limiting their usefulness in applications with temporal dependencies.

More advanced time-series modeling and forecasting models are capable of detecting temporal anomalies in complex scenarios. ARIMA is a general purpose technique for modeling temporal data with seasonality. It is effective at detecting anomalies in data with regular daily or weekly patterns. Extensions of ARIMA enable the automatic determination of seasonality for certain applications. A more recent example capable of handling temporal anomalies is based on relative entropy. Model-based approaches have been developed for specific use cases, but require explicit domain knowledge and are not generalizable. Domain-specific examples include anomaly detection in aircraft engine measurements, cloud datacenter temperatures, and ATM fraud detection. Kalman filtering is a common technique, but the parameter tuning often requires domain knowledge and choosing specific residual error models. Model-based approaches are often computationally efficient but their lack of generalizability limits their applicability to general streaming applications.

There are a number of other restrictions that can make methods unsuitable for real-time streaming anomaly detection, such as computational constraints that impede scalability. An example is Lytics Anomalyzer, which runs in O(n²), limiting its usefulness in practice where streams are arbitrarily long. Dimensionality is another factor that can make some methods restrictive. For instance, online variants of principle component analysis (PCA) such as osPCA or window-based PCA can only work with high-dimensional, multivariate data streams that can be projected onto a low dimensional space. Techniques that require data labels, such as supervised classification-based methods, are typically unsuitable for real-time anomaly detection and continuous learning.

Ahmad et al. (2017) show how to use Hierarchical Temporal Memory (HTM) networks to detect anomalies on a variety of data streams. The resulting system is efficient, extremely tolerant to noisy data, continuously adapts to changes in the statistics of the data, and detects subtle temporal anomalies while minimizing false positives. Based on known properties of cortical neurons, HTM is a theoretical framework for sequence learning in the cortex. HTM implementations operate in real-time and have been shown to work well for prediction tasks. HTM networks continuously learn and model the spatiotemporal characteristics of their inputs, but they do not directly model anomalies and do not output a usable anomaly score. Rather than thresholding the prediction error directly, Ahmad et al. model the distribution of error values as an indirect metric and use this distribution to check for the likelihood that the current state is anomalous. The anomaly likelihood is thus a probabilistic metric defining how anomalous the current state is based on the prediction history of the HTM model. To compute the anomaly likelihood a window of the last W error values is maintained, and the distribution modelled as a rolling normal distribution where the sample mean, μₜ, and variance, σ², are continuously updated from previous error values. Then, a recent short-term average of prediction errors is computed, and a threshold applied to the Gaussian tail probability (Q-function) to decide whether or not to declare an anomaly. Since thresholding involves thresholding a tail probability, there is an inherent upper limit on the number of alerts and a corresponding upper bound on the number of false positives. The anomaly likelihood is based on the distribution of prediction errors, not on the distribution of underlying metric values. As such, it is a measure of how well the model is able to predict, relative to the recent history.

In clean, predictable scenarios, the anomaly likelihood of the HTM anomaly detection network behaves similarly to the prediction error. In these cases, the distribution of errors will have very small variance and will be centered near 0. Any spike in the prediction error will similarly lead to a corresponding spike in likelihood of anomaly. However, in scenarios with some inherent randomness or noise, the variance will be wider and the mean further from 0. A single spike in the prediction error will not lead to a significant increase in anomaly likelihood but a series of spikes will. A scenario that goes from wildly random to completely predictable will also trigger an anomaly.
doi: 10.1016/j.neucom.2017.04.070.
[1] V. Chandola, V. Mithal, V. Kumar, Comparative evaluation of anomaly detection techniques for sequence data, in: Proceedings of the 2008 Eighth IEEE International Conference on Data Mining, 2008, pp. 743-748, doi:10.1109/ICDM.2008. 151.
[2] A. Lavin, S. Ahmad, Evaluating real-time anomaly detection algorithms—the Numenta anomaly benchmark, in: Proceedings of the 14th International Conference on Machine Learning Application, Miami, Fla., IEEE, 2015, doi:10. 1109/ICMLA.2015.141.
[3] J. Gama, I. Žiobaite, A. Bifet, M. Pechenizkiy, A. Bouchachia, A survey on concept drift adaptation, ACM Comput. Surv. 46 (2014) 1-37, doi:10.1145/2523813.
[4] M. Pratama, J. Lu, E. Lughofer, G. Zhang, S. Anavatti, Scaffolding type-2 classifier for incremental learning under concept drifts, Neurocomputing 191 (2016) 304-329, doi: 10.1016/j.neucom.2016.01.049.
[5] A. J. Fox, Outliers in time series, J. R. Stat. Soc. Ser. B. 34 (1972) 350-363.
[6] V. Chandola, A. Banerjee, V. Kumar, Anomaly detection: a survey, ACM Comput. Surv. 41 (2009) 1-72, doi:10.1145/1541880.1541882.
[7] Wong J. Netflix Surus GitHub, Online Code Repos github.com/Netflix/Surus 2015
[8] N. Laptev, S. Amizadeh, I. Flint, Generic and Scalable Framework for Automated Time-series Anomaly Detection, in: Proceedings of the 21th ACM SIGKDD International Conference on Knowledge Discovery Data Mining, 2015, pp. 1939-1947.
[9] E. Keogh, J. Lin, A. Fu, HOT SAX: Efficiently finding the most unusual time series subsequence, in: Proceedings of the IEEE International Conference on Data Mining, ICDM, 2005, pp. 226-233, doi:10.1109/ICDM.2005.79.
[10] P. Malhotra, L. Vig, G. Shroff, P. Agarwal, Long short term memory networks for anomaly detection in time series, Eur. Symp. Artif. Neural Netw. (2015) 22-24.
[11] H. N. Akouemo, R. J. Povinelli, Probabilistic anomaly detection in natural gas time series data, Int. J. Forecast. 32 (2015) 948-956, doi:10.1016/j.ijforecast. 2015.06.001.
[12] J. Gama, Knowledge Discovery from Data Streams, Chapman and Hall/CRC, Boca Raton, Fla., 2010.
[13] M. A. F. Pimentel, D. A. Clifton, L. Clifton, L. Tarassenko, A review of novelty detection, Signal Process. 99 (2014) 215-249, doi:10.1016/j.sigpro.2013.12.026.
[14] M. M. Gaber, A. Zaslavsky, S. Krishnaswamy, Mining data streams, ACM SIGMOD Rec. 34 (2005) 18.
[15] M. Sayed-Mouchaweh, E. Lughofer, Learning in Non-Stationary Environments: Methods and Applications, Springer, New York, 2012.
[16] M. Pratama, J. Lu, E. Lughofer, G. Zhang, M. J. Er, Incremental learning of concept drift using evolving Type-2 recurrent fuzzy neural network, IEEE Trans. Fuzzy Syst (2016) 1, doi:10.1109/TFUZZ.2016.2599855.
[17] M. Pratama, S. G. Anavatti, M. J. Er, E. D. Lughofer, pClass: an effective classifier for streaming examples, IEEE Trans. Fuzzy Syst 23 (2015) 369-386, doi:10.1109/TFUZZ.2014.2312983.
[18] P. Y. Chen, S. Yang, J. A. McCann, Distributed real-time anomaly detection in networked industrial sensing systems, IEEE Trans. Ind. Electron 62 (2015) 3832-3842, doi: 10.1109/TIE.2014.2350451.
[19] E. J. Spinosa, A. P. D. L. F. De Carvalho, J. Gama, OLINDDA: a cluster-based approach for detecting novelty and concept drift in data streams, in: Proceedings of the 2007 ACM Symposium on Applied Computing, 2007, pp. 448-452, doi:10.1145/1244002.1244107.
[20] E. R. Faria, J. Gama, A. C. Carvalho, Novelty detection algorithm for data streams multi-class problems, in: Proceedings of the 28th Annual ACM Symposium on Applied Computing, 2013, pp. 795-800, doi:10.1145/2480362. 2480515.
[21] S. Lee, G. Kim, S. Kim, Self-adaptive and dynamic clustering for online anomaly detection, Expert Syst. Appl. 38 (2011) 14891-14898, doi:10.1016/j.eswa.2011. 05.058.
[22] T. Ahmed, M. Coates, A. Lakhina, Multivariate online anomaly detection using kernel recursive least squares, in: Proceedings of the 26th IEEE International Conference on Computing Communication, 2007, pp. 625-633, doi: 10.1109/INFCOM.2007.79.
[23] M. Schneider, W. Ertel, F. Ramos, Expected Similarity estimation for large-scale batch and streaming anomaly detection, Mach. Learn. 105 (2016) 305-333, doi:10.1007/s10994-016-5567-7.
[24] A. Stanway, Etsy Skyline, Online Code Repos. (2013). github.com/etsy/skyline.
[25] A. Bernieri, G. Betta, C. Liguori, On-line fault detection and diagnosis obtained by implementing neural algorithms on a digital signal processor, IEEE Trans. Instrum. Meas 45 (1996) 894-899, doi:10.1109/19.536707.
[26] M. Basseville, I. V Nikiforov, Detection of Abrupt Changes, 1993.
[27] M. Szmit, A. Szmit, Usage of modified holt-winters method in the anomaly detection of network traffic: case studies, J. Comput. Networks Commun. (2012), doi:10.1155/2012/192913.
[28] P. Angelov, Anomaly detection based on eccentricity analysis, in: Proceedings of the 2014 IEEE Symposium Evolving and Autonomous Learning Systems, 2014, doi:10.1109/EALS.2014.7009497.
[29] B. S. J. Costa, C. G. Bezerra, L. A. Guedes, P. P. Angelov, Online fault detection based on typicality and eccentricity data analytics, in: Proceedings of the International Joint Conference on Neural Networks, 2015, doi:10.1109/IJCNN.2015. 7280712.
[30] A. M. Bianco, M. Garcia Ben, E. J. Martinez, V. J. Yohai, Outlier detection in regression models with ARIMA errors using robust estimates, J. Forecast. 20 (2001) 565-579.
[31] R. J. Hyndman, Y. Khandakar, Automatic time series forecasting: the forecast package for R Automatic time series forecasting: the forecast package for R, J. Stat. Softw 27 (2008) 1-22.
[32] C. Wang, K. Viswanathan, L. Choudur, V. Talwar, W. Satterfield, K. Schwan, Statistical techniques for online anomaly detection in data centers, in: Proceedings of the 12th IFIP/IEEE International Symposium on Integrated Network Management, 2011, pp. 385-392, doi:10.1109/INM.2011.5990537.
[33] D. L. Simon, A. W. Rinehart, A model-based anomaly detection approach for analyzing streaming aircraft engine measurement data, in: Proceedings of Turbo Expo 2014: Turbine Technical Conference and Exposition, ASME, 2014, pp. 665-672, doi:10.1115/GT2014-27172.
[34] E. K. Lee, H. Viswanathan, D. Pompili, Model-based thermal anomaly detection in cloud datacenters, in: Proceedings of the IEEE International Conference on Distributed Computing in Sensor Systems, 2013, pp. 191-198, doi:10.1109/DCOSS.2013.8.
[35] T. Klerx, M. Anderka, H. K. Buning, S. Priesterjahn, Model-based anomaly detection for discrete event systems, in: Proceedings of the 2014 IEEE 26th International Conference on Tools with Artificial Intelligence, IEEE, 2014, pp. 665-672, doi:10.1109/ICTAI.2014.105.
[36] F. Knorn, D. J. Leith, Adaptive Kalman filtering for anomaly detection in software appliances, in: Proceedings of the IEEE INFOCOM, 2008, doi:10.1109/INFOCOM.2008.4544581.
[37] A. Soule, K. Salamatian, N. Taft, Combining filtering and statistical methods for anomaly detection, in: Proceedings of the 5th ACM SIGCOMM conference on Internet measurement, 4, 2005, p. 1, doi:10.1145/1330107.1330147.
[38] H. Lee, S. J. Roberts, On-line novelty detection using the Kalman filter and extreme value theory, in: Proceedings of the 19th International Conference on Pattern Recognition, 2008, pp. 1-4, doi:10.1109/ICPR.2008.4761918.
[39] A. Morgan, Lytics Anomalyzer Blog, (2015). www.getlytics.com/blog/post/check_out_anomalyzer.
[40] Y. J. Lee, Y. R. Yeh, Y. C. F. Wang, Anomaly detection via online oversampling principal component analysis, IEEE Trans. Knowl. Data Eng 25 (2013) 1460-1470, doi:10.1109/TKDE.2012.99.
[41] A. Lakhina, M. Crovella, C. Diot, Diagnosing network-wide traffic anomalies, ACM SIGCOMM Comput. Commun. Rev 34 (2004) 219, doi:10.1145/1030194. 1015492.
[42] N. Gornitz, M. Kloft, K. Rieck, U. Brefeld, Toward supervised anomaly detection, J. Artif. Intell. Res 46 (2013) 235-262, doi:10.1613/jair.3623.
[43] U. Rebbapragada, P. Protopapas, C. E. Brodley, C. Alcock, Finding anomalous periodic time series: An application to catalogs of periodic variable stars, Mach. Learn. 74 (2009) 281-313, doi: 10.1007/s10994-008-5093-3.
[44] T. Pevny, Loda: Lightweight on-line detector of anomalies, Mach. Learn 102 (2016) 275-304, doi: 10.1007/s10994-015-5521-0.
[45] A. Kejariwal, Twitter Engineering: Introducing Practical and Robust Anomaly Detection in a Time Series [Online blog], (2015). bit.ly/1xBbX0Z.
[46] J. Hawkins, S. Ahmad, Why neurons have thousands of synapses, a theory of sequence memory in neocortex, Front. Neural Circuits. 10 (2016) 1-13, doi:10. 3389/fncir.2016.00023.
[47] D. E. Padilla, R. Brinkworth, M. D. McDonnell, Performance of a hierarchical temporal memory network in noisy sequence learning, in: Proceedings of the International Conference on Computational Intelligence and Cybernetics, IEEE, 2013, pp. 45-51, doi: 10.1109/CyberneticsCom.2013.6865779.
[48] D. Rozado, F. B. Rodriguez, P. Varona, Extending the bioinspired hierarchical temporal memory paradigm for sign language recognition, Neurocomputing 79 (2012) 75-86, doi:10.1016/j.neucom.2011.10.005.
[49] Y. Cui, S. Ahmad, J. Hawkins, Continuous online sequence learning with an unsupervised neural network model, Neural Comput 28 (2016) 2474-2504, doi:10.1162/NECO_a_00893.
[50] S. Purdy, Encoding Data for HTM Systems, arXiv. (2016) arXiv: 1602.05925 [cs.NE].
[51] J. Mnatzaganian, E. Fokoue, D. Kudithipudi, A Mathematical Formalization of hierarchical temporal memory's spatial pooler, Front. Robot. AI. 3 (2017) 81, doi: 10.3389/frobt.2016.00081.
[52] Y. Cui, S. Ahmad, J. Hawkins, The HTM Spatial Pooler: a neocortical algorithm for online sparse distributed coding, bioRxiv, 2016, doi: dx.doi.org/10.1101/085035.
[53] S. Ahmad, J. Hawkins, Properties of sparse distributed representations and their application to Hierarchical Temporal Memory, 2015, arXiv:1503.07469 [qNC].
[54] B. H. Bloom, Space/time trade-offs in hash coding with allowable errors, Commun. ACM. 13 (1970) 422-426, doi:10.1145/362686.362692.
[55] G. K. Karagiannidis, A. S. Lioumpas, An improved approximation for the Gaussian Q-function, IEEE Commun. Lett 11 (2007) 644-646.
[56] V. Chandola, A. Banerjee, V. Kumar, Anomaly detection: A survey, ACM Comput. Surv (2009) 1-72.
[57] R. P. Adams, D. J. C. Mackay, Bayesian Online Changepoint Detection, 2007, arXiv:0710.3742 [stat.ML].
[58] M. Schneider, W. Ertel, G. Palm, Constant Time expected similarity estimation using stochastic optimization, (2015) arXiv: 1511.05371 [cs.LG].
[59] M. Bartys, R. Patton, M. Syfert, S. de las Heras, J. Quevedo, Introduction to the DAMADICS actuator FDI benchmark study, Control Eng. Pract. 14 (2006) 577-596, doi: 10.1016/j.conengprac.2005.06.015.
Ahmad, Subutai, Alexander Lavin, Scott Purdy, and Zuha Agha. “Unsupervised real-time anomaly detection for streaming data.” Neurocomputing 262 (2017): 134-147.
Al-Dahidi, S., Baraldi, P., Di Maio, F., and Zio, E. (2014). Quantification of signal reconstruction uncertainty in fault detection systems. In The Second European Conference of the Prognostics and Health Management Society.
Angello, Leonard, Tim Lieuwen, David Robert Noble, and Brian Poole. “System and method for anomaly detection.” U.S. Pat. No. 9,752,960, issued Sep. 5, 2017.
Antonini, Mattia, Massimo Vecchio, Fabio Antonelli, Pietro Ducange, and Charith Perera. “Smart Audio Sensors in the Internet of Things Edge for Anomaly Detection.” IEEE Access (2018).
Aquize, Vanessa Gironda, Eduardo Emery, and Fernando Buarque de Lima Neto. “Self-organizing maps for anomaly detection in fuel consumption. Case study: Illegal fuel storage in Bolivia.” In Computational Intelligence (LA-CCI), 2017 IEEE Latin American Conference on, pp. 1-6. IEEE, 2017.
Arlot, S. and Celisse, A. (2010). A survey of cross-validation procedures for model selection. Statist. Surv., 4:40-79.
Awad, Mahmoud. “Fault detection of fuel systems using polynomial regression profile monitoring.” Quality and Reliability Engineering International 33, no. 4 (2017): 905-920.
Baek, Sujeong, and Duck Young Kim. “Fault Prediction via Symptom Pattern Extraction Using the Discretized State Vectors of Multi-Sensor Signals.” IEEE Transactions on Industrial Informatics (2018).
Bangalore, Pramod, and Lina Bertling Tjernberg. “An artificial neural network approach for early fault detection of gearbox bearings.” IEEE Transactions on Smart Grid 6, no. 2 (2015): 980-987.
Baraldi, P., Canesi, R., Zio, E., Seraoui, R., and Chevalier, R. (2011). Genetic algorithm-based wrapper approach for grouping condition monitoring signals of nuclear power plant components. Integr. Comput.-Aided Eng., 18(3):221-234.
Baraldi, P., Di Maio, F., Genini, D., and Zio, E. (2015a). Comparison of data-driven reconstruction methods for fault detection. Reliability, IEEE Transactions on, 64(3):852-860.
Baraldi, P., Di Maio, F., Pappaglione, L., Zio, E., and Seraoui, R. (2012). Condition monitoring of electrical power plant components during operational transients. Proceedings of the Institution of Mechanical Engineers, Part O: Journal of Risk and Reliability, SAGE, 226:568-583.
Baraldi, P., Di Maio, F., Turati, P., and Zio, E. (2015b). Robust signal reconstruction for condition monitoring of industrial components via a modified Auto Associative Kernel Regression method. Mechanical Systems and Signal Processing, 60-61:29-44.
Barnett, V., Lewis, T., et al. (1994). Outliers in statistical data, volume 3. Wiley New York.
Basseville, Michele. “Distance measures for signal processing and pattern recognition.” Signal processing 18, no. 4 (1989): 349-369.
Bhuyan, Monowar H., Dhruba K. Bhattacharyya, and Jugal K. Kalita. “Network Traffic Anomaly Detection Techniques and Systems.” In Network Traffic Anomaly Detection and Prevention, pp. 115-169. Springer, Cham, 2017.
Boechat, A. A., Moreno, U. F., and Haramura, D. (2012). On-line calibration monitoring system based on data-driven model for oil well sensors. IFAC Proceedings Volumes, 45(8):269-274.
Boss, Gregory J., Andrew R. Jones, Charles S. Lingafelt, Kevin C. McConnell, and John E. Moore. “Predicting vehicular failures using autonomous collaborative comparisons to detect anomalies.” U.S. patent application Ser. No. 15/333,586, filed Apr. 26, 2018.
Brandsmter, A., Manno, G., Vanem, E., and Glad, I. K. (2016). An application of sensor-based anomaly detection in the maritime industry. In 2016 IEEE International Conference on Prognostics and Health Management (ICPHM), pages 1-8.
Brandseter, A., Vanem, E., and Glad, I. K. (2017). Cluster based anomaly detection with applications in the maritime industry. In 2017 International Conference on Sensing, Diagnostics, Prognostics, and Control. Shanghai, China.
Brandsaeter, Andreas, Erik Vanem, and Ingrid Kristine Glad. “Cluster Based Anomaly Detection with Applications in the Maritime Industry.” In Sensing, Diagnostics, Prognostics, and Control (SDPC), 2017 International Conference on, pp. 328-333. IEEE, 2017.
Butler, Matthew. “An Intrusion Detection System for Heavy-Duty Truck Networks.” Proc. of KCWS (2017): 399-406.
Byington, Carl S., Michael J. Roemer, and Thomas Galie. “Prognostic enhancements to diagnostic systems for improved condition-based maintenance [military aircraft].” In Aerospace Conference Proceedings, 2002. IEEE, vol. 6, pp. 6-6. IEEE, 2002.
Cameron, S. (1997). Enhancing gjk: Computing minimum and penetration distances between convex polyhedra. In Robotics and Automation, 1997. Proceedings., 1997 IEEE International Conference on, volume 4, pages 3112-3117. IEEE.
Canali, Claudia, and Riccardo Lancellotti. “Automatic virtual machine clustering based on Bhattacharyya distance for multi-cloud systems.” In Proceedings of the 2013 international workshop on Multi-cloud applications and federated clouds, pp. 45-52. ACM, 2013.
Candel, Arno, Viraj Parmar, Erin LeDell, and Anisha Arora. “Deep learning with H2O.” H2O. ai Inc (2016).
Carnero, M. Carmen. “Selection of diagnostic techniques and instrumentation in a predictive maintenance program. A case study.” Decision Support Systems 38, no. 4 (2005): 539-555.
Chandola, V., Banerjee, A., and Kumar, V. (2009). Anomaly detection: A survey. ACM computing surveys (CSUR), 41(3):15.
Chandra, Abel Avitesh, Nayzel Imran Jannif, Shaneel Prakash, and Vadan Padiachy. “Cloud based real-time monitoring and control of diesel generator using the IoT technology.” In Electrical Machines and Systems (ICEMS), 2017 20th International Conference on, pp. 1-5. IEEE, 2017.
Chaudhuri, Arin, Deovrat Kakde, Maria Jahja, Wei Xiao, Seunghyun Kong, Hansi Jiang, and Sergiy Peredriy. 2016. “Sampling Method for Fast Training of Support Vector Data Description.” eprint arXiv:1606.05382, 2016.
Chaudhuri, G., J. D. Borwankar, and P. R. K. Rao. “Bhattacharyya distance based linear discriminant function for stationary time series.” Communications in Statistics-Theory and Methods 20, no. 7 (1991): 2195-2205.
Chen, Kai-Ying, Long-Sheng Chen, Mu-Chen Chen, and Chia-Lung Lee. “Using SVM based method for equipment fault detection in a thermal power plant.” Computers in industry 62, no. 1 (2011): 42-50.
Cheng, S. and Pecht, M. (2012). Using cross-validation for model parameter selection of sequential probability ratio test. Expert Syst. Appl., 39(9):8467-8473.
Choi, Euisun, and Chulhee Lee. “Feature extraction based on the Bhattacharyya distance.” Pattern Recognition 36, no. 8 (2003): 1703-1709.
Coble, J., Humberstone, M., and Hines, J. W. (2010). Adaptive monitoring, fault detection and diagnostics, and prognostics system for the iris nuclear plant. Annual Conference of the Prognostics and Health Management Society.
Dattorro, J. (2010). Convex optimization & Euclidean distance geometry. Meboo Publishing USA.
Desilva, Upul P., and Heiko Claussen. “Nonintrusive performance measurement of a gas turbine engine in real time.” U.S. Pat. No. 9,746,360, issued Aug. 29, 2017.
Di Maio, F., Baraldi, P., Zio, E., and Seraoui, R. (2013). Fault detection in nuclear power plants components by a combination of statistical methods. Reliability, IEEE Transactions on, 62(4):833-845.
Diez-Olivan, Alberto, Jose A. Pagan, Nguyen Lu Dang Khoa, Ricardo Sanz, and Basilio Sierra. “Kernel-based support vector machines for automated health status assessment in monitoring sensor data.” The International Journal of Advanced Manufacturing Technology 95, no. 1-4 (2018): 327-340.
Diez-Olivan, Alberto, Jose A. Pagan, Ricardo Sanz, and Basilio Sierra. “Data-driven prognostics using a combination of constrained K-means clustering, fuzzy modeling and LOF-based score.” Neurocomputing 241 (2017): 97-107.
Diez-Olivan, Alberto, Jose A. Pagan, Ricardo Sanz, and Basilio Sierra. “Deep evolutionary modeling of condition monitoring data in marine propulsion systems.” Soft Computing (2018): 1-17.
Dimopoulos, G. G., Georgopoulou, C. A., Stefanatos, I. C., Zymaris, A. S., and Kakalis, N. M. (2014). A general-purpose process modelling framework for marine energy systems. Energy Conversion and Management, 86:325-339.
Eskin. Eleazar. “Anomaly detection over noisy data using learned probability distributions.” In In Proceedings of the International Conference on Machine Learning. 2000.
Ester, M., Kriegel, H.-P., Sander, J., Xu, X., et al. (1996). A density-based algorithm for discovering clusters in large spatial databases with noise. In Kdd, volume 96, pages 226-231.
Fernandez-Francos, Diego, David Martinez-Rego, Oscar Fontenla-Romero, and Amparo Alonso-Betanzos. “Automatic bearing fault diagnosis based on one-class v-SVMI.” Computers & Industrial Engineering 64, no. 1 (2013): 357-365.
Filev, Dimitar P., and Finn Tseng. “Novelty detection based machine health prognostics.” In Evolving Fuzzy Systems, 2006 International Symposium on, pp. 193-199. IEEE, 2006.
Filev, Dimitar P., Ratna Babu Chinnam, Finn Tseng, and Pundarikaksha Baruah. “An industrial strength novelty detection framework for autonomous equipment monitoring and diagnostics.” IEEE Transactions on Industrial Informatics 6, no. 4 (2010): 767-779.
Flaherty, N. (2017). Frames of mind. Unmanned systems technology, 3(3).
Galar, Diego, Adithya Thaduri, Marcantonio Catelani, and Lorenzo Ciani. “Context awareness for maintenance decision making: A diagnosis and prognosis approach.” Measurement 67 (2015): 137-150.
Ganesan, Arun, Jayanthi Rao, and Kang Shin. Exploiting consistency among heterogeneous sensors for vehicle anomaly detection. No. 2017-01-1654. SAE Technical Paper, 2017.
Garcia, Mari Cruz, Miguel A. Sanz-Bobi, and Javier del Pico. “SIMAP: Intelligent System for Predictive Maintenance: Application to the health condition monitoring of a windturbine gearbox.” Computers in Industry 57, no. 6 (2006): 552-568.
Garvey, J., Garvey, D., Seibert, R., and Hines, J. W. (2007). Validation of on-line monitoring techniques to nuclear plant data. Nuclear Engineering and Technology, 39:133-142.
Gillespie, Ryan, and Saurabh Gupta. “Real-time Analytics at the Edge: Identifying Abnormal Equipment Behavior and Filtering Data near the Edge for Internet of Things Applications.” (2017).
Goudail, François, Philippe Réfrégier, and Guillaume Delyon. “Bhattacharyya distance as a contrast parameter for statistical processing of noisy optical images.” JOSA A 21, no. 7 (2004): 1231-1240.
Gross, K. C. and Lu, W. (2002). Early detection of signal and process anomalies in enterprise computing systems. In Wani, M. A., Arabnia, H. R., Cios, K. J., Hafeez, K., and Kendall, G., editors, ICMLA, pages 204-210. CSREA Press.
Guorong, Xuan, Chai Peiqi, and Wu Minhui. “Bhattacharyya distance feature selection.” In Pattern Recognition, 1996., Proceedings of the 13th International Conference on, vol. 2, pp. 195-199. IEEE, 1996.
Habeeb, Riyaz Ahamed Ariyaluran, Fariza Nasaruddin, Abdullah Gani, Ibrahim Abaker Targio Hashem, Ejaz Ahmed, and Muhammad Imran. “Real-time big data processing for anomaly detection: A Survey.” International Journal of Information Management (2018).
Hassanzadeh, Amin, Shaan Mulchandani, Malek Ben Salem, and Chien An Chen. “Telemetry Analysis System for Physical Process Anomaly Detection.” U.S. patent application Ser. No. 15/429,900, filed Aug. 10, 2017.
Hastie, T., Tibshirani, R., and Friedman, J. (2009). The elements of statistical learning, volume 1. Springer series in statistics New York, 2 edition.
Hines, J. W. and Garvey, D. R. (2006). Development and application of fault detectability performance metrics for instrument calibration verification and anomaly detection. Journal of Pattern Recognition Research.
Hines, J. W., Garvey, D. R., and Seibert, R. (2008a). Technical review of on-line monitoring techniques for performance assessment (nureg/cr-6895). volume 3: Limiting case studies. Technical report, United States Nuclear Regulatory Commission, Office of Nuclear regulatory Research.
Hines, J. W., Garvey, D. R., Seibert, R., and Usynin, A. (2008b). Technical review of on-line monitoring techniques for performance assessment (nureg/cr-6895). Volume 2: Theoretical issues. Technical report, United States Nuclear Regulatory Commission, Office of Nuclear regulatory Research.
Hedge, V. and Austin, J. (2004). A survey of outlier detection methodologies. Artificial intelligence review, 22(2):85-126.
Hu, Bo, Mark Flaum, and Jane Troutner. “Downhole tool analysis using anomaly detection of measurement data.” U.S. Pat. No. 8,437,943.
Imani, Maryam. “RX anomaly detector with rectified background.” IEEE Geoscience and Remote Sensing Letters 14, no. 8 (2017): 1313-1317.
Jamei, Mahdi, Anna Scaglione, Ciaran Roberts, Emma Stewart, Sean Peisert, Chuck McParland, and Alex McEachern. “Anomaly detection using optimally-placed pPMU sensors in distribution grids.” IEEE Transactions on Power Systems (2017). arXiv preprint ariv: 1708.00118.
Jarvis, R. A. (1973). On the identification of the convex hull of a finite set of points in the plane. Information processing letters, 2(1):18-21.
Jeschke, Sabina, Christian Brecher, Tobias Meisen, Denis Ozdemir, and Tim Eschert. “Industrial internet of things and cyber manufacturing systems.” In Industrial Internet of Things, pp. 3-19. Springer, Cham, 2017.
Jiao, Wenjiang, and Qingbin Li. “Anomaly Detection based on Fuzzy Rules.” International Journal of Performability Engineering 14, no. 2 (2018): 376.
Jimenez, Luis O., and David A. Landgrebe. “Supervised classification in high-dimensional space: geometrical, statistical, and asymptotical properties of multivariate data.” IEEE Transactions on Systems, Main, and Cybernetics, Part C (Applications and Reviews) 28, no. 1 (1998): 39-54.
Johnson, Don, and Sinan Sinanovic. “Symmetrizing the kullback-leibler distance.” IEEE Transactions on Information Theory (2001).
Jombo, Gbanaibolou, Yu Zhang, Jonathan David Griffiths, and Tony Latimer. “Automated Gas Turbine Sensor Fault Diagnostics.” In ASME Turbo Expo 2018: Turbomachinery Technical Conference and Exposition, pp. V006T05A003-V006T05A003. American Society of Mechanical Engineers, 2018.
Kailath, Thomas. “The divergence and Bhattacharyya distance measures in signal selection.” IEEE transactions on communication technology 15, no. 1 (1967): 52-60.
Kanarachos, S., Christopoulos, S.-R. G., Chroneos, A., and Fitzpatrick, M. E. (2017). Detecting anomalies in time series data via a deep learning algorithm combining wavelets, neural networks and Hilbert transform. Expert Systems with Applications, 85(Supplement C):292-304.
Kang, Myeongsu. “Machine Learning: Anomaly Detection.” Prognostics and Health Management of Electronics: Fundamentals, Machine Learning. and the Internet of Things (2018): 131-162.
Kazakos, Dimitri. “The Bhattacharyya distance and detection between Markov chains.” IEEE Transactions on Information Theory 24, no. 6 (1978): 747-754.
Keogh, E. and Mueen, A. (2011). Curse of dimensionality. In Encyclopedia of Machine Learning, pages 257-258. Springer.
Keshk, Marwa, Nour Moustafa, Elena Sitnikova, and Gideon Creech. “Privacy preservation intrusion detection technique for SCADA systems.” In Military Communications and Information Systems Conference (MilCIS), 2017, pp. 1-6. IEEE, 2017.
Khan, Wazir Zada, Mohammed Y. Aalsalem, Muhammad Khurram Khan, Md Shohrab Hossain, and Mohammed Atiquzzaman. “A reliable Internet of Things based architecture for oil and gas industry.” In Advanced Communication Technology (ICACT), 2017 19th International Conference on, pp. 705-710. IEEE, 2017.
Kim, Jong-Min, and Jaiwook Baik. “Anomaly Detection in Sensor Data.” Reliability Application Research 18, no. 1 (2018): 20-32.
Klingbeil, Adam Edgar, and Eric Richard Dillen. “Engine diagnostic system and an associated method thereof.” U.S. Pat. No. 9,617,940, issued Apr. 11, 2017.
Kobayashi, Hisashi, and John B. Thomas. “Distance measures and related criteria.” In Proc. 5th Annu. Allerton Conf. Circuit and System Theory, pp. 491-500. 1967.
Kohavi, R. (1995). A study of cross-validation and bootstrap for accuracy estimation and model selection. In Proceedings of the 14th International Joint Conference on Artificial Intelligence—Volume 2, IJCAI'95, pages 1137-1143, San Francisco, Calif., USA. Morgan Kaufmann Publishers Inc.
Kroll, Björn, David Schaffranek, Sebastian Schriegel, and Oliver Niggemann. “System modeling based on machine learning for anomaly detection and predictive maintenance in industrial plants.” In Emerging Technology and Factory Automation (ETFA), 2014 IEEE, pp. 1-7. IEEE, 2014.
Kushal, Tazim Ridwan Billah, Kexing Lai, and Mahesh S. Illindala. “Risk-based Mitigation of Load Curtailment Cyber Attack Using Intelligent Agents in a Shipboard Power System.” IEEE Transactions on Smart Grid (2018).
Lampreia, Suzana, Jose Requeijo, and Victor Lobo. “Diesel engine vibration monitoring based on a statistical model.” In MATEC Web of Conferences, vol. 211, p. 03007. EDP Sciences, 2018.
Lane, Terran D. Machine learning techniques for the computer security domain of anomaly detection. 2000.
Lane, Terran, and Carla E. Brodley. “An application of machine learning to anomaly detection.” In Proceedings of the 20th National Information Systems Security Conference, vol. 377, pp. 366-380. Baltimore, USA, 1997.'
Langone, Rocco, Carlos Alzate, Bart De Ketelaere, Jonas Vlasselaer, Wannes Meert, and Johan A K Suykens. “LS-SVM based spectral clustering and regression for predicting maintenance of industrial machines.” Engineering Applications of Artificial Intelligence 37 (2015): 268-278.
Lee, Chulhee, and Daesik Hong. “Feature extraction using the Bhattacharyya distance.” In Systems, Man, and Cybernetics, 1997. Computational Cybernetics and Simulation., 1997 IEEE International Conference on, vol. 3, pp. 2147-2150. IEEE, 1997.
Lee, J., M. Ghaffari, and S. Elmeligy. “Self-maintenance and engineering immune systems: Towards smarter machines and manufacturing systems.” Annual Reviews in Control 35, no. 1 (2011): 111-122.
Lee, Jay, Hung-An Kao, and Shanhu Yang. “Service innovation and smart analytics for industry 4.0 and big data environment.” Procedia Cirp 16 (2014): 3-8.
Lee, Jay. “Machine performance monitoring and proactive maintenance in computer-integrated manufacturing: review and perspective.” International Journal of computer integrated manufacturing 8, no. 5 (1995): 370-380.
Lee, Sunghyun, Jong-Won Park, Do-Sik Kim, Insu Jeon, and Dong-Cheon Baek. “Anomaly detection of tripod shafts using modified Mahalanobis distance.” Journal of Mechanical Science and Technology 32, no. 6 (2018): 2473-2478.
Lei, Sifan, Lin He, Yang Liu, and Dong Song. “Integrated modular avionics anomaly detection based on symbolic time series analysis.” In Advanced Information Technology, Electronic and Automation Control Conference (IAEAC), 2017 IEEE 2nd, pp. 2095-2099. IEEE, 2017.
Li, Fei, Hongzhi Wang, Guowen Zhou, Daren Yu, Jiangzhong Li, and Hong Gao. “Anomaly detection in gas turbine fuel systems using a sequential symbolic method.” Energies 10, no. 5 (2017): 724.
Li, Hongfei, Dhaivat Parikh, Qing He, Buyue Qian, Zhiguo Li, Dongping Fang, and Arun Hampapur. “Improving rail network velocity: A machine learning approach to predictive maintenance.” Transportation Research Part C: Emerging Technologies 45 (2014): 17-26.
Li, Weihua, Tielin Shi, Guanglan Liao, and Shuzi Yang. “Feature extraction and classification of gear faults using principal component analysis.” Journal of Quality in Maintenance Engineering 9, no. 2 (2003): 132-143.
Liu, Datong, Jingyue Pang, Ben Xu, Zan Liu, Jun Zhou, and Guoyong Zhang. “Satellite Telemetry Data Anomaly Detection with Hybrid Similarity Measures.” In Sensing, Diagnostics, Prognostics, and Control (SDPC), 2017 International Conference on, pp. 591-596. IEEE, 2017.
Lu, Bin, Yaoyu Li, Xin Wu, and Zhongzhou Yang. “A review of recent advances in wind turbine condition monitoring and fault diagnosis.” In Power Electronics and Machines in Wind Applications, 2009. PEMWA 2009. IEEE, pp. 1-7. IEEE, 2009.
Lu, Huimin, Yujie Li, Shenglin Mu, Dong Wang, Hyoungseop Kim, and Seiichi Serikawa. “Motor anomaly detection for unmanned aerial vehicles using reinforcement learning.” IEEE Internet of Things Journal 5, no. 4 (2018): 2315-2322.
Luo, Hui, and Shisheng Zhong. “Gas turbine engine gas path anomaly detection using deep learning with Gaussian distribution.” In Prognostics and System Health Management Conference (PHAM-Harbin), 2017, pp. 1-6. IEEE, 2017.
Mack, Daniel L C, Gautam Biswas, Hamed Khorasgani, Dinkar Mylaraswamy, and Raj Bharadwaj. “Combining expert knowledge and unsupervised learning techniques for anomaly detection in aircraft flight data.” at-Automatisierungstechnik 66, no. 4 (2018): 291-307.
Mak, Brian, and Etienne Barnard. “Phone clustering using the Bhattacharyya distance.” In Fourth International Conference on Spoken Language Processing. 1996.
Maulidevi, Nur Ulfa, Masayu Leylia Khodra, Herry Susanto, and Furkan Jadid. “Smart online monitoring system for large scale diesel engine.” In Information Technology Systems and Innovation (ICITSI), 2014 International Conference on, pp. 235-240. IEEE, 2014.
Messer, Adam J., and Kenneth W. Bauer. “Mahalanobis masking: a method for the sensitivity analysis of anomaly detection algorithms for hyperspectral imagery.” Journal of Applied Remote Sensing 12, no. 2 (2018): 025001.
Michau, G., Palme, T., and Fink, O. (2017). Deep feature learning network for fault detection and isolation. In Proceedings of the Annual Conference of the Prognostics and Health Management Society, pages 108-118.
Misra, Prateep, Arpan Pal, Balamuralidhar Purushothaman, Chirabrata Bhaumik, Deepak Swamy, Venkatramanan Siva Subrahmanian, Avik Ghose, and Aniruddha Sinha. “Computer platform for development and deployment of sensor-driven vehicle telemetry applications and services.” U.S. Pat. No. 9,990,182, issued Jun. 5, 2018.
Moustafa, Nour, Gideon Creech, Elena Sitnikova, and Marwa Keshk. “Collaborative anomaly detection framework for handling big data of cloud computing.” In Military Communications and Information Systems Conference (MilCIS), 2017, pp. 1-6. IEEE, 2017.
Nakano, Hitoshi. “Anomaly determination system and anomaly determination method.” U.S. Pat. No. 9,945,745, issued Apr. 17, 2018.
Nakayama, Kiyoshi, and Ratnesh Sharma. “Energy management systems with intelligent anomaly detection and prediction.” In Resilience Week (RWS), 2017, pp. 24-29. IEEE, 2017.
Narendra, Patrenahalli M., and Keinosuke Fukunaga. “A branch and bound algorithm for feature subset selection.” IEEE Transactions on computers 9 (1977): 917-922.
Ng, R. T. and Han, J. (1994). Efficient and effective clustering methods for spatial data mining. In Proceedings of VLDB, pages 144-155.
Ng, R. T. and Han, J. (2002). Clarans: A method for clustering objects for spatial data mining. IEEE transactions on knowledge and data engineering, 14(5):1003-1016.
Nick, Sascha. “System and method for scalable multi-level remote diagnosis and predictive maintenance.” U.S. patent application Ser. No. 09/934,000, filed Mar. 6, 2003.
Nielsen, Frank, and Sylvain Boltz. “The burbea-rao and bhattacharyya centroids.” IEEE Transactions on Information Theory 57, no. 8 (2011): 5455-5466.
Ogden, David A., Tom L. Arnold, and Walter D. Downing. “A multivariate statistical approach for anomaly detection and condition based maintenance in complex systems.” In AUTOTESTCON, 2017 IEEE, pp. 1-8. IEEE, 2017.
Ohkubo, Masato, and Yasushi Nagata. “Anomaly detection in high-dimensional data with the Mahalanobis-Taguchi system.” Total Quality Management & Business Excellence 29, no. 9-10 (2018): 1213-1227.
Olson, C., Judd, K., and Nichols, J. (2018). Manifold learning techniques for unsupervised anomaly detection. Expert Systems with Applications, 91(Supplement C):374-385.
Omura, Jim K. “Expurgated bounds, Bhattacharyya distance, and rate distortion functions.” Information and Control 24, no. 4 (1974): 358-383.
Park, JinSoo, Dong Hag Choi, You-Boo Jeon, Yunyoung Nam, Min Hong, and Doo-Soon Park. “Network anomaly detection based on probabilistic analysis.” Soft Computing 22, no. 20 (2018): 6621-6627.
Paschos, George. “Perceptually uniform color spaces for color texture analysis: an empirical evaluation.” IEEE transactions on Image Processing 10, no. 6 (2001): 932-937.
Patil, Sundeep R., Ansh Kapil, Alexander Sagel, Lutter Michael, Oliver Baptista, and Martin Kleinsteuber. “Multi-layer anomaly detection framework.” U.S. patent application Ser. No. 15/287,249, filed Apr. 12, 2018.
Peng, Ying, Ming Dong, and Ming Jian Zuo. “Current status of machine prognostics in condition-based maintenance: a review.” The International Journal of Advanced Manufacturing Technology 50, no. 1-4 (2010): 297-313.
Perronnin, Florent, and Christopher Dance. “Fisher kernels on visual vocabularies for image categorization.” In 2007 IEEE conference on computer vision and pattern recognition, pp. 1-8. IEEE, 2007.
Qi, Baohua. “Particulate matter sensing device for controlling and diagnosing diesel particulate filter systems.” U.S. Pat. No. 9,605,578, issued Mar. 28, 2017.
Rabatel, Julien, Sandra Bringay, and Pascal Poncelet. “Anomaly detection in monitoring sensor data for preventive maintenance.” Expert Systems with Applications 38, no. 6 (2011): 7003-7015.
Rabenoro, Tsirizo, and Jerome Henri Noel Lacaille. “Method of estimation on a curve of a relevant point for the detection of an anomaly of a motor and data processing system for the implementation thereof.” U.S. Pat. No. 9,792,741, issued Oct. 17, 2017.
Raheja, D., J. Llinas, R. Nagi, and C. Romanowski. “Data fusion/data mining-based architecture for condition-based maintenance.” International Journal of Production Research 44, no. 14 (2006): 2869-2887.
Salonidis. Theodoros, Dinesh C. Verma, and David A. Wood III. “Acoustics based anomaly detection in machine rooms.” U.S. Pat. No. 9,905,249, issued Feb. 27, 2018.
Saranya, C. and Manikandan, G. (2013). A study on normalization techniques for privacy preserving data mining. International Journal of Engineering and Technology, 5:2701-2704.
Sartran, Laurent, Pierre-Andre Savalle, Jean-Philippe Vasseur, Grégory Mermoud, Javier Cruz Mota, and Sébastien Gay. “Detection and analysis of seasonal network patterns for anomaly detection.” U.S. patent application Ser. No. 15/188,175, filed Sep. 28, 2017.
Saxena, A., Celaya, J., Balaban, E., Goebel, K., Saha, B., Saha, S., and Schwabacher, M. (2008). Metrics for evaluating performance of prognostic techniques.
Schweppe, Fred C. “On the Bhattacharyya distance and the divergence between Gaussian processes.” Information and Control 11, no. 4 (1967): 373-395.
Shah, Gauri, and Aashis Tiwari. “Anomaly detection in IIoT: a case study using machine learning.” In Proceedings of the ACM India Joint International Conference on Data Science and Management of Data, pp. 295-300. ACM, 2018.
Shin, Hyun Joon, Dong-Hwan Eom, and Sung-Shick Kim. “One-class support vector machines—an application in machine fault detection and classification.” Computers & Industrial Engineering 48, no. 2 (2005): 395-408.
Shin, Jong-Ho, and Hong-Bae Jun. “On condition based maintenance policy.” Journal of Computational Design and Engineering 2, no. 2 (2015): 119-127.
Shon, Taeshik, and Jongsub Moon. “A hybrid machine learning approach to network anomaly detection.” Information Sciences 177, no. 18 (2007): 3799-3821.
Shon, Taeshik, Yongdae Kim, Cheolwon Lee, and Jongsub Moon. “A machine learning framework for network anomaly detection using SVM and GA.” In Information Assurance Workshop, 2005. IAW'05. Proceedings from the Sixth Annual IEEE SMC, pp. 176-183. IEEE, 2005.
Siddique, Arfat, G. S. Yadava, and Bhim Singh. “Applications of artificial intelligence techniques for induction machine stator fault diagnostics.” (2003).
Siegel, Joshua Eric, and Sumeet Kumar. “System, Device, and Method for Feature Generation, Selection, and Classification for Audio Detection of Anomalous Engine Operation.” U.S. patent application Ser. No. 15/639,408, filed Jan. 4, 2018.
Sipos, Ruben, Dmitriy Fradkin, Fabian Moerchen, and Zhuang Wang. “Log-based predictive maintenance.” In Proceedings of the 20th ACM SIGKDD international conference on knowledge discovery and data mining, pp. 1867-1876. ACM, 2014.
Sonntag, Daniel, Sonja Zillner, Patrick van der Smagt, and Andrφs Lörincz. “Overview of the CPS for smart factories project: deep learning, knowledge acquisition, anomaly detection and intelligent user interfaces.” In Industrial Internet of Things, pp. 487-504. Springer, Cham, 2017.
Spoerre, Julie K., Chang-Ching Lin, and Hsu-Pin Wang. “Machine performance monitoring and fault classification using an exponentially weighted moving average scheme.” U.S. Pat. No. 5,602,761, issued Feb. 11, 1997.
Tao, Hua, Pinjing He, Zhishan Wang, and Wenjie Sun. “Application of the Mahalanobis distance on evaluating the overall performance of moving-grate incineration of municipal solid waste.” Environmental monitoring and assessment 190, no. 5 (2018): 284.
Teizer, Jochen, Mario Wolf, Olga Golovina, Manuel Perschewski, Markus Propach, Matthias Neges, and Markus Konig. “Internet of Things (IoT) for Integrating Environmental and Localization Data in Building Information Modeling (BIM).” In ISARC. Proceedings of the International Symposium on Automation and Robotics in Construction, vol. 34. Vilnius Gediminas Technical University, Department of Construction Economics & Property, 2017.
Theissler, Andreas. “Detecting known and unknown faults in automotive systems using ensemble-based anomaly detection.” Knowledge-Based Systems 123 (2017): 163-173.
Thompson, Scott, Sravan Karri, and Michael Joseph Campagna. “Turbocharger speed anomaly detection.” U.S. Pat. No. 9,976,474, issued May 22, 2018.
Toussaint, G. “Comments on” The Divergence and Bhattacharyya Distance Measures in Signal Selection”.” IEEE Transactions on Communications 20, no. 3 (1972): 485-485.
Tran, Kim Phuc, and Anh Tuan Mai. “Anomaly detection in wireless sensor networks via support vector data description with mahalanobis kernels and discriminative adjustment.” In Information and Computer Science, 2017 4th NAFOSTED Conference on, pp. 7-12. IEEE, 2017.
Ur, Shmuel, David Hirshberg, Shay Bushinsky, Vlad Grigore Dabija, and Ariel Fligler. “Sensor data anomaly detector.” U.S. patent application Ser. No. 15/707,436, filed Jan. 4, 2018.
Ur, Shmuel, David Hirshberg, Shay Bushinsky, Vlad Grigore Dabija, and Ariel Fligler. “Sensor data anomaly detector.” U.S. Pat. No. 9,764,712, issued Sep. 19, 2017.
Veillette, Michel, Said Berriah, and Gilles Tremblay. “Intelligent monitoring system and method for building predictive models and detecting anomalies.” U.S. Pat. No. 7,818,276, issued Oct. 19, 2010.
Viegas, Eduardo, Altair O. Santin, Andre Franca, Ricardo Jasinski, Volnei A. Pedroni, and Luiz S. Oliveira. “Towards an energy-efficient anomaly-based intrusion detection engine for embedded systems.” IEEE Transactions on Computers 66, no. 1 (2017): 163-177.
Wegerich, Stephan W., Andre Wolosewicz, and R. Matthew Pipke. “Diagnostic systems and methods for predictive condition monitoring.” U.S. Pat. No. 7,308,385, issued Dec. 11, 2007.
Wei, Muheng, Bohua Qiu, Xiao Tan, Yangong Yang, and Xueliang Liu. “Condition Monitoring for the Marine Diesel Engine Economic Performance Analysis with Degradation Contribution.” In 2018 IEEE International Conference on Prognostics and Health Management (ICPHM), pp. 1-6. IEEE, 2018.
Widodo, Achmad, and Bo-Suk Yang. “Support vector machine in machine condition monitoring and fault diagnosis.” Mechanical systems and signal processing 21, no. 6 (2007): 2560-2574.
Wu, Ying, Malte Christian Kaufmann, Robert McGrath, Ulrich Schlueter, and Simon Sitt. “Automatic condition monitoring and anomaly detection for predictive maintenance.” U.S. patent application Ser. No. 15/185,951, filed Dec. 21, 2017.
Xu, Yang, Zebin Wu, Jocelyn Chanussot, and Zhihui Wei. “Joint reconstruction and anomaly detection from compressive hyperspectral images using Mahalanobis distance-regularized tensor RPCA.” IEEE Transactions on Geoscience and Remote Sensing 56, no. 5 (2018): 2919-2930.
Xuan, Guorong, Xiuming Zhu, Peiqi Chai, Zhenping Zhang, Yun Q. Shi, and Dongdong Fu. “Feature selection based on the Bhattacharyya distance.” In Pattern Recognition, 2006. ICPR 2006. 18th International Conference on, vol. 4, pp. 957-957. IEEE, 2006.
Xun, Lu, and Le Wang. “An object-based SVM method incorporating optimal segmentation scale estimation using Bhattacharyya Distance for mapping salt cedar (Tamarisk spp.) with QuickBird imagery.” GIScience & Remote Sensing 52, no. 3 (2015): 257-273.
Yam, R. C. M., P. W. Tse, L. Li, and P. Tu. “Intelligent predictive decision support system for condition-based maintenance.” The International Journal of Advanced Manufacturing Technology 17, no. 5 (2001): 383-391.
Yamato, Yoji, Hiroki Kumazaki, and Yoshifumi Fukumoto. “Proposal of lambda architecture adoption for real time predictive maintenance.” In 2016 Fourth International Symposium on Computing and Networking (CANDAR), pp. 713-715. IEEE, 2016.
Yamato, Yoji, Yoshifumi Fukumoto, and Hiroki Kumazaki. “Predictive maintenance platform with sound stream analysis in edges.” Journal of Information processing 25 (2017): 317-320.
Yan, Weili, and Jun-Hong Zhou. “Early Fault Detection of Aircraft Components Using Flight Sensor Data.” In 2018 IEEE 23rd International Conference on Emerging Technologies and Factory Automation (ETFA), vol. 1, pp. 1337-1342. IEEE, 2018.
You, Chang Huai, Kong Aik Lee, and Haizhou Li. “A GMM supervector Kernel with the Bhattacharyya distance for SVM based speaker recognition.” In Acoustics, Speech and Signal Processing, 2009. ICASSP 2009. IEEE International Conference on, pp. 4221-4224. IEEE, 2009.
You, Chang Huai, Kong Aik Lee, and Haizhou Li. “An SVM kernel with GMM-supervector based on the Bhattacharyya distance for speaker recognition.” IEEE Signal processing letters 16, no. 1 (2009): 49-52.
You, Chang Huai, Kong Aik Lee, and Haizhou Li. “GMM-SVM kernel with a Bhattacharyya-based distance for speaker recognition.” IEEE Transactions on Audio, Speech, and Language Processing 18, no. 6 (2010): 1300-1312.
Zarpelão, Bruno Bogaz, Rodrigo Sanches Miani, Clφudio Toshio Kawakani, and Sean Carlisto de Alvarenga. “A survey of intrusion detection in Internet of Things.” Journal of Network and Computer Applications 84 (2017): 25-37.
Zhao, Chunhui, Lili Zhang, and Baozhi Cheng. “A local Mahalanobis-distance method based on tensor decomposition for hyperspectral anomaly detection.” Geocarto hternational (2017): 1-14.
Zheng, D., Li, F., and Zhao, T. (2016). Self-adaptive statistical process control for anomaly detection in time series. Expert Systems with Applications, 57(Supplement C):324-336.
Zhou, Shaohua Kevin, and Rama Chellappa. “From sample similarity to ensemble similarity: Probabilistic distance measures in reproducing kernel hilbert space.” IEEE transactions on pattern analysis and machine intelligence 28, no. 6 (2006): 917-929.
U.S. Pat. Nos. 1,000,3300; 10,003,511; 10,005,427; 10,008,885; 10,011,119; 10,013,303; 10,013,655; 10,014,727; 10,018,071; 10,020,689; 10,020,844; 10,024,884; 10,024,975; 10,025,659; 10,027,694; 10,031,830; 10,037,025; 10,037,666; 10,044,742; 10,050,852; 10,054,686; 10,055,004; 10,069,347; 10,078,963; 10,088,189; 10,088,452; 10,089,886; 10,095,871; 10,099,703; 10,099,876; 10,102,054; 10,102,056; 10,102,220; 10,102,858; 10,108,181; 10,108,480; 10,119,985; 10,121,103; 10,121,104; 10,122,740; 10,123,199; 4,161,687; 4,229,796; 4,237,539; 4,245,212; 4,322,974; 4,335,353; 4,360,359; 4,544,917; 4,598,419; 4,618,850; 4,633,720; 4,634,110; 4,759,215; 4,787,618; 4,817,624; 4,857,840; 4,970,467; 4,971,749; 4,978,225; 4,991,312; 5,034,965; 5,102,587; 5,117,182; 5,123,111; 5,150,039; 5,155,439; 5,189,374; 5,270,661; 5,291,777; 5,304,804; 5,305,745; 5,369,674; 5,404,019; 5,419,405; 5,469,746; 5,504,990; 5,542,467; 5,548,343; 5,570,017; 5,577,589; 5,589,611; 5,610,518; 5,629,626; 5,649,589; 5,682,366; 5,684,523; 5,708,307; 5,781,649; 5,784,560; 5,807,761; 5,844,862; 5,847,563; 5,872,438; 5,900,739; 5,903,970; 5,954,898; 5,986,242; 5,986,580; 6,031,377; 6,046,834; 6,049,497; 6,064,428; 6,067,218; 6,067,657; 6,078,851; 6,172,509; 6,178,027; 6,185,028; 6,201,480; 6,246,503; 6,267,013; 6,292,582; 6,309,536; 6,324,659; 6,332,362; 6,338,152; 6,341,828; 6,353,678; 6,356,299; 6,357,486; 6,400,996; 6,404,484; 6,404,999; 6,426,612; 6,439,062; 6,456,026; 6,534,930; 6,546,344; 6,560,480; 6,570,379; 6,595,035; 6,597,777; 6,597,997; 6,640,145; 6,647,757; 6,678,851; 6,679,129; 6,683,774; 6,684,470; 6,698,323; 6,710,556; 6,718,245; 6,739,177; 6,750,564; 6,751,560; 6,765,954; 6,771,214; 6,784,672; 6,794,865; 6,815,946; 6,819,118; 6,842,674; 6,850,252; 6,856,950; 6,857,329; 6,873,680; 6,882,620; 6,909,768; 6,930,596; 6,939,131; 6,943,570; 6,943,872; 6,945,035; 6,965,935; 6,980,543; 6,985,979; 7,004,872; 7,006,881; 7,031,424; 7,047,861; 7,049,952; 7,051,044; 7,068,050; 7,075,427; 7,079,958; 7,095,223; 7,096,092; 7,102,739; 7,107,758; 7,109,723; 7,164,272; 7,187,437; 7,191,359; 7,194,298; 7,194,709; 7,201,620; 7,212,474; 7,215,106; 7,218,392; 7,222,047; 7,230,564; 7,266,426; 7,274,971; 7,286,825; 7,292,021; 7,298,394; 7,301,335; 7,305,308; 7,310,590; 7,327,689; 7,359,833; 7,370,203; 7,383,012; 7,383,158; 7,391,240; 7,398,043; 7,402,959; 7,403,862; 7,406,653; 7,409,929; 7,416,649; 7,418,634; 7,420,589; 7,422,495; 7,423,590; 7,427,867; 7,436,504; 7,439,693; 7,444,086; 7,451,005; 7,451,394; 7,460,498; 7,466,667; 7,489,255; 7,492,400; 7,495,612; 7,516,128; 7,518,813; 7,520,155; 7,523,014; 7,531,921; 7,536,229; 7,538,555; 7,538,670; 7,539,874; 7,542,821; 7,546,236; 7,555,036; 7,555,407; 7,557,581; 7,558,316; 7,562,396; 7,587,299; 7,590,670; 7,613,173; 7,613,668; 7,626,383; 7,626,542; 7,628,073; 7,633,858; 7,636,848; 7,647,156; 7,664,154; 7,667,974; 7,668,491; 7,680,624; 7,689,018; 7,693,589; 7,694,333; 7,697,881; 7,701,482; 7,701,686; 7,716,485; 7,734,388; 7,742,845; 7,746,076; 7,747,364; 7,751,955; 7,756,593; 7,756,678; 7,760,354; 7,767,472; 7,769,603; 7,778,123; 7,782,000; 7,782,873; 7,783,433; 7,785,078; 7,787,394; 7,792,610; 7,793,138; 7,796,368; 7,797,133; 7,797,567; 7,800,586; 7,813,822; 7,818,276; 7,825,824; 7,826,744; 7,827,442; 7,829,821; 7,834,593; 7,836,398; 7,839,292; 7,844,828; 7,849,124; 7,849,187; 7,855,848; 7,859,855; 7,880,417; 7,885,734; 7,890,813; 7,891,247; 7,904,187; 7,907,535; 7,908,097; 7,917,811; 7,924,542; 7,930,259; 7,930,593; 7,932,858; 7,934,133; 7,949,879; 7,952,710; 7,954,153; 7,962,311; 7,966,078; 7,974,714; 7,974,800; 7,987,003; 7,987,033; 8,015,176; 8,015,877; 8,024,140; 8,031,060; 8,063,793; 8,065,813; 8,069,210; 8,069,485; 8,073,592; 8,076,929; 8,086,880; 8,086,904; 8,087,488; 8,095,798; 8,095,992; 8,102,518; 8,108,094; 8,112,562; 8,120,361; 8,121,599; 8,121,741; 8,126,790; 8,127,412; 8,131,107; 8,134,816; 8,140,250; 8,143,017; 8,144,005; 8,145,913; 8,150,105; 8,155,541; 8,159,945; 8,160,352; 8,165,916; 8,175,739; 8,186,395; 8,187,189; 8,189,599; 8,201,028; 8,201,973; 8,205,265; 8,207,316; 8,207,745; 8,208,604; 8,209,084; 8,225,137; 8,240,059; 8,242,785; 8,246,458; 8,249,818; 8,261,421; 8,279,768; 8,282,849; 8,285,155; 8,285,501; 8,290,376; 8,301,041; 8,306,028; 8,306,931; 8,326,578; 8,330,421; 8,330,813; 8,341,518; 8,345,397; 8,347,009; 8,352,216; 8,352,412; 8,353,060; 8,356,513; 8,359,481; 8,364,136; 8,369,967; 8,370,679; 8,375,455; 8,377,275; 8,379,800; 8,386,118; 8,392,756; 8,400,011; 8,411,914; 8,412,402; 8,413,016; 8,418,560; 8,423,128; 8,423,226; 8,424,765; 8,428,811; 8,428,813; 8,430,922; 8,432,132; 8,433,472; 8,446,645; 8,448,236; 8,452,871; 8,465,635; 8,467,949; 8,475,517; 8,478,418; 8,479,064; 8,482,290; 8,482,809; 8,483,905; 8,485,137; 8,486,548; 8,490,384; 8,495,083; 8,504,871; 8,510,591; 8,515,719; 8,516,266; 8,526,824; 8,527,835; 8,532,869; 8,548,174; 8,549,573; 8,550,344; 8,551,155; 8,566,047; 8,572,720; 8,573,592; 8,577,111; 8,577,693; 8,578,466; 8,582,457; 8,583,263; 8,583,389; 8,586,948; 8,600,483; 8,605,306; 8,606,117; 8,610,596; 8,611,228; 8,626,362; 8,626,889; 8,630,452; 8,630,751; 8,635,334; 8,640,015; 8,654,956; 8,655,518; 8,659,254; 8,660,743; 8,677,485; 8,677,510; 8,682,616; 8,682,824; 8,684,274; 8,684,275; 8,690,073; 8,705,328; 8,714,461; 8,717,234; 8,719,401; 8,721,706; 8,736,459; 8,738,334; 8,742,926; 8,744,124; 8,744,561; 8,744,813; 8,745,199; 8,760,343; 8,767,921; 8,768,542; 8,770,626; 8,774,369; 8,774,813; 8,774,932; 8,777,800; 8,779,920; 8,781,209; 8,781,210; 8,788,869; 8,791,716; 8,806,313; 8,806,621; 8,812,586; 8,814,057; 8,816,272; 8,818,199; 8,820,261; 8,823,218; 8,838,389; 8,844,054; 8,851,381; 8,857,815; 8,862,364; 8,873,813; 8,874,972; 8,876,036; 8,886,064; 8,890,073; 8,893,290; 8,893,858; 8,897,116; 8,897,867; 8,909,997; 8,912,888; 8,913,807; 8,918,289; 8,921,070; 8,921,774; 8,923,960; 8,935,104; 8,938,533; 8,966,555; 8,968,197; 8,984,116; 8,994,817; 9,002,093; 9,003,076; 9,007,385; 9,015,317; 9,015,536; 9,037,707; 9,043,934; 9,046,219; 9,049,101; 9,051,058; 9,052,831; 9,055,431; 9,058,294; 9,063,061; 9,074,865; 9,077,610; 9,079,461; 9,081,883; 9,086,483; 9,088,010; 9,092,618; 9,092,651; 9,102,295; 9,106,555; 9,106,687; 9,111,644; 9,112,948; 9,128,482; 9,128,836; 9,134,347; 9,164,514; 9,164,928; 9,165,325; 9,171,079; 9,172,552; 9,177,592; 9,177,600; 9,183,033; 9,188,695; 9,194,899; 9,197,511; 9,215,268; 9,224,391; 9,225,793; 9,228,428; 9,233,471; 9,235,991; 9,239,760; 9,244,133; 9,245,396; 9,247,159; 9,249,657; 9,259,644; 9,267,330; 9,268,664; 9,268,714; 9,269,162; 9,271,057; 9,274,842; 9,275,093; 9,285,296; 9,292,888; 9,294,499; 9,294,719; 9,297,707; 9,298,530; 9,303,568; 9,305,043; 9,307,914; 9,311,210; 9,311,598; 9,316,759; 9,322,264; 9,325,275; 9,330,119; 9,330,371; 9,336,248; 9,336,388; 9,356,552; 9,360,855; 9,369,356; 9,377,374; 9,378,079; 9,385,546; 9,395,437; 9,396,253; 9,398,863; 9,400,307; 9,405,795; 9,407,651; 9,408,175; 9,412,067; 9,422,909; 9,439,092; 9,449,325; 9,459,944; 9,464,999; 9,466,196; 9,467,572; 9,470,202; 9,471,544; 9,472,084; 9,476,871; 9,483,049; 9,491,247; 9,494,547; 9,495,330; 9,495,395; 9,500,612; 9,503,228; 9,509,621; 9,514,234; 9,516,041; 9,533,831; 9,535,563; 9,535,808; 9,535,959; 9,537,954; 9,540,974; 9,547,944; 9,553,909; 9,559,849; 9,563,806; 9,568,519; 9,571,516; 9,576,223; 9,582,780; 9,583,911; 9,588,565; 9,589,362; 9,597,715; 9,598,178; 9,600,394; 9,600,899; 9,603,870; 9,612,031; 9,612,336; 9,613,123; 9,613,511; 9,614,616; 9,614,742; 9,617,603; 9,617,940; 9,621,448; 9,628,499; 9,632,037; 9,632,511; 9,651,669; 9,652,354; 9,652,959; 9,661,074; 9,661,075; 9,665,842; 9,666,059; 9,667,061; 9,674,211; 9,675,756; 9,679,497; 9,680,693; 9,680,938; 9,681,269; 9,692,662; 9,692,775; 9,697,574; 9,699,581; 9,699,603; 9,709,981; 9,710,857; 9,711,998; 9,720,095; 9,720,823; 9,722,895; 9,723,469; 9,746,511; 9,747,638; 9,749,414; 9,751,747; 9,753,801; 9,754,135; 9,754,429; 9,759,774; 9,762,601; 9,764,712; 9,766,615; 9,774,460; 9,774,679; 9,779,370; 9,779,495; 9,781,127; 9,786,182; 9,794,144; 9,798,883; 9,805,002; 9,805,763; 9,813,021; 9,813,314; 9,817,972; 9,824,069; 9,825,819; 9,826,872; 9,831,814; 9,843,474; 9,846,240; 9,852,471; 9,853,990; 9,853,992; 9,864,912; 9,865,101; 9,866,370; 9,872,188; 9,874,489; 9,880,228; 9,883,371; 9,886,337; 9,888,635; 9,891,325; 9,891,983; 9,892,744; 9,893,963; 9,894,324; 9,900,546; 9,905,249; 9,915,697; 9,916,538; 9,916,554; 9,916,651; 9,925,858; 9,926,686; 9,928,281; 9,933,338; 9,934,639; 9,939,393; 9,940,184; 9,945,745; 9,945,917; 9,953,411; 9,954,852; 9,958,844; 9,961,571; 9,965,649; 9,971,037; 9,972,517; 9,976,474; 9,977,094; 9,979,675; 9,984,543; 9,990,683; 9,991,840; 9,995,677; 9,996,305; 9,998,778; 9,998,804; 20010015751; 20010039975; 20010045803; 20010054320; 20020035437; 20020036501; 20020047634; 20020093330; 20020101224; 20020129363; 20020138188; 20020139360; 20020145423; 20020151992; 20020156574; 20020165953; 20020172509; 20020196341; 20030001595; 20030027036; 20030029256; 20030030387; 20030046545; 20030048748; 20030101716; 20030115389; 20030126613; 20030136197; 20030155209; 20030172785; 20030195640; 20030218568; 20030231297; 20040003455; 20040008467; 20040012491; 20040012987; 20040014016; 20040017883; 20040022197; 20040030419; 20040030448; 20040030449; 20040030450; 20040030451; 20040030570; 20040030571; 20040068196; 20040068351; 20040068415; 20040068416; 20040116106; 20040134289; 20040134336; 20040134337; 20040164888; 20040176204; 20040194446; 20040218715; 20040222094; 20040224351; 20040239316; 20050040832; 20050053124; 20050068050; 20050075803; 20050080492; 20050092487; 20050100852; 20050108538; 20050123031; 20050143976; 20050164229; 20050172910; 20050177320; 20050177870; 20050183569; 20050190786; 20050198602; 20050200838; 20050206506; 20050210465; 20050228525; 20050232096; 20050237055; 20050243965; 20050246159; 20050246350; 20050246577; 20050248751; 20050261853; 20050262555; 20050264796; 20050270037; 20050283309; 20050283511; 20050285772; 20050285939; 20050285940; 20060005097; 20060007946; 20060015296; 20060018534; 20060019417; 20060038571; 20060053123; 20060067729; 20060077013; 20060080049; 20060101402; 20060108170; 20060113199; 20060119515; 20060133869; 20060155398; 20060156005; 20060158433; 20060159468; 20060160437; 20060160438; 20060171715; 20060186895; 20060200253; 20060200258; 20060200259; 20060200260; 20060210288; 20060229801; 20060241785; 20060242473; 20060259673; 20060279234; 20060289280; 20070008120; 20070009982; 20070016476; 20070028219; 20070028220; 20070045292; 20070050107; 20070052424; 20070053513; 20070053564; 20070067481; 20070071241; 20070071338; 20070073911; 20070074288; 20070075753; 20070080977; 20070094738; 20070101290; 20070106519; 20070121267; 20070136115; 20070143552; 20070175414; 20070183305; 20070186651; 20070188117; 20070198830; 20070200761; 20070206498; 20070219652; 20070222457; 20070223338; 20070226634; 20070239329; 20070251467; 20070253232; 20070255097; 20070255430; 20070255431; 20070256832; 20070262824; 20070265713; 20070268510; 20070276552; 20070287364; 20070288115; 20070288130; 20070293756; 20070293963; 20070293965; 20070293966; 20070294150; 20070294151; 20070294152; 20070294210; 20070294279; 20070294280; 20070294591; 20070297478; 20080001649; 20080002325; 20080010039; 20080010330; 20080012541; 20080021650; 20080027659; 20080031139; 20080046975; 20080048307; 20080059119; 20080070479; 20080086434; 20080086435; 20080091978; 20080092826; 20080103882; 20080114744; 20080126003; 20080133439; 20080137800; 20080140751; 20080144927; 20080147347; 20080155335; 20080189067; 20080195463; 20080215204; 20080215913; 20080216572; 20080222123; 20080243339; 20080243437; 20080244747; 20080252441; 20080263407; 20080263663; 20080270129; 20080270274; 20080274705; 20080275359; 20080283332; 20080284644; 20080289423; 20080297958; 20080309270; 20080316347; 20080317672; 20090009395; 20090012402; 20090012673; 20090028416; 20090028417; 20090030336; 20090030544; 20090032329; 20090040054; 20090045950; 20090045976; 20090046287; 20090048690; 20090052330; 20090055043; 20090055050; 20090055111; 20090067353; 20090072997; 20090083557; 20090084844; 20090086205; 20090088929; 20090089112; 20090106359; 20090118632; 20090128106; 20090128159; 20090132626; 20090135727; 20090141775; 20090147945; 20090152595; 20090157278; 20090193071; 20090207020; 20090207987; 20090210755; 20090218990; 20090237083; 20090241185; 20090251543; 20090252006; 20090253222; 20090254777; 20090274053; 20090279772; 20090281679; 20090290757; 20090295561; 20090297336; 20090299554; 20090299695; 20090300417; 20090302835; 20090328119; 20100005663; 20100033743; 20100045279; 20100056956; 20100063750; 20100067523; 20100071807; 20100073926; 20100076642; 20100083055; 20100094798; 20100095374; 20100114524; 20100117855; 20100125422; 20100125910; 20100131526; 20100132025; 20100132437; 20100133116; 20100133664; 20100136390; 20100142958; 20100159931; 20100165812; 20100168951; 20100185405; 20100191681; 20100201373; 20100204958; 20100211341; 20100219808; 20100220781; 20100223226; 20100223986; 20100225051; 20100246432; 20100248844; 20100255757; 20100256866; 20100259037; 20100260508; 20100267077; 20100268411; 20100275094; 20100277843; 20100287442; 20100289656; 20100290346; 20100302602; 20100303611; 20100306575; 20100307825; 20100309468; 20100328734; 20100332373; 20100332887; 20110004580; 20110012738; 20110012753; 20110019566; 20110022809; 20110025270; 20110029704; 20110029906; 20110033829; 20110035088; 20110043180; 20110052243; 20110055982; 20110072151; 20110080138; 20110084609; 20110091225; 20110094209; 20110102790; 20110115669; 20110119742; 20110130898; 20110145715; 20110149745; 20110152702; 20110153236; 20110156896; 20110167110; 20110172876; 20110173497; 20110178612; 20110193722; 20110199709; 20110202453; 20110208364; 20110210890; 20110214012; 20110218687; 20110221377; 20110224918; 20110230304; 20110231743; 20110241836; 20110243576; 20110246640; 20110257897; 20110275531; 20110276828; 20110288836; 20110307220; 20110313726; 20110314325; 20110315490; 20110320586; 20120000084; 20120001641; 20120008159; 20120011407; 20120018514; 20120019823; 20120023366; 20120033207; 20120035803; 20120036016; 20120038485; 20120041575; 20120042001; 20120059227; 20120060052; 20120060053; 20120063641; 20120066539; 20120066735; 20120089414; 20120095742; 20120095852; 20120101800; 20120103245; 20120130724; 20120143706; 20120144415; 20120146683; 20120150058; 20120166016; 20120166142; 20120169497; 20120190450; 20120192274; 20120197852; 20120197856; 20120197898; 20120197911; 20120209539; 20120212229; 20120213049; 20120232947; 20120233703; 20120235929; 20120239246; 20120248313; 20120248314; 20120250830; 20120254673; 20120262303; 20120265029; 20120271587; 20120271850; 20120272308; 20120277596; 20120278051; 20120281818; 20120290879; 20120301161; 20120316835; 20120317636; 20130003925; 20130018665; 20130020895; 20130030761; 20130030765; 20130034273; 20130053617; 20130054783; 20130057201; 20130062456; 20130066592; 20130073260; 20130076508; 20130090946; 20130113913; 20130114879; 20130120561; 20130129182; 20130141100; 20130144466; 20130173135; 20130173218; 20130184995; 20130187750; 20130191688; 20130197854; 20130202287; 20130207975; 20130211632; 20130211768; 20130218399; 20130253354; 20130253355; 20130259088; 20130261886; 20130262916; 20130275158; 20130282313; 20130282336; 20130282509; 20130282896; 20130286198; 20130288220; 20130295877; 20130308239; 20130325371; 20130326287; 20130335009; 20130335267; 20130336814; 20130338846; 20130338965; 20130343619; 20130346417; 20130346441; 20140002071; 20140003821; 20140020100; 20140039834; 20140043491; 20140053283; 20140055269; 20140058615; 20140067734; 20140068067; 20140068068; 20140068069; 20140068777; 20140079297; 20140085996; 20140089241; 20140093124; 20140094661; 20140095098; 20140102712; 20140102713; 20140103122; 20140108241; 20140108640; 20140112457; 20140116715; 20140136025; 20140137980; 20140149128; 20140150104; 20140152679; 20140165054; 20140165195; 20140172382; 20140173452; 20140174752; 20140181949; 20140184786; 20140188369; 20140188778; 2014019518420140201126; 20140201810; 20140215053; 20140215612; 20140222379; 20140229008; 20140230911; 20140232595; 20140236396; 20140236514; 20140237113; 20140240171; 20140240172; 20140244528; 20140249751; 20140251478; 20140266282; 20140277798; 20140277910; 20140277925; 20140278248; 20140283988; 20140309756; 20140310235; 20140310285; 20140310714; 20140313077; 20140317752; 20140323883; 20140324786; 20140325649; 20140331511; 20140337992; 20140351517; 20140351520; 20140351642; 20140358308; 20140359363; 20140365021; 20140375335; 20150006123; 20150006127; 20150012758; 20150019067; 20150021391; 20150032277; 20150034083; 20150034608; 20150052407; 20150056484; 20150063088; 20150066875; 20150066879; 20150067090; 20150067295; 20150067707; 20150073650; 20150073730; 20150073853; 20150074011; 20150095333; 20150099662; 20150106324; 20150116146; 20150120914; 20150121124; 20150121160; 20150123846; 20150124849; 20150124850; 20150127595; 20150142385; 20150142986; 20150143913; 20150149554; 20150160098; 20150160640; 20150168495; 20150169393; 20150177101; 20150178521; 20150178944; 20150178945; 20150180227; 20150180920; 20150190956; 20150194034; 20150199889; 20150207711; 20150211468; 20150215332; 20150222503; 20150226858; 20150227947; 20150233783; 20150234869; 20150237215; 20150237680; 20150240728; 20150260812; 20150262435; 20150269050; 20150269845; 20150278748; 20150279194; 20150285628; 20150286783; 20150287249; 20150287311; 20150293234; 20150293516; 20150293535; 20150301517; 20150301796; 20150304786; 20150308980; 20150310362; 20150318161; 20150319729; 20150322531; 20150324501; 20150331023; 20150332008; 20150332523; 20150333998; 20150338442; 20150346007; 20150355917; 20150358379; 20150358576; 20150363925; 20150365423; 20150367387; 20150381648; 20150381931; 20160004979; 20160020969; 20160021390; 20160047329; 20160049831; 20160050136; 20160055654; 20160056064; 20160061640; 20160061948; 20160062815; 20160062950; 20160064031; 20160065476; 20160075445; 20160076970; 20160077566; 20160078353; 20160081608; 20160091370; 20160091540; 20160092317; 20160092787; 20160094180; 20160100031; 20160103032; 20160106339; 20160113223; 20160113469; 20160127208; 20160132754; 20160133000; 20160139575; 20160140155; 20160149786; 20160155068; 20160158437; 20160160470; 20160162687; 20160164721; 20160164949; 20160171310; 20160174844; 20160179298; 20160180684; 20160182344; 20160195294; 20160202223; 20160203594; 20160205697; 20160209364; 20160212164; 20160217056; 20160223333; 20160225372; 20160226728; 20160243903; 20160245851; 20160245921; 20160246291; 20160248262; 20160248624; 20160249793; 20160253232; 20160253635; 20160253751; 20160253858; 20160258747; 20160258748; 20160261087; 20160267256; 20160275150; 20160283754; 20160284137; 20160284212; 20160289009; 20160291552; 20160292182; 20160292405; 20160295475; 20160299938; 20160300474; 20160315585; 20160318522; 20160321128; 20160321557; 20160327596; 20160335552; 20160341830; 20160342453; 20160343177; 20160349302; 20160349830; 20160358268; 20160364920; 20160367326; 20160369777; 20160370236; 20160371170; 20160371180; 20160371181; 20160371363; 20160371600; 20160373473; 20170001510; 20170008487; 20170010767; 20170011008; 20170012790; 20170012834; 20170013407; 20170017735; 20170025863; 20170026373; 20170031743; 20170032281; 20170034721; 20170038233; 20170041089; 20170045409; 20170046217; 20170046628; 20170049392; 20170054724; 20170060499; 20170060931; 20170061659; 20170067763; 20170069190; 20170070971; 20170076217; 20170078167; 20170083830; 20170086051; 20170089845; 20170093810; 20170094053; 20170094537; 20170097863; 20170098534; 20170099208; 20170100301; 20170102978; 20170103264; 20170103679; 20170103680; 20170104447; 20170104866; 20170106820; 20170108612; 20170110873; 20170111760; 20170113698; 20170115119; 20170116059; 20170123875; 20170124669; 20170124777; 20170124782; 20170126532; 20170132059; 20170132068; 20170132613; 20170132862; 20170140005; 20170142097; 20170146585; 20170147611; 20170158203; 20170174457; 20170178322; 20170185927; 20170187570; 20170187580; 20170187585; 20170192095; 20170192872; 20170199156; 20170200379; 20170201412; 20170201428; 20170201897; 20170205266; 20170206452; 20170206458; 20170208080; 20170211900; 20170214701; 20170221367; 20170222487; 20170222593; 20170227500; 20170227610; 20170228278; 20170230264; 20170234455; 20170235294; 20170235626; 20170241895; 20170242148; 20170244726; 20170246876; 20170250855; 20170261954; 20170266378; 20170269168; 20170272185; 20170272878; 20170279840; 20170281118; 20170282654; 20170284903; 20170286776; 20170286841; 20170288463; 20170289409; 20170289732; 20170293829; 20170294686; 20170296056; 20170298810; 20170301247; 20170302506; 20170303110; 20170310549; 20170315021; 20170316667; 20170318043; 20170322987; 20170323073; 20170329353; 20170331921; 20170332995; 20170337397; 20170343695; 20170343980; 20170343990; 20170351563; 20170352201; 20170352265; 20170353057; 20170353058; 20170353059; 20170353490; 20170358111; 20170363199; 20170364661; 20170365048; 20170366568; 20170370606; 20170370984; 20170370986; 20170374436; 20170374573; 20180001869; 20180003593; 20180004961; 20180006739; 20180018384; 20180018876; 20180019931; 20180020332; 20180024203; 20180024874; 20180032081; 20180032386; 20180033144; 20180034701; 20180038954; 20180041409; 20180045599; 20180047225; 20180048850; 20180049662; 20180051890; 20180052229; 20180053528; 20180060159; 20180067042; 20180068172; 20180068906; 20180076610; 20180077677; 20180081855; 20180082189; 20180082190; 20180082192; 20180082193; 20180082207; 20180082208; 20180082443; 20180082689; 20180083998; 20180088609; 20180091326; 20180091327; 20180091369; 20180091381; 20180091649; 20180094536; 20180097830; 20180097881; 20180101744; 20180107203; 20180107559; 20180109387; 20180109622; 20180109935; 20180113167; 20180114120; 20180114450; 20180117846; 20180120370; 20180120371; 20180120372; 20180124018; 20180124087; 20180131710; 20180135456; 20180136675; 20180136677; 20180157220; 20180158323; 20180160327; 20180165576; 20180173581; 20180173607; 20180173608; 20180176253; 20180180765; 20180183823; 20180188704; 20180188714; 20180188715; 20180189242; 20180191760; 20180191992; 20180196133; 20180196922; 20180197624; 20180199784; 20180203472; 20180204111; 20180210425; 20180210426; 20180210427; 20180210927; 20180212821; 20180213219; 20180213348; 20180214634; 20180216960; 20180217015; 20180217584; 20180219881; 20180222043; 20180222498; 20180222504; 20180224848; 20180224850; 20180225606; 20180227731; 20180231478; 20180231603; 20180238253; 20180239295; 20180241654; 20180241693; 20180242375; 20180246514; 20180248905; 20180253073; 20180253074; 20180253075; 20180253664; 20180255374; 20180255375; 20180255376; 20180255377; 20180255378; 20180255379; 20180255380; 20180255381; 20180255382; 20180255383; 20180257643; 20180257661; 20180260173; 20180261560; 20180266233; 20180270134; 20180270549; 20180275642; 20180276326; 20180278634; 20180281815; 20180283326; 20180284292; 20180284313; 20180284735; 20180284736; 20180284737; 20180284741; 20180284742; 20180284743; 20180284744; 20180284745; 20180284746; 20180284747; 20180284749; 20180284752; 20180284753; 20180284754; 20180284755; 20180284756; 20180284757; 20180284758; 20180285178; 20180285179; 20180285320; 20180290730; 20180291728; 20180291911; 20180292777; 20180293723; 20180293814; 20180294772; 20180298839; 20180299878; 20180300180; 20180300477; 20180303363; 20180307576; 20180308112; 20180312074; 20180313721; and 20180316709.

### BRIEF DESCRIPTION OF THE DRAWINGS

FIG. 1 shows example independent variables time series: Engine RPM and Load during a training period for detecting engine coolant temperature anomaly on a tugboat, in accordance with some embodiments.

FIG. 2 shows example engine coolant temperature and standard error in predicted values during the training period, in accordance with some embodiments.

FIG. 3 shows an example Mahalanobis distance time series of computed z-scores of errors from six engine sensor data (coolant temperature), coolant pressure (coolant pressure), oil temperature (oil temperature), oil pressure (oil pressure), fuel pressure (fuel pressure), and fuel actuator percentage (fuel actuator percentage) during the training period, in accordance with some embodiments.

FIG. 4 shows an example time series of Engine RPM and Load during a test period, in accordance with some embodiments.

FIG. 5 shows example engine coolant temperature and the respective standard error in predicted values during the test period, in accordance with some embodiments.

FIG. 6 shows an example zoomed-in engine coolant temperature and corresponding standardized errors (z-scores of errors) in predicted values during the test period, in accordance with some embodiments.

FIG. 7 shows an example Mahalanobis distance time series of computed z-scores of errors from six engine sensor data (coolant temperature), coolant pressure (coolant pressure), oil temperature (oil temperature), oil pressure (oil pressure), fuel pressure (fuel pressure), and fuel actuator percentage (fuel actuator percentage) during the test period, in accordance with some embodiments.

FIG. 8 shows example raw engine sensor data at a time prior to and during a Fuel Pump Failure (occurring on August 28), where average engine load, average engine fuel pressure and average manifold pressure are shown, in accordance with some embodiments.

FIG. 9 shows an example of computed error z scores for average engine load, average fuel pressure and average manifold pressure as well as example Mahalanobis Angle of the Errors in one dimension at a time prior to and during the Fuel Pump Failure (occurring on August 28), in accordance with some embodiments.

FIG. 10 shows a flow chart of data pre-processing for model generation, in accordance with some embodiments.

### DETAILED DESCRIPTION

In some embodiments, the present technology provides systems and methods for capturing a stream of data relating to performance of a physical system, processing the stream with respect to a statistical model generated using machine learning, and predicting the presence of an anomaly representing impending or actual hardware deviation from a normal state, distinguished from the hardware in a normal state, in a rigorous environment of use.

It is often necessary to decide which one of a finite set of possible Gaussian processes is being observed. For example, it may be important to decide whether a normal state of operation is being observed with its range of statistical variations, or an aberrant state of operation is being observed, which may assume not only a different nominal operating point, but also a statistical variance that is quantitatively different from the normal state. Indeed, the normal and aberrational states may differ only in the differences in statistical profile, with all nominal values having, or controlled to maintain, a nominal value. The ability to make such decisions can depend on the distances in n-dimensional space between the Gaussian processes where n is the number of features that describe the processes; if the processes are close (similar) to each other, the decision can be difficult. The distances may be measured using a divergence, the Bhattacharyya distance, or the Mahalanobis distance, for example. In addition, these distances can be described as or converted to vectors in n-dimensional space by determining angles from the corresponding axis (e.g. the n Mahalanobis angles between the vectors of Mahalanobis distances, spanning from the origin to multi-dimensional standardized error points, and the corresponding axis of standardized errors). Some or all of these distances and angles can be used to evaluate whether a system is in a normal or aberrant state of operation and can also be used as input to models that classify an aberrant state of operation as a particular kind of engine failure in accordance with some embodiments of the presently disclosed technology.

In many cases, engine parameter(s) being monitored and analyzed for anomaly detection are assumed to be correlated with some other engine parameter(s) being monitored. For example, if y is the engine sensor value being analyzed for near real-time predictions and x1, x2, . . . are other engine sensors also being monitored, there exists a function ƒ1 such that y=ƒ1(x1, x2, . . . , xn) where y is the dependent variable and x1, x2, . . . , xn, etc., are independent variables and y is a function of x1, x2, . . . , xn or f1: [symbol] ⁿ [symbol] [symbol] ^{l}.

In some embodiments, the machine being analyzed is a diesel engine within a marine vessel, and the analysis system's goal is to identify diesel engine operational anomalies and/or diesel engine sensor anomalies at near real-time latency, using an edge device installed at or near the engine. Of course, other types of vehicles, engines, or machines may similarly be subject to the monitoring and analysis.

The edge device may interface with the engine's electronic control module/unit (ECM/ECU) and collects engine sensors data as a time series (e.g., engine revolutions per minute (RPM), load percent, coolant temperature, coolant pressure, oil temperature, oil pressure, fuel pressure, fuel actuator percentage, etc.) as well as speed and location data from an internal GPS/DGPS or vessel's GPS/DGPS.

The edge device may, for example, collect all of these sensor data at an approximate rate of sixty samples per minute, and align the data to every second's timestamp (e.g. 12:00:00, 12:00:01, 12:00:02, . . . ). If data can be recorded at higher frequency, an aggregate (e.g., an average value) may be calculated for each second or other appropriate period. Then the average value (i.e., arithmetical mean) for each minute may then be calculated, creating the minute's averaged time series (e.g., 12:00:00, 12:01:00, 12:02:00, . . . ).

In some embodiments, minute's average data were found to be more stable for developing statistical models and predicting anomalies than raw, high-frequency samples. However, in some cases, the inter-sample noise can be processed with subsequent stages of the algorithm.

The edge device collects an n-dimensional engine data time series that may include, but is not limited to, timestamps (ts) and the following engine parameters: engine speed (rpm), engine load percentage (load), coolant temperature (coolant temperature), coolant pressure (coolant pressure), oil temperature (oil temperature), oil pressure (oil pressure), fuel pressure (fuel pressure), and fuel actuator percentage (fuel actuator percentage).

In some cases, ambient temperature, barometric pressure, humidity, location, maintenance information, or other data are collected.

In a variance analysis of diesel engine data, most of the engine parameters, including coolant temperature, are found to have strong correlation with engine RPM and engine load percentage in a bounded range of engine speed and when engine is in steady state, i.e., RPM and engine load is stable. So, inside that bounded region of engine RPM (e.g., higher than idle engine RPM), there exists a function ƒ1 such that:

coolant temperature=ƒ1(rpm, load)

f1: [symbol] ⁿ [symbol] [symbol] ^{m}.

In this case n equals two (rpm and load) and m equals one (coolant temperature).

In other words, ƒ1 is a map that allows for prediction of a single dependent variable from two independent variables. Similarly,
coolant pressure=ƒ2(rpm, load)
oil temperature=ƒ3(rpm, load)
oil pressure=ƒ4(rpm, load)
fuel pressure=ƒ5(rpm, load)
fuel actuator percentage=ƒ6(rpm, load)

Grouping these maps into one map leads to a multi-dimensional map (i.e. the model) such that ƒ: [symbol] ⁿ [symbol] [symbol] ^{m} where n equals two (rpm, load) and m equals six (coolant temperature, coolant pressure, oil temperature, oil pressure, fuel pressure and fuel actuator percentage) in this case. Critically, many maps are grouped into a single map with the same input variables, enabling potentially many correlated variables (i.e., a tensor of variables) to be predicted within a bounded range. Note that the specific independent variables need not be engine RPM and engine load and need not be limited to two variables. For example, engine operating hours could be added as an independent variable in the map to account for engine degradation with operating time.

In order to create an engine model, a training time period is selected in which the engine had no apparent operational issues. In some embodiments, a machine learning algorithm is used to generate the engine models directly on the edge device, in a local or remote server, or in the cloud. A modeling technique can be selected that offers low model bias (e.g. spline, neural network or support vector machines (SVM), and/or a Generalized Additive Model (GAM)). See:

U.S. Pat. Nos. 1,006,1887; 10,126,309; 10,154,624; 10,168,337; 10,187,899; 6,006,182; 6,064,960; 6,366,884; 6,401,070; 6,553,344; 6,785,652; 7,039,654; 7,144,869; 7,379,890; 7,389,114; 7,401,057; 7,426,499; 7,547,683; 7,561,972; 7,561,973; 7,583,961; 7,653,491; 7,693,683; 7,698,213; 7,702,576; 7,729,864; 7,730,063; 7,774,272; 7,813,981; 7,873,567; 7,873,634; 7,970,640; 8,005,620; 8,126,653; 8,152,750; 8,185,486; 8,401,798; 8,412,461; 8,498,915; 8,515,719; 8,566,070; 8,635,029; 8,694,455; 8,713,025; 8,724,866; 8,731,728; 8,843,356; 8,929,568; 8,992,453; 9,020,866; 9,037,256; 9,075,796; 9,092,391; 9,103,826; 9,204,319; 9,205,064; 9,297,814; 9,428,767; 9,471,884; 9,483,531; 9,534,234; 9,574,209; 9,580,697; 9,619,883; 9,886,545; 9,900,790; 9,903,193; 9,955,488; 9,992,123; 20010009904; 20010034686; 20020001574; 20020138012; 20020138270; 20030023951; 20030093277; 20040073414; 20040088239; 20040110697; 20040172319; 20040199445; 20040210509; 20040215551; 20040225629; 20050071266; 20050075597; 20050096963; 20050144106; 20050176442; 20050245252; 20050246314; 20050251468; 20060059028; 20060101017; 20060111849; 20060122816; 20060136184; 20060184473; 20060189553; 20060241869; 20070038386; 20070043656; 20070067195; 20070105804; 20070166707; 20070185656; 20070233679; 20080015871; 20080027769; 20080027841; 20080050357; 20080114564; 20080140549; 20080228744; 20080256069; 20080306804; 20080313073; 20080319897; 20090018891; 20090030771; 20090037402; 20090037410; 20090043637; 20090050492; 20090070182; 20090132448; 20090171740; 20090220965; 20090271342; 20090313041; 20100028870; 20100029493; 20100042438; 20100070455; 20100082617; 20100100331; 20100114793; 20100293130; 20110054949; 20110059860; 20110064747; 20110075920; 20110111419; 20110123986; 20110123987; 20110166844; 20110230366; 20110276828; 20110287946; 20120010867; 20120066217; 20120136629; 20120150032; 20120158633; 20120207771; 20120220958; 20120230515; 20120258874; 20120283885; 20120284207; 20120290505; 20120303408; 20120303504; 20130004473; 20130030584; 20130054486; 20130060305; 20130073442; 20130096892; 20130103570; 20130132163; 20130183664; 20130185226; 20130259847; 20130266557; 20130315885; 20140006013; 20140032186; 20140100128; 20140172444; 20140193919; 20140278967; 20140343959; 20150023949; 20150235143; 20150240305; 20150289149; 20150291975; 20150291976; 20150291977; 20150316562; 20150317449; 20150324548; 20150347922; 20160003845; 20160042513; 20160117327; 20160145693; 20160148237; 20160171398; 20160196587; 20160225073; 20160225074; 20160239919; 20160282941; 20160333328; 20160340691; 20170046347; 20170126009; 20170132537; 20170137879; 20170191134; 20170244777; 20170286594; 20170290024; 20170306745; 20170308672; 20170308846; 20180006957; 20180017564; 20180018683; 20180035605; 20180046926; 20180060458; 20180060738; 20180060744; 20180120133; 20180122020; 20180189564; 20180227930; 20180260515; 20180260717; 20180262433; 20180263606; 20180275146; 20180282736; 20180293511; 20180334721; 20180341958; 20180349514; 20190010554; and 20190024497.

In statistics, the generalized linear model (GLM) is a flexible generalization of ordinary linear regression that allows for response variables that have error distribution models other than a normal distribution. The GLM generalizes linear regression by allowing the linear model to be related to the response variable via a link function and by allowing the magnitude of the variance of each measurement to be a function of its predicted value. Generalized linear models unify various other statistical models, including linear regression, logistic regression and Poisson regression, and employs an iteratively reweighted least squares method for maximum likelihood estimation of the model parameters. See:

U.S. Pat. No. 1,000,2367; 10,006,088; 10,009,366; 10,013,701; 10,013,721; 10,018,631; 10,019,727; 10,021,426; 10,023,877; 10,036,074; 10,036,638; 10,037,393; 10,038,697; 10,047,358; 10,058,519; 10,062,121; 10,070,166; 10,070,220; 10,071,151; 10,080,774; 10,092,509; 10,098,569; 10,098,908; 10,100,092; 10,101,340; 10,111,888; 10,113,198; 10,113,200; 10,114,915; 10,117,868; 10,131,949; 10,142,788; 10,147,173; 10,157,509; 10,172,363; 10,175,387; 10,181,010; 5,529,901; 5,641,689; 5,667,541; 5,770,606; 5,915,036; 5,985,889; 6,043,037; 6,121,276; 6,132,974; 6,140,057; 6,200,983; 6,226,393; 6,306,437; 6,411,729; 6,444,870; 6,519,599; 6,566,368; 6,633,857; 6,662,185; 6,684,252; 6,703,231; 6,704,718; 6,879,944; 6,895,083; 6,939,670; 7,020,578; 7,043,287; 7,069,258; 7,117,185; 7,179,797; 7,208,517; 7,228,171; 7,238,799; 7,268,137; 7,306,913; 7,309,598; 7,337,033; 7,346,507; 7,445,896; 7,473,687; 7,482,117; 7,494,783; 7,516,572; 7,550,504; 7,590,516; 7,592,507; 7,593,815; 7,625,699; 7,651,840; 7,662,564; 7,685,084; 7,693,683; 7,695,911; 7,695,916; 7,700,074; 7,702,482; 7,709,460; 7,711,488; 7,727,725; 7,743,009; 7,747,392; 7,751,984; 7,781,168; 7,799,530; 7,807,138; 7,811,794; 7,816,083; 7,820,380; 7,829,282; 7,833,706; 7,840,408; 7,853,456; 7,863,021; 7,888,016; 7,888,461; 7,888,486; 7,890,403; 7,893,041; 7,904,135; 7,910,107; 7,910,303; 7,913,556; 7,915,244; 7,921,069; 7,933,741; 7,947,451; 7,953,676; 7,977,052; 7,987,148; 7,993,833; 7,996,342; 8,010,476; 8,017,317; 8,024,125; 8,027,947; 8,037,043; 8,039,212; 8,071,291; 8,071,302; 8,094,713; 8,103,537; 8,135,548; 8,148,070; 8,153,366; 8,211,638; 8,214,315; 8,216,786; 8,217,078; 8,222,270; 8,227,189; 8,234,150; 8,234,151; 8,236,816; 8,283,440; 8,291,069; 8,299,109; 8,311,849; 8,328,950; 8,346,688; 8,349,327; 8,351,688; 8,364,627; 8,372,625; 8,374,837; 8,383,338; 8,412,465; 8,415,093; 8,434,356; 8,452,621; 8,452,638; 8,455,468; 8,461,849; 8,463,582; 8,465,980; 8,473,249; 8,476,077; 8,489,499; 8,496,934; 8,497,084; 8,501,718; 8,501,719; 8,514,928; 8,515,719; 8,521,294; 8,527,352; 8,530,831; 8,543,428; 8,563,295; 8,566,070; 8,568,995; 8,569,574; 8,600,870; 8,614,060; 8,618,164; 8,626,697; 8,639,618; 8,645,298; 8,647,819; 8,652,776; 8,669,063; 8,682,812; 8,682,876; 8,706,589; 8,712,937; 8,715,704; 8,715,943; 8,718,958; 8,725,456; 8,725,541; 8,731,977; 8,732,534; 8,741,635; 8,741,956; 8,754,805; 8,769,094; 8,787,638; 8,799,202; 8,805,619; 8,811,670; 8,812,362; 8,822,149; 8,824,762; 8,871,901; 8,877,174; 8,889,662; 8,892,409; 8,903,192; 8,903,531; 8,911,958; 8,912,512; 8,956,608; 8,962,680; 8,965,625; 8,975,022; 8,977,421; 8,987,686; 9,011,877; 9,030,565; 9,034,401; 9,036,910; 9,037,256; 9,040,023; 9,053,537; 9,056,115; 9,061,004; 9,061,055; 9,069,352; 9,072,496; 9,074,257; 9,080,212; 9,106,718; 9,116,722; 9,128,991; 9,132,110; 9,186,107; 9,200,324; 9,205,092; 9,207,247; 9,208,209; 9,210,446; 9,211,103; 9,216,010; 9,216,213; 9,226,518; 9,232,217; 9,243,493; 9,275,353; 9,292,550; 9,361,274; 9,370,501; 9,370,509; 9,371,565; 9,374,671; 9,375,412; 9,375,436; 9,389,235; 9,394,345; 9,399,061; 9,402,871; 9,415,029; 9,451,920; 9,468,541; 9,503,467; 9,534,258; 9,536,214; 9,539,223; 9,542,939; 9,555,069; 9,555,251; 9,563,921; 9,579,337; 9,585,868; 9,615,585; 9,625,646; 9,633,401; 9,639,807; 9,639,902; 9,650,678; 9,663,824; 9,668,104; 9,672,474; 9,674,210; 9,675,642; 9,679,378; 9,681,835; 9,683,832; 9,701,721; 9,710,767; 9,717,459; 9,727,616; 9,729,568; 9,734,122; 9,734,290; 9,740,979; 9,746,479; 9,757,388; 9,758,828; 9,760,907; 9,769,619; 9,775,818; 9,777,327; 9,786,012; 9,790,256; 9,791,460; 9,792,741; 9,795,335; 9,801,857; 9,801,920; 9,809,854; 9,811,794; 9,836,577; 9,870,519; 9,871,927; 9,881,339; 9,882,660; 9,886,771; 9,892,420; 9,926,368; 9,926,593; 9,932,637; 9,934,239; 9,938,576; 9,949,659; 9,949,693; 9,951,348; 9,955,190; 9,959,285; 9,961,488; 9,967,714; 9,972,014; 9,974,773; 9,976,182; 9,982,301; 9,983,216; 9,986,527; 9,988,624; 9,990,648; 9,990,649; 9,993,735; 20020016699; 20020055457; 20020099686; 20020184272; 20030009295; 20030021848; 20030023951; 20030050265; 20030073715; 20030078738; 20030104499; 20030139963; 20030166017; 20030166026; 20030170660; 20030170700; 20030171685; 20030171876; 20030180764; 20030190602; 20030198650; 20030199685; 20030220775; 20040063095; 20040063655; 20040073414; 20040092493; 20040115688; 20040116409; 20040116434; 20040127799; 20040138826; 20040142890; 20040157783; 20040166519; 20040265849; 20050002950; 20050026169; 20050080613; 20050096360; 20050113306; 20050113307; 20050164206; 20050171923; 20050272054; 20050282201; 20050287559; 20060024700; 20060035867; 20060036497; 20060084070; 20060084081; 20060142983; 20060143071; 20060147420; 20060149522; 20060164997; 20060223093; 20060228715; 20060234262; 20060278241; 20060286571; 20060292547; 20070026426; 20070031846; 20070031847; 20070031848; 20070036773; 20070037208; 20070037241; 20070042382; 20070049644; 20070054278; 20070059710; 20070065843; 20070072821; 20070078117; 20070078434; 20070087000; 20070088248; 20070123487; 20070129948; 20070167727; 20070190056; 20070202518; 20070208600; 20070208640; 20070239439; 20070254289; 20070254369; 20070255113; 20070259954; 20070275881; 20080032628; 20080033589; 20080038230; 20080050732; 20080050733; 20080051318; 20080057500; 20080059072; 20080076120; 20080103892; 20080108081; 20080108713; 20080114564; 20080127545; 20080139402; 20080160046; 20080166348; 20080172205; 20080176266; 20080177592; 20080183394; 20080195596; 20080213745; 20080241846; 20080248476; 20080286796; 20080299554; 20080301077; 20080305967; 20080306034; 20080311572; 20080318219; 20080318914; 20090006363; 20090035768; 20090035769; 20090035772; 20090053745; 20090055139; 20090070081; 20090076890; 20090087909; 20090089022; 20090104620; 20090107510; 20090112752; 20090118217; 20090119357; 20090123441; 20090125466; 20090125916; 20090130682; 20090131702; 20090132453; 20090136481; 20090137417; 20090157409; 20090162346; 20090162348; 20090170111; 20090175830; 20090176235; 20090176857; 20090181384; 20090186352; 20090196875; 20090210363; 20090221438; 20090221620; 20090226420; 20090233299; 20090253952; 20090258003; 20090264453; 20090270332; 20090276189; 20090280566; 20090285827; 20090298082; 20090306950; 20090308600; 20090312410; 20090325920; 20100003691; 20100008934; 20100010336; 20100035983; 20100047798; 20100048525; 20100048679; 20100063851; 20100076949; 20100113407; 20100120040; 20100132058; 20100136553; 20100136579; 20100137409; 20100151468; 20100174336; 20100183574; 20100183610; 20100184040; 20100190172; 20100191216; 20100196400; 20100197033; 20100203507; 20100203508; 20100215645; 20100216154; 20100216655; 20100217648; 20100222225; 20100249188; 20100261187; 20100268680; 20100272713; 20100278796; 20100284989; 20100285579; 20100310499; 20100310543; 20100330187; 20110004509; 20110021555; 20110027275; 20110028333; 20110054356; 20110065981; 20110070587; 20110071033; 20110077194; 20110077215; 20110077931; 20110079077; 20110086349; 20110086371; 20110086796; 20110091994; 20110093288; 20110104121; 20110106736; 20110118539; 20110123100; 20110124119; 20110129831; 20110130303; 20110131160; 20110135637; 20110136260; 20110137851; 20110150323; 20110173116; 20110189648; 20110207659; 20110207708; 20110208738; 20110213746; 20110224181; 20110225037; 20110251272; 20110251995; 20110257216; 20110257217; 20110257218; 20110257219; 20110263633; 20110263634; 20110263635; 20110263636; 20110263637; 20110269735; 20110276828; 20110284029; 20110293626; 20110302823; 20110307303; 20110311565; 20110319811; 20120003212; 20120010274; 20120016106; 20120016436; 20120030082; 20120039864; 20120046263; 20120064512; 20120065758; 20120071357; 20120072781; 20120082678; 20120093376; 20120101965; 20120107370; 20120108651; 20120114211; 20120114620; 20120121618; 20120128223; 20120128702; 20120136629; 20120154149; 20120156215; 20120163656; 20120165221; 20120166291; 20120173200; 20120184605; 20120209565; 20120209697; 20120220055; 20120239489; 20120244145; 20120245133; 20120250963; 20120252050; 20120252695; 20120257164; 20120258884; 20120264692; 20120265978; 20120269846; 20120276528; 20120280146; 20120301407; 20120310619; 20120315655; 20120316833; 20120330720; 20130012860; 20130024124; 20130024269; 20130029327; 20130029384; 20130030051; 20130040922; 20130040923; 20130041034; 20130045198; 20130045958; 20130058914; 20130059827; 20130059915; 20130060305; 20130060549; 20130061339; 20130065870; 20130071033; 20130073213; 20130078627; 20130080101; 20130081158; 20130102918; 20130103615; 20130109583; 20130112895; 20130118532; 20130129764; 20130130923; 20130138481; 20130143215; 20130149290; 20130151429; 20130156767; 20130171296; 20130197081; 20130197738; 20130197830; 20130198203; 20130204664; 20130204833; 20130209486; 20130210855; 20130211229; 20130212168; 20130216551; 20130225439; 20130237438; 20130237447; 20130240722; 20130244233; 20130244902; 20130244965; 20130252267; 20130252822; 20130262425; 20130271668; 20130273103; 20130274195; 20130280241; 20130288913; 20130303558; 20130303939; 20130310261; 20130315894; 20130325498; 20130332231; 20130332338; 20130346023; 20130346039; 20130346844; 20140004075; 20140004510; 20140011206; 20140011787; 20140038930; 20140058528; 20140072550; 20140072957; 20140080784; 20140081675; 20140086920; 20140087960; 20140088406; 20140093127; 20140093974; 20140095251; 20140100989; 20140106370; 20140107850; 20140114746; 20140114880; 20140120137; 20140120533; 20140127213; 20140128362; 20140134186; 20140134625; 20140135225; 20140141988; 20140142861; 20140143134; 20140148505; 20140156231; 20140156571; 20140163096; 20140170069; 20140171337; 20140171382; 20140172507; 20140178348; 20140186333; 20140188918; 20140199290; 20140200953; 20140200999; 20140213533; 20140219968; 20140221484; 20140234291; 20140234347; 20140235605; 20140236965; 20140242180; 20140244216; 20140249447; 20140249862; 20140256576; 20140258355; 20140267700; 20140271672; 20140274885; 20140278148; 20140279053; 20140279306; 20140286935; 20140294903; 20140303481; 20140316217; 20140323897; 20140324521; 20140336965; 20140343786; 20140349984; 20140365144; 20140365276; 20140376645; 20140378334; 20150001420; 20150002845; 20150004641; 20150005176; 20150006605; 20150007181; 20150018632; 20150019262; 20150025328; 20150031578; 20150031969; 20150032598; 20150032675; 20150039265; 20150051896; 20150051949; 20150056212; 20150064194; 20150064195; 20150064670; 20150066738; 20150072434; 20150072879; 20150073306; 20150078460; 20150088783; 20150089399; 20150100407; 20150100408; 20150100409; 20150100410; 20150100411; 20150100412; 20150111775; 20150112874; 20150119759; 20150120758; 20150142331; 20150152176; 20150167062; 20150169840; 20150178756; 20150190367; 20150190436; 20150191787; 20150205756; 20150209586; 20150213192; 20150215127; 20150216164; 20150216922; 20150220487; 20150228031; 20150228076; 20150231191; 20150232944; 20150240304; 20150240314; 20150250816; 20150259744; 20150262511; 20150272464; 20150287143; 20150292010; 20150292016; 20150299798; 20150302529; 20150306160; 20150307614; 20150320707; 20150320708; 20150328174; 20150332013; 20150337373; 20150341379; 20150348095; 20150356458; 20150359781; 20150361494; 20150366830; 20150377909; 20150378807; 20150379428; 20150379429; 20150379430; 20160010162; 20160012334; 20160017037; 20160017426; 20160024575; 20160029643; 20160029945; 20160032388; 20160034640; 20160034664; 20160038538; 20160040184; 20160040236; 20160042009; 20160042197; 20160045466; 20160046991; 20160048925; 20160053322; 20160058717; 20160063144; 20160068890; 20160068916; 20160075665; 20160078361; 20160097082; 20160105801; 20160108473; 20160108476; 20160110657; 20160110812; 20160122396; 20160124933; 20160125292; 20160138105; 20160139122; 20160147013; 20160152538; 20160163132; 20160168639; 20160171618; 20160171619; 20160173122; 20160175321; 20160198657; 20160202239; 20160203279; 20160203316; 20160222100; 20160222450; 20160224724; 20160224869; 20160228056; 20160228392; 20160237487; 20160243190; 20160243215; 20160244836; 20160244837; 20160244840; 20160249152; 20160250228; 20160251720; 20160253324; 20160253330; 20160259883; 20160265055; 20160271144; 20160281105; 20160281164; 20160282941; 20160295371; 20160303111; 20160303172; 20160306075; 20160307138; 20160310442; 20160319352; 20160344738; 20160352768; 20160355886; 20160359683; 20160371782; 20160378942; 20170004409; 20170006135; 20170007574; 20170009295; 20170014032; 20170014108; 20170016896; 20170017904; 20170022563; 20170022564; 20170027940; 20170028006; 20170029888; 20170029889; 20170032100; 20170035011; 20170037470; 20170046499; 20170051019; 20170051359; 20170052945; 20170056468; 20170061073; 20170067121; 20170068795; 20170071884; 20170073756; 20170074878; 20170076303; 20170088900; 20170091673; 20170097347; 20170098240; 20170098257; 20170098278; 20170099836; 20170100446; 20170103190; 20170107583; 20170108502; 20170112792; 20170116624; 20170116653; 20170117064; 20170119662; 20170124520; 20170124528; 20170127110; 20170127180; 20170135647; 20170140122; 20170140424; 20170145503; 20170151217; 20170156344; 20170157249; 20170159045; 20170159138; 20170168070; 20170177813; 20170180798; 20170193647; 20170196481; 20170199845; 20170214799; 20170219451; 20170224268; 20170226164; 20170228810; 20170231221; 20170233809; 20170233815; 20170235894; 20170236060; 20170238850; 20170238879; 20170242972; 20170246963; 20170247673; 20170255888; 20170255945; 20170259178; 20170261645; 20170262580; 20170265044; 20170268066; 20170270580; 20170280717; 20170281747; 20170286594; 20170286608; 20170286838; 20170292159; 20170298126; 20170300814; 20170300824; 20170301017; 20170304248; 20170310697; 20170311895; 20170312289; 20170312315; 20170316150; 20170322928; 20170344554; 20170344555; 20170344556; 20170344954; 20170347242; 20170350705; 20170351689; 20170351806; 20170351811; 20170353825; 20170353826; 20170353827; 20170353941; 20170363738; 20170364596; 20170364817; 20170369534; 20170374521; 20180000102; 20180003722; 20180005149; 20180010136; 20180010185; 20180010197; 20180010198; 20180011110; 20180014771; 20180017545; 20180017564; 20180017570; 20180020951; 20180021279; 20180031589; 20180032876; 20180032938; 20180033088; 20180038994; 20180049636; 20180051344; 20180060513; 20180062941; 20180064666; 20180067010; 20180067118; 20180071285; 20180075357; 20180077146; 20180078605; 20180080081; 20180085168; 20180085355; 20180087098; 20180089389; 20180093418; 20180093419; 20180094317; 20180095450; 20180108431; 20180111051; 20180114128; 20180116987; 20180120133; 20180122020; 20180128824; 20180132725; 20180143986; 20180148776; 20180157758; 20180160982; 20180171407; 20180182181; 20180185519; 20180191867; 20180192936; 20180193652; 20180201948; 20180206489; 20180207248; 20180214404; 20180216099; 20180216100; 20180216101; 20180216132; 20180216197; 20180217141; 20180217143; 20180218117; 20180225585; 20180232421; 20180232434; 20180232661; 20180232700; 20180232702; 20180232904; 20180235549; 20180236027; 20180237825; 20180239829; 20180240535; 20180245154; 20180251819; 20180251842; 20180254041; 20180260717; 20180263962; 20180275629; 20180276325; 20180276497; 20180276498; 20180276570; 20180277146; 20180277250; 20180285765; 20180285900; 20180291398; 20180291459; 20180291474; 20180292384; 20180292412; 20180293462; 20180293501; 20180293759; 20180300333; 20180300639; 20180303354; 20180303906; 20180305762; 20180312923; 20180312926; 20180314964; 20180315507; 20180322203; 20180323882; 20180327740; 20180327806; 20180327844; 20180336534; 20180340231; 20180344841; 20180353138; 20180357361; 20180357362; 20180357529; 20180357565; 20180357726; 20180358118; 20180358125; 20180358128; 20180358132; 20180359608; 20180360892; 20180365521; 20180369238; 20180369696; 20180371553; 20190000750; 20190001219; 20190004996; 20190005586; 20190010548; 20190015035; 20190017117; 20190017123; 20190024174; 20190032136; 20190033078; 20190034473; 20190034474; 20190036779; 20190036780; and 20190036816.

Ordinary linear regression predicts the expected value of a given unknown quantity (the response variable, a random variable) as a linear combination of a set of observed values (predictors). This implies that a constant change in a predictor leads to a constant change in the response variable (i.e. a linear-response model). This is appropriate when the response variable has a normal distribution (intuitively, when a response variable can vary essentially indefinitely in either direction with no fixed “zero value”, or more generally for any quantity that only varies by a relatively small amount, e.g. human heights). However, these assumptions can be inappropriate for some types of response variables. For example, in cases where the response variable is expected to be always positive and varying over a wide range, constant input changes lead to geometrically varying, rather than constantly varying, output changes.

In a GLM, each outcome Y of the dependent variables is assumed to be generated from a particular distribution in the exponential family, a large range of probability distributions that includes the normal, binomial, Poisson and gamma distributions, among others.

The GLM consists of three elements: A probability distribution from the exponential family; a linear predictor η=Xβ; and a link function g such that E(Y)=μ=g−1(η). The linear predictor is the quantity which incorporates the information about the independent variables into the model. The symbol η (Greek “eta”) denotes a linear predictor. It is related to the expected value of the data through the link function. η is expressed as linear combinations (thus, “linear”) of unknown parameters β. The coefficients of the linear combination are represented as the matrix of independent variables X. η can thus be expressed as the link function and provides the relationship between the linear predictor and the mean of the distribution function. There are many commonly used link functions, and their choice is informed by several considerations. There is always a well-defined canonical link function which is derived from the exponential of the response's density function. However, in some cases it makes sense to try to match the domain of the link function to the range of the distribution function's mean or use a non-canonical link function for algorithmic purposes, for example Bayesian probit regression. For the most common distributions, the mean is one of the parameters in the standard form of the distribution's density function, and then is the function as defined above that maps the density function into its canonical form. A simple, important example of a generalized linear model (also an example of a general linear model) is linear regression. In linear regression, the use of the least-squares estimator is justified by the Gauss-Markov theorem, which does not assume that the distribution is normal.

The standard GLM assumes that the observations are uncorrelated. Extensions have been developed to allow for correlation between observations, as occurs for example in longitudinal studies and clustered designs. Generalized estimating equations (GEEs) allow for the correlation between observations without the use of an explicit probability model for the origin of the correlations, so there is no explicit likelihood. They are suitable when the random effects and their variances are not of inherent interest, as they allow for the correlation without explaining its origin. The focus is on estimating the average response over the population (“population-averaged” effects) rather than the regression parameters that would enable prediction of the effect of changing one or more components of X on a given individual. GEEs are usually used in conjunction with Huber-White standard errors. Generalized linear mixed models (GLMMs) are an extension to GLMs that includes random effects in the linear predictor, giving an explicit probability model that explains the origin of the correlations. The resulting “subject-specific” parameter estimates are suitable when the focus is on estimating the effect of changing one or more components of X on a given individual. GLMMs are also referred to as multilevel models and as mixed model. In general, fitting GLMMs is more computationally complex and intensive than fitting GEEs.

In statistics, a generalized additive model (GAM) is a generalized linear model in which the linear predictor depends linearly on unknown smooth functions of some predictor variables, and interest focuses on inference about these smooth functions. GAMs were originally developed by Trevor Hastie and Robert Tibshirani to blend properties of generalized linear models with additive models.

The model relates a univariate response variable, to some predictor variables. An exponential family distribution is specified for (for example normal, binomial or Poisson distributions) along with a link function g (for example the identity or log functions) relating the expected value of univariate response variable to the predictor variables.

The functions may have a specified parametric form (for example a polynomial, or an un-penalized regression spline of a variable) or may be specified non-parametrically, or semi-parametrically, simply as ‘smooth functions’, to be estimated by non-parametric means. A typical GAM might use a scatterplot smoothing function, such as a locally weighted mean. This flexibility to allow non-parametric fits with relaxed assumptions on the actual relationship between response and predictor, provides the potential for better fits to data than purely parametric models, but arguably with some loss of interpretability.

Any multivariate function can be represented as sums and compositions of univariate functions. Unfortunately, though the Kolmogorov-Arnold representation theorem asserts the existence of a function of this form, it gives no mechanism whereby one could be constructed. Certain constructive proofs exist, but they tend to require highly complicated (i.e., fractal) functions, and thus are not suitable for modeling approaches. It is not clear that any step-wise (i.e. backfitting algorithm) approach could even approximate a solution. Therefore, the Generalized Additive Model drops the outer sum, and demands instead that the function belong to a simpler class.

The original GAM fitting method estimated the smooth components of the model using non-parametric smoothers (for example smoothing splines or local linear regression smoothers) via the backfitting algorithm. Backfitting works by iterative smoothing of partial residuals and provides a very general modular estimation method capable of using a wide variety of smoothing methods to estimate the terms. Many modern implementations of GAMs and their extensions are built around the reduced rank smoothing approach, because it allows well founded estimation of the smoothness of the component smooths at comparatively modest computational cost, and also facilitates implementation of a number of model extensions in a way that is more difficult with other methods. At its simplest the idea is to replace the unknown smooth functions in the model with basis expansions. Smoothing bias complicates interval estimation for these models, and the simplest approach turns out to involve a Bayesian approach. Understanding this Bayesian view of smoothing also helps to understand the REML and full Bayes approaches to smoothing parameter estimation. At some level smoothing penalties are imposed.

Overfitting can be a problem with GAMs, especially if there is un-modelled residual auto-correlation or un-modelled overdispersion. Cross-validation can be used to detect and/or reduce overfitting problems with GAMs (or other statistical methods), and software often allows the level of penalization to be increased to force smoother fits. Estimating very large numbers of smoothing parameters is also likely to be statistically challenging, and there are known tendencies for prediction error criteria (GCV, AIC etc.) to occasionally undersmooth substantially, particularly at moderate sample sizes, with REML being somewhat less problematic in this regard. Where appropriate, simpler models such as GLMs may be preferable to GAMs unless GAMs improve predictive ability substantially (in validation sets) for the application in question. In addition, univariate outlier detection approaches can be implemented where effective. These approaches can look for values that surpass the normal range of distribution for a given machine component and could include calculation of Z-scores or Robust Z-scores (using the median absolute deviation).
Augustin, N. H.; Sauleau, E-A; Wood, S. N. (2012). “On quantile quantile plots for generalized linear models”. Computational Statistics and Data Analysis. 56: 2404-2409. doi: 10.1016/j.csda.2012.01.026.
Brian Junker (Mar. 22, 2010). “Additive models and cross-validation”.
Chambers, J. M.; Hastie, T. (1993). Statistical Models in S. Chapman and Hall.
Dobson, A. J.; Barnett, A. G. (2008). Introduction to Generalized Linear Models (3rd ed.). Boca Raton, Fla.: Chapman and Hall/CRC. ISBN 1-58488-165-8.
Fahrmeier, L.; Lang, S. (2001). “Bayesian Inference for Generalized Additive Mixed Models based on Markov Random Field Priors”. Journal of the Royal Statistical Society, Series C. 50: 201-220.
Greven, Sonja; Kneib, Thomas (2010). “On the behaviour of marginal and conditional AIC in linear mixed models”. Biometrika. 97: 773-789. doi:10.1093/biomet/asq042.
Gu, C.; Wahba, G. (1991). “Minimizing GCV/GML scores with multiple smoothing parameters via the Newton method”. SIAM Journal on Scientific and Statistical Computing. 12. pp. 383-398.
Gu, Chong (2013). Smoothing Spline ANOVA Models (2nd ed.). Springer.
Hardin, James; Hilbe, Joseph (2003). Generalized Estimating Equations. London: Chapman and Hall/CRC. ISBN 1-58488-307-3.
Hardin, James; Hilbe, Joseph (2007). Generalized Linear Models and Extensions (2nd ed.). College Station: Stata Press. ISBN 1-59718-014-9.
Hastie, T. J.; Tibshirani, R. J. (1990). Generalized Additive Models. Chapman & Hall/CRC. ISBN 978-0-412-34390-2.
Kim, Y. J.; Gu, C. (2004). “Smoothing spline Gaussian regression: more scalable computation via efficient approximation”. Journal of the Royal Statistical Society, Series B. 66. pp. 337-356.
Madsen, Henrik; Thyregod, Poul (2011). Introduction to General and Generalized Linear Models. Chapman & Hall/CRC. ISBN 978-1-4200-9155-7.
Marra, G.; Wood, S. N. (2011). “Practical Variable Selection for Generalized Additive Models”. Computational Statistics and Data Analysis. 55: 2372-2387. doi:10.1016/j.csda.2011.02.004.
Marra, G.; Wood, S. N. (2012). “Coverage properties of confidence intervals for generalized additive model components”. Scandinavian Journal of Statistics. 39: 53-74. doi:10.1111/j.1467-9469.2011.00760.x.
Mayr, A.; Fenske, N.; Hofner, B.; Kneib, T.; Schmid, M. (2012). “Generalized additive models for location, scale and shape for high dimensional data—a flexible approach based on boosting”. Journal of the Royal Statistical Society, Series C. 61: 403-427. doi:10.1111/j.1467-9876.2011.01033.x.
McCullagh, Peter; Nelder, John (1989). Generalized Linear Models, Second Edition. Boca Raton: Chapman and Hall/CRC. ISBN 0-412-31760-5.
Nelder, John; Wedderburn, Robert (1972). “Generalized Linear Models”. Journal of the Royal Statistical Society. Series A (General). Blackwell Publishing. 135 (3): 370-384. doi:10.2307/2344614. JSTOR 2344614.
Nychka, D. (1988). “Bayesian confidence intervals for smoothing splines”. Journal of the American Statistical Association. 83. pp. 1134-1143.
Reiss, P. T.; Ogden, T. R. (2009). “Smoothing parameter selection for a class of semiparametric linear models”. Journal of the Royal Statistical Society, Series B. 71: 505-523. doi:10.1111/j.1467-9868.2008.00695.x.
Rigby, R. A.; Stasinopoulos, D. M. (2005). “Generalized additive models for location, scale and shape (with discussion)”. Journal of the Royal Statistical Society, Series C. 54: 507-554. doi:10.1111/j.1467-9876.2005.00510.x.
Rue, H.; Martino, Sara; Chopin, Nicolas (2009). “Approximate Bayesian inference for latent Gaussian models by using integrated nested Laplace approximations (with discussion)”. Journal of the Royal Statistical Society, Series B. 71: 319-392. doi:10.1111/j.1467-9868.2008.00700.x.
Ruppert, D.; Wand, M. P.; Carroll, R. J. (2003). Semiparametric Regression. Cambridge University Press.
Schmid, M.; Hothorn, T. (2008). “Boosting additive models using component-wise P-splines”. Computational Statistics and Data Analysis. 53: 298-311. doi:10.1016/j.csda.2008.09.009.
Senn, Stephen (2003). “A conversation with John Nelder”. Statistical Science. 18 (1): 118-131. doi:10.1214/ss/1056397489.
Silverman, B. W. (1985). “Some Aspects of the Spline Smoothing Approach to Non-Parametric Regression Curve Fitting (with discussion)”. Journal of the Royal Statistical Society, Series B. 47. pp. 1-53.
Umlauf, Nikolaus; Adler, Daniel; Kneib, Thomas; Lang, Stefan; Zeileis, Achim. “Structured Additive Regression Models: An R Interface to BayesX”. Journal of Statistical Software. 63 (21): 1-46.
Wahba, G. (1983). “Bayesian Confidence Intervals for the Cross Validated Smoothing Spline”. Journal of the Royal Statistical Society, Series B. 45. pp. 133-150.
Wahba, Grace. Spline Models for Observational Data. SIAM Rev., 33(3), 502-502 (1991).
Wood, S. N. (2000). “Modelling and smoothing parameter estimation with multiple quadratic penalties”. Journal of the Royal Statistical Society. Series B. 62 (2): 413-428. doi:10.1111/1467-9868.00240.
Wood, S. N. (2017). Generalized Additive Models: An Introduction with R (2nd ed). Chapman & Hall/CRC. ISBN 978-1-58488-474-3.
Wood, S. N.; Pya, N.; Saefken, B. (2016). “Smoothing parameter and model selection for general smooth models (with discussion)”. Journal of the American Statistical Association. 111: 1548-1575. doi:10.1080/01621459.2016.1180986.
Wood, S. N. (2011). “Fast stable restricted maximum likelihood and marginal likelihood estimation of semiparametric generalized linear models”. Journal of the Royal Statistical Society, Series B. 73: 3-36.
Wood, Simon (2006). Generalized Additive Models: An Introduction with R. Chapman & Hall/CRC. ISBN 1-58488-474-6.
Wood, Simon N. (2008). “Fast stable direct fitting and smoothness selection for generalized additive models”. Journal of the Royal Statistical Society, Series B. 70 (3): 495-518. arXiv:0709.3906. doi:10.111/j.1467-9868.2007.00646.x.
Yee, Thomas (2015). Vector generalized linear and additive models. Springer. ISBN 978-1-4939-2817-0.
Zeger, Scott L.; Liang, Kung-Yee; Albert, Paul S. (1988). “Models for Longitudinal Data: A Generalized Estimating Equation Approach”. Biometrics. International Biometric Society. 44 (4): 1049-1060. doi:10.2307/2531734. JSTOR 2531734. PMID 3233245.

In some embodiments, the programming language ‘R’ is used as an environment for statistical computing and graphics and for creating appropriate models. Error statistics and/or the z-scores of the predicted errors are used to further minimize prediction errors.

The engine's operating ranges can be divided into multiple distinct ranges and multiple multi-dimensional models can be built to improve model accuracy.

Next, depending on the capabilities of the edge device (e.g., whether or not it can execute the programming language ‘R’), engine models are deployed as R models or the equivalent database lookup tables are generated and deployed, that describe the models for the bounded region of the independent variables.

The same set of training data that was used to build the model is then passed as an input set to the model, in order to create a predicted sensor value(s) time series. By subtracting the predicted sensor values from the measured sensor values, an error time series for all the dependent sensor values is created for the training data set. The error statistics, namely mean and standard deviations of the training period error series, are computed and saved as the training period error statistics.

In some embodiments, in order for the z-statistics to work, the edge device typically needs to select more than 30 samples for every data point and provide average value for every minute. Some embodiments implement the system with approximately 60 samples per minute (1 sec interval) and edge device calculates every minute's average values by averaging (arithmetic mean) the values for every minute.

Once the model is deployed to the edge device, and the system is operational, the dependent and independent sensor values can be measured in near real-time and the minute's average data may be computed. The expected value for dependent engine sensors can be predicted by passing the independent sensor values to the engine model. The error (i.e., the difference) between the measured value of a dependent variable and its predicted value, can then be computed. These errors are standardized by subtracting the training error mean from the instantaneous error and dividing this difference by the training error standard deviations for a given sensor. This process creates z-scores of error or standard error time-series that can be used to detect anomalies and, with an alert processing system, detect and send notifications to on-board and shore based systems at near real-time when the standard error is above/below a certain number of error standard deviations or is above/below a certain z-score.

According to some embodiments, an anomaly classification system may also be deployed that ties anomalies to particular kinds of engine failures. The z-scores of an error data series from multiple engine sensors are classified (as failures or not failures) in near real-time and to a high degree of certainty through previous training on problem cases, learned engine issues, and/or engine sensor issues.

This classification may be by neural network or deep neural network, clustering algorithm, principal component analysis, various statistical algorithms, or the like. Some examples are described in the incorporated references, supra.

Some embodiments of the classification system provide a mechanism (e.g., a design and deployment tool(s)) to select unique, short time periods for an asset and tag (or label) the selected periods with arbitrary strings that denote classification types. A user interface may be used to view historical engine data and/or error time series data, and to select and tag time periods of interest. Then, the system calculates robust Mahalanobis distances (and/or Bhattacharyya distances) from the z-scores of error data from multiple engine sensors of interests and stores the calculated range for the tagged time periods in the edge device and/or cloud database for further analysis.

The Bhattacharyya distance measures the similarity of two probability distributions. It is closely related to the Bhattacharyya coefficient which is a measure of the amount of overlap between two statistical samples or populations. The coefficient can be used to determine the relative closeness of the two samples being considered. It is used to measure the separability of classes in classification and it is considered to be more reliable than the Mahalanobis distance, as the Mahalanobis distance is a particular case of the Bhattacharyya distance when the standard deviations of the two classes are the same. Consequently, when two classes have similar means but different standard deviations, the Mahalanobis distance would tend to zero, whereas the Bhattacharyya distance grows depending on the difference between the standard deviations.

The Bhattacharyya distance is a measure of divergence. It can be defined formally as follows. Let (Ω, B, v) be a measure space, and let P be the set of all probability measures (cf. Probability measure) on B that are absolutely continuous with respect to v. Consider two such probability measures P₁, P₂, ∈P and let p1 and p2 be their respective density functions with respect to ν. The Bhattacharyya coefficient between P₁ and P₂, denoted by ρ(P₁, P₂), is defined by

$$ρ ( {P}_{1} , {P}_{2} ) = {\int }_{Ω} {( \frac{d {P}_{1}}{dv} • \frac{dP}{dv} )}^{1 / 2} dv ,$$

where dPᵢ/dν is the Radon-Nikodým derivative (cf. Radon-Nikodým theorem) of Pᵢ (i=1, 2) with respect to ν. It is also known as the Kakutani coefficient and the Matusita coefficient. Note that ρ(P₁, P₂) does not depend on the measure ν dominating P₁ and P₂.

i) 0≤ρ(P₁, P₂)≤1;

ii) ρ(P₁, P₂)=1 if and only if P₁=P₂;

iii) ρ(P₁, P₂)=0 if and only if P₁ is orthogonal to P₂.

The Bhattacharyya distance between two probability distributions P₁ and P₂, denoted by B(1,2), is defined by B(1,2)=−ln ρ(P₁, P₂).

0≤B(1,2)≤∞. The distance B(1,2) does not satisfy the triangle inequality. The Bhattacharyya distance comes out as a special case of the Chernoff distance (taking t=1/2):

$$- ln {inf}_{0 \leq t \leq 1} ( {\int }_{Ω} {P}_{1}^{t} {P}_{2}^{1 - t} dv )$$

The Hellinger distance between two probability measures P₁ and P₂, denoted by H(1,2), is related to the Bhattacharyya coefficient by the following relation: H(1,2)=2[1−ρ(P₁,P₂)].

B(1,2) is called the Bhattacharyya distance since it is defined through the Bhattacharyya coefficient. If one uses the Bayes criterion for classification and attaches equal costs to each type of misclassification, then the total probability of misclassification is majorized by e^{-B(1,2)}. In the case of equal covariances, maximization of B(1,2) yields the Fisher linear discriminant function.
Bhattacharyya distance. G. Chaudhuri (originator), Encyclopedia of Mathematics.www.encyclopediaofmath.org/index.php?title=Bhattacharyya_distance&oldid=15124
B. P. Adhikari, D. D. Joshi, “Distance discrimination et resume exhaustif” Publ. Inst. Statist. Univ. Paris, 5 (1956) pp. 57-74
C. R. Rao, “Advanced statistical methods in biometric research”, Wiley (1952)
H. Chernoff, “A measure of asymptotic efficiency for tests of a hypothesis based on the sum of observations” Ann. Math. Stat., 23 (1952) pp. 493-507
S. Kullback, “Information theory and statistics”, Wiley (1959)
A. N. Kolmogorov, “On the approximation of distributions of sums of independent summands by infinitely divisible distributions” Sankhya, 25 (1963) pp. 159-174
S. M. Ali, S. D. Silvey, “A general class of coefficients of divergence of one distribution from another” J. Roy. Statist. Soc. B, 28 (1966) pp. 131-142
T. Kailath, “The divergence and Bhattacharyya distance measures in signal selection” IEEE Trans. Comm. Techn., COM-15 (1967) pp. 52-60
E. Hellinger, “Neue Begrundung der Theorie quadratischer Formen von unendlichvielen Veranderlichen” J. Reine Angew. Math., 36 (1909) pp. 210-271
S. Kakutani, “On equivalence of infinite product measures” Ann. Math. Stat., 49 (1948) pp. 214-224
K. Matusita, “A distance and related statistics in multivariate analysis” P. R. Krishnaiah (ed.), Proc. Internat. Symp. Multivariate Analysis, Acad. Press (1966) pp. 187-200
A. Bhattacharyya, “On a measure of divergence between two statistical populations defined by probability distributions” Bull. Calcutta Math. Soc., 35 (1943) pp. 99-109
K. Matusita, “Some properties of affinity and applications” Ann. Inst. Statist. Math., 23 (1971) pp. 137-155
Ray, S., “On a theoretical property of the Bhattacharyya coefficient as a feature evaluation criterion” Pattern Recognition Letters, 9 (1989) pp. 315-319
G. Chaudhuri, J. D. Borwankar, P. R. K. Rao, “Bhattacharyya distance-based linear discriminant function for stationary time series” Comm. Statist. (Theory and Methods), 20 (1991) pp. 2195-2205
G. Chaudhuri, J. D. Borwankar, P. R. K. Rao, “Bhattacharyya distance-based linear discrimination” J. Indian Statist. Assoc., 29 (1991) pp. 47-56
G. Chaudhuri, “Linear discriminant function for complex normal time series” Statistics and Probability Lett., 15 (1992) pp. 277-279
G. Chaudhuri, “Some results in Bhattacharyya distance-based linear discrimination and in design of signals” Ph.D. Thesis Dept. Math. Indian Inst. Technology, Kanpur, India (1989)
I. J. Good, E. P. Smith, “The variance and covariance of a generalized index of similarity especially for a generalization of an index of Hellinger and Bhattacharyya” Commun. Statist. (Theory and Methods), 14 (1985) pp. 3053-3061

The Mahalanobis distance is a measure of the distance between a point P and a distribution D. It is a multi-dimensional generalization of the idea of measuring how many standard deviations away P is from the mean of D. This distance is zero if P is at the mean of D, and grows as P moves away from the mean along each principal component axis, the Mahalanobis distance measures the number of standard deviations from P to the mean of D. If each of these axes is re-scaled to have unit variance, then the Mahalanobis distance corresponds to standard Euclidean distance in the transformed space. The Mahalanobis distance is thus unitless and scale-invariant and takes into account the correlations of the data set.

The Mahalanobis distance is quantity ρ(X,Y|A)={(X−Y)^{T}A(X−Y)}^{1/2}, where X, Y are vectors and A is a matrix (and □^{T} denotes transposition). It is used in multi-dimensional statistical analysis; in particular, for testing hypotheses and the classification of observations. The quantity ρ(μ₁, μ₂|Σ⁻¹) is a distance between two normal distributions with expectations μ₁ and μ₂ and common covariance matrix Σ. The Mahalanobis distance between two samples (from distributions with identical covariance matrices), or between a sample and a distribution, is defined by replacing the corresponding theoretical moments by sampling moments. As an estimate of the Mahalanobis distance between two distributions one uses the Mahalanobis distance between the samples extracted from these distributions or, in the case where a linear discriminant function is utilized—the statistic Φ⁻¹(α)+Φ⁻¹(β), where α and β are the frequencies of correct classification in the first and the second collection, respectively, and Φ is the normal distribution function with expectation 0 and variance 1.
Mahalanobis distance. A. I. Orlov (originator), Encyclopedia of Mathematics. URL: www.encyclopediaofinath.org/index.php?title=Mahalanobis_distance&oldid=17720
P. Mahalanobis, “On tests and measures of group divergence I. Theoretical formulae” J. and Proc. Asiat. Soc. of Bengal, 26 (1930) pp. 541-588
P. Mahalanobis, “On the generalized distance in statistics” Proc. Nat. Inst. Sci. India (Calcutta), 2 (1936) pp. 49-55
T. W. Anderson, “Introduction to multivariate statistical analysis”, Wiley (1958)
S. A. Aivazyan, Z. I. Bezhaeva, O. V. Staroverov, “Classifying multivariate observations”, Moscow (1974) (In Russian)
A. I. Orlov, “On the comparison of algorithms for classifying by results observations of actual data” Dokl. Moskov. Obshch. Isp. Prirod. 1985, Otdel. Biol. (1987) pp. 79-82 (In Russian)
See,
en.wikipedia.org/wiki/Mahalanobis_distance
en.wikipedia.org/wiki/Bhattacharyya_distance
Mahalanobis, Prasanta Chandra (1936). “On the generalised distance in statistics” (PDF). Proceedings of the National Institute of Sciences of India. 2 (1): 49-55. Retrieved 2016-09-27.
De Maesschalck, R.; Jouan-Rimbaud, D.; Massart, D. L. “The Mahalanobis distance”. Chemometrics and Intelligent Laboratory Systems. 50 (1): 1-18. doi:10.1016/s0169-7439(99)00047-7.
Gnanadesikan, R.; Kettenring, J. R. (1972). “Robust Estimates, Residuals, and Outlier Detection with Multiresponse Data”. Biometrics. 28 (1): 81-124. doi:10.2307/2528963. JSTOR 2528963.
Weiner, Irving B.; Schinka, John A.; Velicer, Wayne F. (23 Oct. 2012). Handbook of Psychology, Research Methods in Psychology. John Wiley & Sons. ISBN 978-1-118-28203-8.
Mahalanobis, Prasanta Chandra (1927); Analysis of race mixture in Bengal, Journal and Proceedings of the Asiatic Society of Bengal, 23:301-333
McLachlan, Geoffrey (4 Aug. 2004). Discriminant Analysis and Statistical Pattern Recognition. John Wiley & Sons. pp. 13-. ISBN 978-0-471-69115-0.
Bhattacharyya, A. (1943). “On a measure of divergence between two statistical populations defined by their probability distributions”. Bulletin of the Calcutta Mathematical Society. 35: 99-109. MR 0010358.
Frank Nielsen. A generalization of the Jensen divergence: The chord gap divergence. arxiv 2017 (ICASSP 2018). arxiv.org/pdf/1709.10498.pdf
Guy B. Coleman, Harry C. Andrews, “Image Segmentation by Clustering”, Proc IEEE, Vol. 67, No. 5, pp. 773-785, 1979
D. Comaniciu, V. Ramesh, P. Meer, Real-Time Tracking of Non-Rigid Objects using Mean Shift, BEST PAPER AWARD, IEEE Conf. Computer Vision and Pattern Recognition (CVPR'00), Hilton Head Island, S.C., Vol. 2, 142-149, 2000
Euisun Choi, Chulhee Lee, “Feature extraction based on the Bhattacharyya distance”, Pattern Recognition, Volume 36, Issue 8, August 2003, Pages 1703-1709
François Goudail, Philippe Réfrégier, Guillaume Delyon, “Bhattacharyya distance as a contrast parameter for statistical processing of noisy optical images”, JOSA A, Vol. 21, Issue 7, pp. 1231-1240 (2004)
Chang Huai You, “An SVM Kernel With GMM-Supervector Based on the Bhattacharyya Distance for Speaker Recognition”, Signal Processing Letters, IEEE, Vol 16, Is 1, pp. 49-52
Mak, B., “Phone clustering using the Bhattacharyya distance”, Spoken Language, 1996. ICSLP 96. Proceedings., Fourth International Conference on, Vol 4, pp. 2005-2008 vol. 4, 3-6 Oct. 1996
Reyes-Aldasoro, C. C., and A. Bhalerao, “The Bhattacharyya space for feature selection and its application to texture segmentation”, Pattern Recognition, (2006) Vol. 39, Issue 5, May 2006, pp. 812-826
Nielsen, F.; Boltz, S. (2010). “The Burbea-Rao and Bhattacharyya centroids”. IEEE Transactions on Information Theory. 57 (8): 5455-5466. arXiv:1004.5049. doi:10.1109/TIT.2011.2159046.
Bhattacharyya, A. (1943). “On a measure of divergence between two statistical populations defined by their probability distributions”. Bulletin of the Calcutta Mathematical Society. 35: 99-109. MR 0010358.
Kailath, T. (1967). “The Divergence and Bhattacharyya Distance Measures in Signal Selection”. IEEE Transactions on Communication Technology. 15 (1): 52-60. doi:10.1109/TCOM. 1967.1089532.
Djouadi, A.; Snorrason, O.; Garber, F. (1990). “The quality of Training-Sample estimates of the Bhattacharyya coefficient”. IEEE Transactions on Pattern Analysis and Machine Intelligence. 12 (1): 92-97. doi:10.1109/34.41388.

At run time, the system calculates the z-scores of error data from the engine sensor data time series then optionally calculates the robust Mahalanobis distance (and/or Bhattacharyya distances) of the z-scores of error data of the selected dimension(s) (i.e., engine sensor(s)). The value is compared against the range of Mahalanobis distances (and/or Bhattacharyya distances) for analyzing and comparing a set of tensors of z-scores of errors during a test period against a set of tensors of z-scores of errors during training period that had a positive match and tagging, that were stored previously as a part of the deployed classification labels (specific type of failure or not specific type of failure) and classified accordingly. When a failure classification is obtained, the alerts system sends notifications to human operators and/or automated systems.

Some embodiments can then provide a set of data as an input to a user interface (e.g., analysis gauges) in the form of standardized error values for each sensor and/or the combined Mahalanobis distance (or Bhattacharyya distance) for each sensor. This allows users to understand why data were classified as failures or anomalies.

Of note, the system does not necessarily differentiate between operational engine issues and engine sensor issues. Rather, it depends on the classifications made during the deep learning training period in accordance with some embodiments. Also, because the system uses standardized z-errors for creating the knowledge base of issues (i.e., tags and Mahalanobis/Bhattacharyya distance ranges and standardized error ranges), the model can be deployed as a prototype for other engines and/or machines of similar types before an engine-specific model is created.

It is therefore an object to provide a method of determining anomalous operation of a system, comprising: capturing a stream of data representing sensed or determined operating parameters of the system, wherein the operating parameters vary in dependence on an operating state of the system, over a range of operating states of the system, with a stability indicator representing whether the system was operating in a stable state when the operating parameters were sensed or determined; characterizing statistical properties of the stream of data, comprising at least an amplitude-dependent parameter and a variance of the amplitude over time parameter for an operating regime representing stable operation; determining a statistical norm for the characterized statistical properties that reliably distinguish between normal operation of the system and anomalous operation of the system; and outputting a signal dependent on whether a concurrent stream of data representing sensed or determined operating parameters of the system represent anomalous operation of the system.

It is also an object to provide a method of determining anomalous operation of a system, comprising: capturing a plurality of streams of training data representing sensor readings over a range of states of the system during a training phase; characterizing joint statistical properties of the plurality of streams of data representing sensor readings over the range of states of the system during the training phase, comprising determining a plurality of quantitative standardized errors between a predicted value of a respective training datum, and a measured value of the respective training datum, and a variance of the respective plurality of quantitative standardized errors over time; determining a statistical norm for the characterized joint statistical properties that reliably distinguishes between a normal state of the system and an anomalous state of the system; and storing the determined statistical norm in a non-volatile memory.

It is also an object to provide a method of predicting anomalous operation of a system, comprising: characterizing statistical properties of a plurality of streams of data representing sensor readings over a range of states of the system during a training phase, comprising determining a statistical variance over time of a quantitative standardized errors between a predicted value of a respective training datum and a measured value of the respective training datum; determining a statistical norm for the characterized statistical properties comprising at least one decision boundary that reliably distinguishes between a normal operational state of the system and an anomalous operational state of the system; and storing the determined statistical norm in a non-volatile memory.

It is a further object to provide a system for determining anomalous operational state, comprising: an input port configured to receive a plurality of streams of training data representing sensor readings over a range of states of the system during a training phase; at least one automated processor, configured to: characterize joint statistical properties of plurality of streams of data representing sensor readings over the range of states of the system during the training phase, based on a plurality of quantitative standardized errors between a predicted value of a respective training datum, and a measured value of the respective training datum, and a variance of the respective plurality of quantitative standardized errors over time; and determine a statistical norm for the characterized joint statistical properties that reliably distinguishes between a normal state of the system and an anomalous state of the system; and a non-volatile memory configured to store the determined statistical norm.

Another object provides a method of determining anomalous operation of a system, comprising: capturing a plurality of streams of training data representing sensor readings over a range of states of the system during a training phase; transmitting the captured streams of training data to a remote server; receiving, from the remote server, a statistical norm for characterized joint statistical properties that reliably distinguishes between a normal state of the system and an anomalous state of the system, the characterized joint statistical properties being based on a plurality of streams of data representing sensor readings over the range of states of the system during the training phase, comprising quantitative standardized errors between a predicted value of a respective training datum, and a measured value of the respective training datum, and a variance of the respective plurality of quantitative standardized errors over time; capturing a stream of data representing sensor readings over states of the system during an operational phase; and producing a signal selectively dependent on whether the stream of data representing sensor readings over states of the system during the operational phase are within the statistical norm.

A further object provides a method of determining a statistical norm for non-anomalous operation of a system, comprising: receiving a plurality of captured streams of training data at a remote server, the captured plurality of streams of training data representing sensor readings over a range of states of a system during a training phase; processing the received a plurality of captured streams of training data to determine a statistical norm for characterized joint statistical properties that reliably distinguishes between a normal state of the system and an anomalous state of the system, the characterized joint statistical properties being based on a plurality of streams of data representing sensor readings over the range of states of the system during the training phase, comprising quantitative standardized errors between a predicted value of a respective training datum, and a measured value of the respective training datum, and a variance of the respective plurality of quantitative standardized errors over time; and transmitting the determined statistical norm to the system. The method may further comprise, at the system, capturing a stream of data representing sensor readings over states of the system during an operational phase, and producing a signal selectively dependent on whether the stream of data representing sensor readings over states of the system during the operational phase are within the statistical norm.

A non-transitory computer-readable medium is also encompassed, storing therein instructions for controlling a programmable processor to perform any or all steps of a computer-implemented method disclosed herein.

At least one stream of training data may be aggregated prior to characterizing the joint statistical properties of the plurality of streams of data representing the sensor readings over the range of states of the system during the training phase.

The method may further comprise communicating the captured plurality of streams of training data representing sensor readings over a range of states of the system during a training phase from an edge device to a cloud device prior to the cloud device characterizing the joint statistical property of the plurality of streams of operational data; communicating the determined statistical norm from the cloud device to the edge device; and wherein the non-volatile memory may be provided within the edge device.

The method may further comprise capturing a plurality of streams of operational data representing sensor readings during an operational phase; determining a plurality of quantitative standardized errors between a predicted value of a respective operational datum, and a measured value of the respective training datum, and a variance of the respective plurality of quantitative standardized errors over time in the edge device; and comparing the plurality of quantitative standardized errors and the variance of the respective plurality of quantitative standardized errors with the determined statistical norm, to determine whether the plurality of streams of operational data representing the sensor readings during the operational phase represent an anomalous state of system operation.

The method may further comprise capturing a plurality of streams of operational data representing sensor readings during an operational phase; characterizing a joint statistical property of the plurality of streams of operational data, comprising determining a plurality of quantitative standardized errors between a predicted value of a respective operational datum, and a measured value of the respective training datum, and a variance of the respective plurality of quantitative standardized errors over time; and comparing the characterized joint statistical property of the plurality of streams of operational data with the determined statistical norm to determine whether the plurality of streams of operational data representing the sensor readings during the operational phase represent an anomalous state of system operation.

The method may further comprise capturing a plurality of streams of operational data representing sensor readings during an operational phase; and determining at least one of a Mahalanobis distance, a Bhattacharyya distance, Chernoff distance, a Matusita distance, a KL divergence, a Symmetric KL divergence, a Patrick-Fisher distance, a Lissack-Fu distance and a Kolmogorov distance of the captured plurality of streams of operational data with respect to the determined statistical norm. The method may further comprise determining a Mahalanobis distance between the plurality of streams of training data representing sensor readings over the range of states of the system during the training phase and a captured plurality of streams of operational data representing sensor readings during an operational phase of the system. The method may further comprise determining a Bhattacharyya distance between the plurality of streams of training data representing sensor readings over the range of states of the system during the training phase and a captured plurality of streams of operational data representing sensor readings during an operational phase of the system.

The method may further comprise determining an anomalous state of operation based on a statistical difference between sensor data obtained during operation of the system subsequent to the training phase and the statistical norm. The method may further comprise performing an analysis on the sensor data obtained during the anomalous state, defining a signature of the sensor data obtained leading to the anomalous state, and communicating the defined signature of the sensor data obtained leading to the anomalous state to a second system. The method may still further comprise receiving a defined signature of sensor data obtained leading to an anomalous state of a second system from the second system and performing a signature analysis of a stream of sensor data after the training phase. The method may further comprise receiving a defined signature of sensor data obtained leading to an anomalous state of a second system from the second system, and integrating the defined signature with the determined statistical norm, such that the statistical norm may be updated to distinguish a pattern of sensor data preceding the anomalous state from a normal state of operation.

The method may further comprise determining a z-score for the plurality of quantitative standardized errors. The method may further comprise determining a z-score for a stream of sensor data received after the training phase. The method may further comprise decimating a stream of sensor data received after the training phase. The method may further comprise decimating and determining a z-score for a stream of sensor data received after the training phase.

The method may further comprise receiving a stream of sensor data received after the training phase; determining an anomalous state of operation of the system based on differences between the received stream of sensor data received after the training phase; and tagging a log of sensor data received after the training phase with an annotation of anomalous state of operation. The method may further comprise classifying the anomalous state of operation as a particular kind of event.

The plurality of streams of training data representing the sensor readings over the range of states of the system may comprise data from a plurality of different types of sensors. The plurality of streams of training data representing the sensor readings over the range of states of the system may comprise data from a plurality of different sensors of the same type. The method may further comprise classifying a stream of sensor data received after the training phase by at least performing a k-nearest neighbors analysis. The method may further comprise determining whether a stream of sensor data received after the training phase may be in a stable operating state and tagging a log of the stream of sensor data with a characterization of the stability.

The method may include at least one of: transmit the plurality of streams of training data to a remote server; transmit the characterized joint statistical properties to the remote server; transmit the statistical norm to the remote server; transmit a signal representing a determination whether the system is operating anomalously to the remote server based on the statistical norm; receive the characterized joint statistical properties from the remote server; receive the statistical norm from the remote server; receive a signal representing a determination whether the system is operating anomalously from the remote server based on the statistical norm; and receive a signal from the remote server representing a predicted statistical norm for operation of the system, representing a type of operation of the system outside the range of states during the training phase, based on respective statistical norms for other systems.

According to one embodiment, upon initiation of the system, there is no initial model, and the edge device sends lossless uncompressed data to the cloud computer for analysis. Once a model is built and synchronized or communicated by both sides of a communication pair, the communications between them may synchronously switch to a lossy compressed mode of data communication. In cases where different operating regimes have models of different maturity, the edge device may determine on a class-by-class basis what mode of communication to employ. Further, in some cases, the compression of the data may be tested according to different algorithms, and the optimal algorithm employed, according to criteria which may include communication cost or efficiency, various risks and errors or cost-weighted risks and errors in anomaly detection, or the like. In some cases, computational complexity and storage requirements of compression is also an issue, especially in lightweight IoT sensors with limited memory and processing power.

In one embodiment, the system can initially use a “stock” model and corresponding “stock statistical parameters” (standard deviation of error and mean error) in the beginning, when there is no custom or system-specific model built for that specific asset, and then later when the edge device builds a new and sufficiently complete model, it will send that model to the cloud computer, and then both side can synchronously switch to the new model. In this scheme only the edge device would build the models, as cloud always receives lossy data. As discussed above, the stock model may initiate with population statistics for the class of system, and as individual-specific data is acquired, update the model to reflect the specific device rather than the population of devices. The transition between models need not be binary, and some blending of population parameters and device specific parameters may be present or persistent in the system. This is especially useful where the training data is sparse or unavailable for certain regimes of operation, or where certain types of anomalies cannot or should not be emulated during training. Thus, certain catastrophic anomalies may be preceded by signature patterns, which may be included in the stock model. Typically, the system will not, during training, explore operating regions corresponding to imminent failure, and therefore the operating regimes associated with those states will remain unexplored. Thus, the aspects of the stock model relating to these regimes of operation may naturally persist, even after the custom model is mature.

In some embodiments, to ensure continuous effective monitoring of anomalies, the system can automatically monitor itself for the presence of drift. Drift can be detected for a sensor when models no longer fit the most recent data well and the frequency of type I errors the system detects exceeds an acceptable, pre-specified threshold. Type I errors can be determined by identifying when a model predicts an anomaly and no true anomaly is detected in a defined time window around the predicted anomaly.

True anomalies can be detected when a user provides input in near real-time that a predicted anomaly is a false alert or when a threshold set on a sensor is exceeded. Thresholds can either be set by following manufacturer's specifications for normal operating ranges or by setting statistical thresholds determined by analyzing the distribution of data during normal sensor operation and identifying high and low thresholds.

In these embodiments, when drift is detected, the system can trigger generation of new models (e.g., of same or different model types) on the most recent data for the sensor. The system can compare the performance of different models or model types on identical test data sampled from the most recent sensor data and put a selected model (e.g., a most effective model) into deployment or production. The most effective model can be the model that has the highest recall (lowest rate of type II errors), lowest false positive rate (lowest rate of type I errors), and/or maximum lead time of prediction (largest amount of time that it predicts anomalies before manufacturer-recommended thresholds detect them). However, if there is no model whose false positive rate falls below a specified level, the system will not put a model into production. In that case, once more recent data is captured, the system will undertake subsequent attempts at model generation until successful.

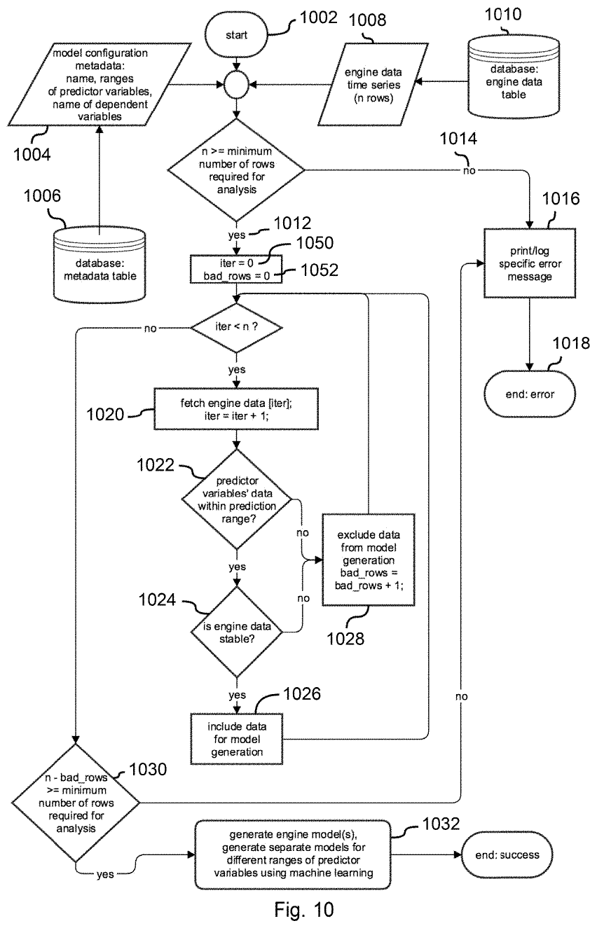

In some embodiments, the anomaly detection system described herein may be used to determine engine coolant temperature anomalies on a marine vessel such as a tugboat. FIG. 10 describes an example of how a machine learning model may be created based on recorded vessel engine data. When the anomaly detection system starts 1002, model configuration metadata 1004 such as the independent engine parameters and any restriction to their values, dependent engine parameters and any restriction to their values, model name, etc. are accessed from a model metadata table stored in a database 1006.

An engine's data 1008 are accessed from a database 1010 to be used as input data for model generation. FIG. 1, shows example independent variables of engine RPM and load for the model training set. If the required number of engine data rows 1008 are not available 1014 in the database 1010, an error message is displayed 1016 and the model generation routine ends 1018. Note that a process may be in place to re-attempt model building the case of a failure.

If enough rows of engine data 1008 are available 1012, the model building process begins by filtering the engine data time series 1008. An iterator 1050 slices a data row from the set of n rows 1020. If the predictor variables are within the acceptable range 1022 and the engine data are stable 1024 as defined by the model metadata table 1006, the data row is included in the set of data rows to be used in the model 1026. If the predictor variables' data is not within range or engine data are not stable, the data row is excluded 1028 from the set of data rows to be used in the model 1026. The data filtering process then continues for each data row in the engine data time series 1008.

If enough data rows are available after filtering 1030, the engine model(s) is generated using machine learning 1032. Algorithm 1 additionally details the data filtering and model(s) generation process in which the stability of predictor variables is determined and used as a filter for model input data. The machine learning model 1032 may be created using a number of appropriate modeling techniques or machine learning algorithms (e.g., splines, support vector machines, neural networks, and/or generalized additive model). In some implementations, the model with the lowest model bias and lowest mean squared error (MSE) is selected as the model for use in subsequent steps.

If too few data rows are available after filtering 1030, a specific error message may be displayed 1016 and the model generation routine ended 1018

If enough data rows are available 1030 and the machine-learning based model has been generated 1032, the model may optionally be converted into a lookup table, using Algorithm 2, as a means of serializing the model for faster processing. The lookup table can contain n+m columns considering the model represents ƒ: [symbol] ⁿ [symbol] [symbol] ^{m}. For engine RPM between 0 and 2000 RPM and load between 0 and 100%, the lookup table can have 200,000+1 rows assuming an interval of 1 for each independent variable. The model can have 2+6=8 columns assuming independent variables of engine RPM and load and dependent variables of coolant temperature, coolant pressure, oil temperature, oil pressure, fuel pressure, fuel actuator percentage. For each engine RPM and load, the model is used to predict the values of the dependent parameters with the results stored in the lookup table.

With the model 1032 known, the training period error statistics can be calculated as described in Algorithm 3. Using the generated model 1032, a prediction for all dependent sensor values can be made based on that generated model 1032 and data for the independent variables during the training period. FIG. 1 shows example data for the time series of the two independent variables, engine RPM and load. The error time series can be generated by subtracting the measured value of a dependent sensor from the model's prediction of that dependent sensor across the time series. The mean and standard deviation of this error time series (i.e. the error statistics) are then calculated.

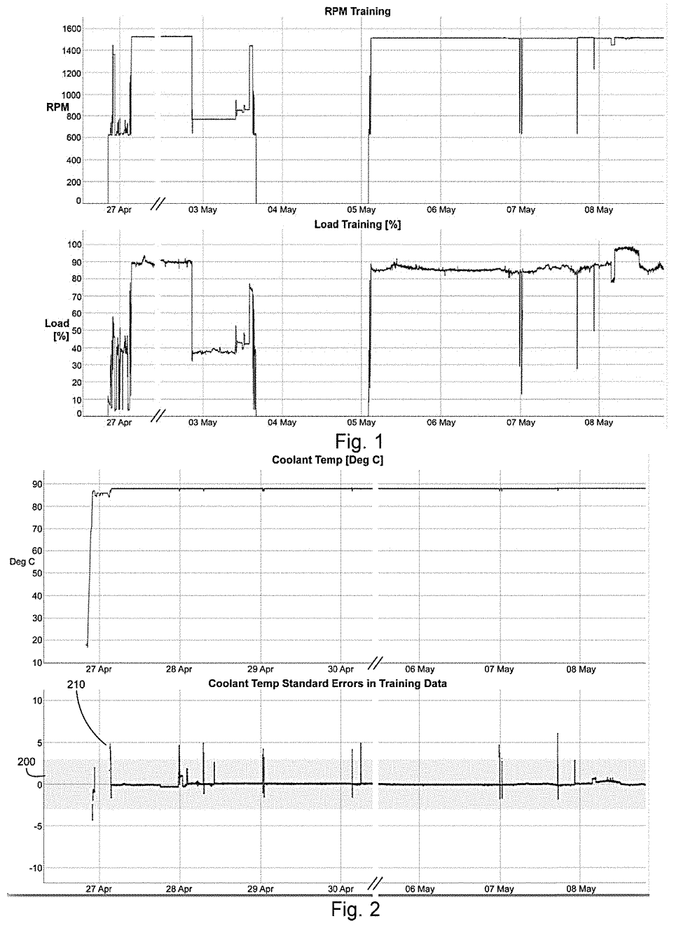

Algorithm 4 describes how the error statistics can be standardized into an error z-score series. The error z-score series is calculated by subtracting the error series mean from each error in the error time series and dividing the result by the error standard deviation, using error statistics from Algorithm 3. FIG. 2 shows an example error z-score series for one sensor in the training period. Generally, the error z-scores are within acceptable range of ±3 200 with short spikes outside of that range 210 occurring when the engine is not stable (i.e., engine RPM and Load are changing quickly). Those points outside the range are excluded when the model is built.

With the error z-score series calculated and the model deployed to the edge device and/or cloud database, the design time steps of Algorithm 5 are complete. At runtime, engine data are stored in a database either at the edge or in the cloud. Using Algorithm 4 with the training error statistics of Algorithm 3, the test data error z-scores can be calculated. If the absolute value of the test data error z-scores are above a given threshold (e.g., user defined or automatically generated), an anomaly condition is identified. An error notification may be sent or other operation taken based on this error condition.

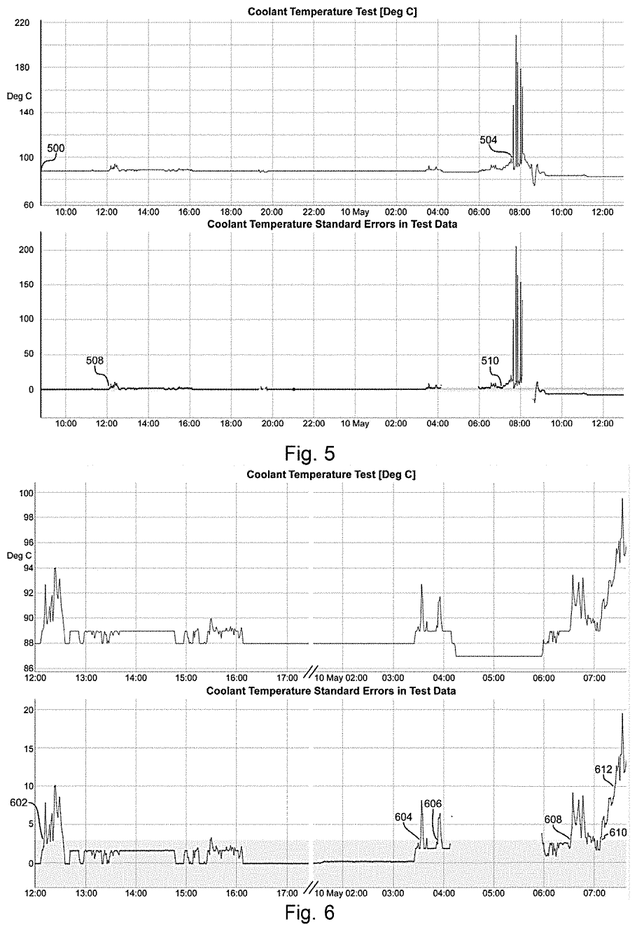

FIG. 4, FIG. 5, and FIG. 6 show an example period which contains a coolant temperature anomaly condition and failure condition. FIG. 4 depicts the values of the independent variables, engine RPM and load. Between the beginning of the coolant temperature time series 500 and the beginning of the failure condition 504, there was no clear trend in the data that a failure was approaching. The first anomaly condition 508 was identified 20 hours prior to the failure condition 504 with a strong anomaly 510 indicated an hour prior to the failure. FIG. 6 changes the axes' bounds to provide a clear view of the anomaly conditions 602, 604, 606, 608, 610. The failure condition 504 is precipitated by a strong anomaly 612 condition, well outside of the expected range (e.g., standard error range).

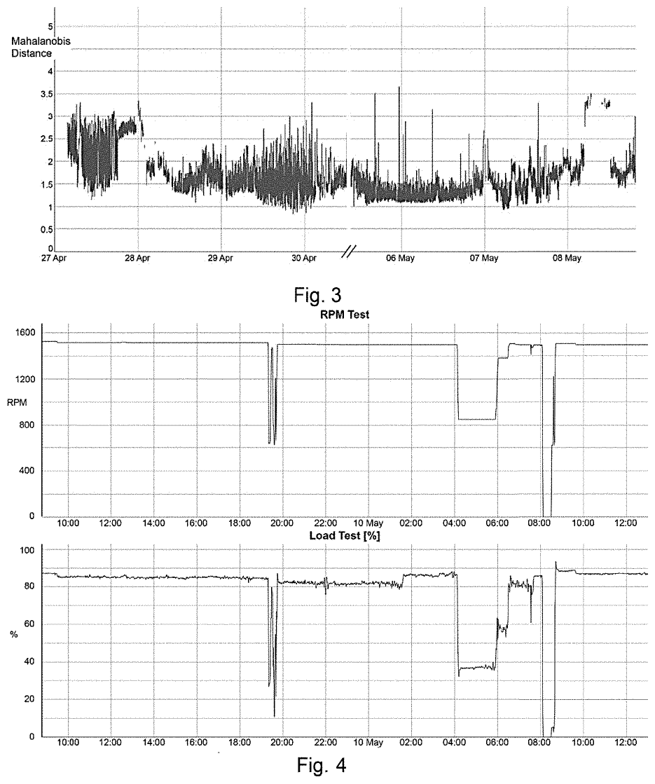

Algorithm 6, which details the calculation of the Mahalanobis distance and/or robust Mahalanobis distance, can be used along with Algorithm 7 to classify anomalies and attempt to identify the anomalies that may lead to a failure. To create the Mahalanobis and/or robust Mahalanobis distance, the training period error z-score series (e.g. the series of FIG. 2) is used as the input to the Mahalanobis and/or robust Mahalanobis distance algorithm. The results may be calculated using a statistical computing language such as ‘R’ and its built-in functionality. Optionally, the maximum of the regular and robust Mahalanobis distances or the Bhattacharyya distance can be calculated. FIG. 3 shows an example Mahalanobis distance time series of computed z-scores of errors from six engine sensor data (coolant temperature), coolant pressure (coolant pressure), oil temperature (oil temperature), oil pressure (oil pressure), fuel pressure (fuel pressure), and fuel actuator percentage (fuel actuator percentage) during the training period. Note that the distance remains small (i.e. near to zero) and bounded. Using one or many of the aforementioned distances as the tag value, time periods containing a known failure are tagged. At real time, Algorithm 7 may be used to calculate and match test data with the tags created during training thus providing a means of understanding which anomaly conditions may lead to failure conditions.

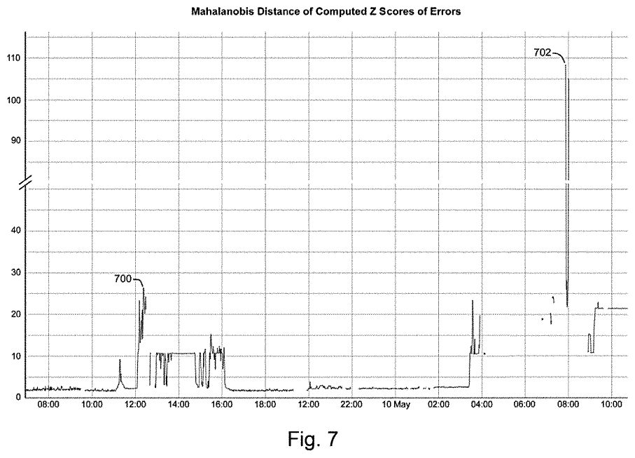

FIG. 7 shows an example Mahalanobis distance time series of computed error z-scores from six engine sensor data (coolant temperature), coolant pressure (coolant pressure), oil temperature (oil temperature), oil pressure (oil pressure), fuel pressure (fuel pressure), and fuel actuator percentage (fuel actuator percentage) during the test period. Note the peaks when the first anomaly is identified 700 and when the failure condition is at its peak 702.

As used herein, the term “processor” may refer to any device or portion of a device that processes electronic data from registers and/or memory to transform that electronic data into other electronic data that may be stored in registers and/or memory.

A system which implements the various embodiments of the presently disclosed technology may be constructed as follows. The system includes at least one controller that may include any or any combination of a system-on-chip, or commercially available embedded processor, Arduino, MeOS, MicroPython, Raspberry Pi, or other type processor board. The system may also include an Application Specific Integrated Circuit (ASIC), an electronic circuit, a programmable combinatorial circuit (e.g., FPGA), a processor (shared, dedicated, or group) or memory (shared, dedicated, or group) that may execute one or more software or firmware programs, or other suitable components that provide the described functionality. The controller has an interface to a communication port, e.g., a radio or network device, a user interface, and other peripherals and other system components.

In some embodiments, one or more of sensors determine, sense, and/or provide to controller data regarding one or more other characteristics may be and/or include Internet of Things (“IoT”) devices. IoT devices may be objects or “things”, each of which may be embedded with hardware or software that may enable connectivity to a network, typically to provide information to a system, such as controller. Because the IoT devices are enabled to communicate over a network, the IoT devices may exchange event-based data with service providers or systems in order to enhance or complement the services that may be provided. These IoT devices are typically able to transmit data autonomously or with little to no user intervention. In some embodiments, a connection may accommodate vehicle sensors as IoT devices and may include IoT-compatible connectivity, which may include any or all of WiFi, LoRan, 900 MHz Wifi, BlueTooth, low-energy BlueTooth, USB, UWB, etc. Wired connections, such as Ethernet 100BaseT, 1000baseT, CANBus, USB 2.0, USB 3.0, USB 3.1, etc., may be employed.

Embodiments may be implemented into a system using any suitable hardware and/or software to configure as desired. The computing device may house a board such as motherboard which may include a number of components, including but not limited to a processor and at least one communication interface device. The processor may include one or more processor cores physically and electrically coupled to the motherboard. The at least one communication interface device may also be physically and electrically coupled to the motherboard. In further implementations, the communication interface device may be part of the processor. In embodiments, processor may include a hardware accelerator (e.g., FPGA).

Depending on its applications, computing device used in the system may include other components which include, but are not limited to, volatile memory (e.g., DRAM), non-volatile memory (e.g., ROM), and flash memory. In embodiments, flash and/or ROM may include executable programming instructions configured to implement the algorithms, operating system, applications, user interface, and/or other aspects in accordance with various embodiments of the presently disclosed technology.

In embodiments, computing device used in the system may further include an analog-to-digital converter, a digital-to-analog converter, a programmable gain amplifier, a sample-and-hold amplifier, a data acquisition subsystem, a pulse width modulator input, a pulse width modulator output, a graphics processor, a digital signal processor, a crypto processor, a chipset, a cellular radio, an antenna, a display, a touchscreen display, a touchscreen controller, a battery, an audio codec, a video codec, a power amplifier, a global positioning system (GPS) device or subsystem, a compass (magnetometer), an accelerometer, a barometer (manometer), a gyroscope, a speaker, a camera, a mass storage device (such as a SIM card interface, and SD memory or micro-SD memory interface, SATA interface, hard disk drive, compact disk (CD), digital versatile disk (DVD), and so forth), a microphone, a filter, an oscillator, a pressure sensor, and/or an RFID chip.

The communication network interface device used in the system may enable wireless communications for the transfer of data to and from the computing device. The term “wireless” and its derivatives may be used to describe circuits, devices, systems, processes, techniques, communications channels, etc., that may communicate data through the use of modulated electromagnetic radiation through a non-solid medium. The term does not imply that the associated devices do not contain any wires, although in some embodiments they might not. The communication chip 406 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible BWA networks are generally referred to as WiMAX networks, an acronym that stands for Worldwide Interoperability for Microwave Access, which is a certification mark for products that pass conformity and interoperability tests for the IEEE 802.16 standards. The communication chip 406 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 406 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 406 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip may operate in accordance with other wireless protocols in other embodiments. The computing device may include a plurality of communication chips. For instance, a first communication chip may be dedicated to shorter range wireless communications such as Wi-Fi and Bluetooth and a second communication chip may be dedicated to longer range wireless communications such as GPS, EDGE, GPRS, CDMA, WiMAX, LTE, Ev-DO, and others.

Exemplary hardware for performing the technology includes at least one automated processor (or microprocessor) coupled to a memory. The memory may include random access memory (RAM) devices, cache memories, non-volatile or back-up memories such as programmable or flash memories, read-only memories (ROM), etc. In addition, the memory may be considered to include memory storage physically located elsewhere in the hardware, e.g. any cache memory in the processor as well as any storage capacity used as a virtual memory, e.g., as stored on a mass storage device.

The hardware may receive a number of inputs and outputs for communicating information externally. For interface with a user or operator, the hardware may include one or more user input devices (e.g., a keyboard, a mouse, imaging device, scanner, microphone) and a one or more output devices (e.g., a Liquid Crystal Display (LCD) panel, a sound playback device (speaker)). To embody the present invention, the hardware may include at least one screen device.

For additional storage, as well as data input and output, and user and machine interfaces, the hardware may also include one or more mass storage devices, e.g., a floppy or other removable disk drive, a hard disk drive, a Direct Access Storage Device (DASD), an optical drive (e.g. a Compact Disk (CD) drive, a Digital Versatile Disk (DVD) drive) and/or a tape drive, among others. Furthermore, the hardware may include an interface with one or more networks (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor and each of the components is known in the art.

The hardware operates under the control of an operating system, and executes various computer software applications, components, programs, objects, modules, etc. to implement the techniques described above. Moreover, various applications, components, programs, objects, etc., collectively indicated by application software, may also execute on one or more processors in another computer coupled to the hardware via a network, e.g. in a distributed computing environment, whereby the processing required to implement the functions of a computer program may be allocated to multiple computers over a network.

In general, the routines executed to implement the embodiments of the present disclosure may be implemented as part of an operating system or a specific application, component, program, object, module or sequence of instructions referred to as a “computer program.” A computer program typically comprises one or more instruction sets at various times in various memory and storage devices in a computer, and that, when read and executed by one or more processors in a computer, cause the computer to perform operations necessary to execute elements involving the various aspects of the invention. Moreover, while the technology has been described in the context of fully functioning computers and computer systems, those skilled in the art will appreciate that the various embodiments of the invention are capable of being distributed as a program product in a variety of forms, and may be applied equally to actually effect the distribution regardless of the particular type of computer-readable media used. Examples of computer-readable media include but are not limited to recordable type media such as volatile and non-volatile memory devices, removable disks, hard disk drives, optical disks (e.g., Compact Disk Read-Only Memory (CD-ROMs), Digital Versatile Disks (DVDs)), flash memory, etc., among others. Another type of distribution may be implemented as Internet downloads. The technology may be provided as ROM, persistently stored firmware, or hard-coded instructions.

While certain exemplary embodiments have been described and shown in the accompanying drawings, it is understood that such embodiments are merely illustrative and not restrictive of the broad invention and that the present disclosure is not limited to the specific constructions and arrangements shown and described, since various other modifications may occur to those ordinarily skilled in the art upon studying this disclosure. The disclosed embodiments may be readily modified or re-arranged in one or more of its details without departing from the principals of the present disclosure.

Implementations of the subject matter and the operations described herein can be implemented in digital electronic circuitry, computer software, firmware or hardware, including the structures disclosed in this specification and their structural equivalents or in combinations of one or more of them. Implementations of the subject matter described in this specification can be implemented as one or more computer programs, i.e., one or more modules of computer program instructions, encoded on one or more computer storage medium for execution by, or to control the operation of data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a non-transitory computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices).

Accordingly, the computer storage medium may be tangible and non-transitory. All embodiments within the scope of the claims should be interpreted as being tangible and non-abstract in nature, and therefore this application expressly disclaims any interpretation that might encompass abstract subject matter.

The present technology provides analysis that improves the functioning of the machine in which it is installed and provides distinct results from machines that employ different algorithms.

The operations described in this specification can be implemented as operations performed by a data processing apparatus on data stored on one or more computer-readable storage devices or received from other sources.

The term “client or “server” includes a variety of apparatuses, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, a code that creates an execution environment for the computer program in question, e.g., a code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The architecture may be CISC, RISC, SISD, SIMD, MIMD, loosely-coupled parallel processing, etc. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone (e.g., a smartphone), a personal digital assistant (PDA), a mobile audio or video player, a game console, or a portable storage device (e.g., a universal serial bus (USB) flash drive). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well. For example, feedback provided to the user can be any form of sensory feedback, e.g., visual feedback, auditory feedback, or tactile feedback and input from the user can be received in any form, including acoustic, speech, or tactile input. In addition, a computer can interact with a user by sending documents to and receiving documents from a device that is used by the user. For example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are considered in a particular order, this should not be understood as requiring that such operations be performed in the particular order shown, in sequential order or that all operations be performed to achieve desirable results. In certain circumstances, multitasking and parallel processing may be advantageous. Moreover, the separation of various system components in the implementations described above should not be understood as requiring such separation in all implementations and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. In cases where any document incorporated by reference conflicts with the present application, the present application controls.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### Algorithms

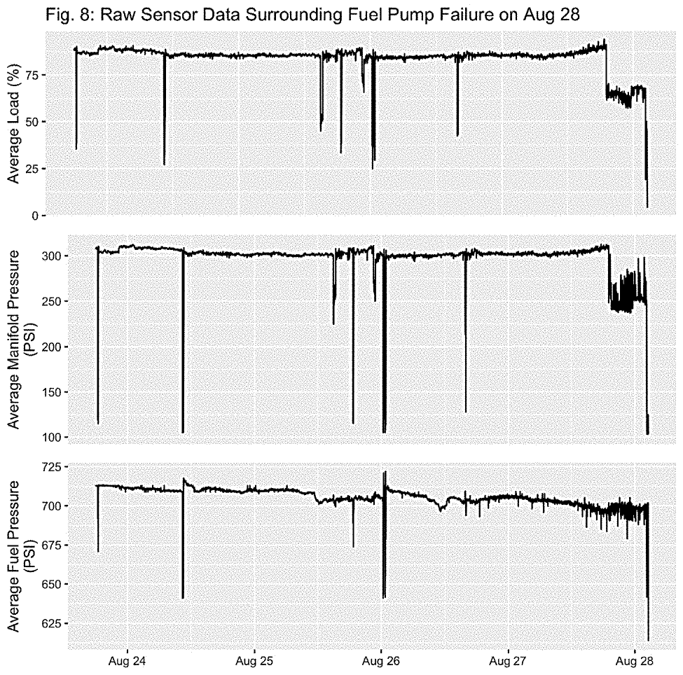

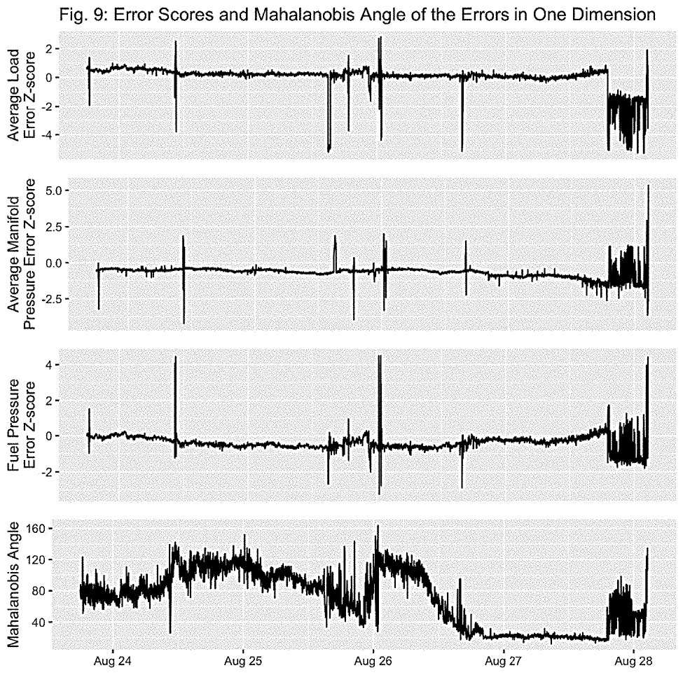

```
  Algorithm 1: Create engine model using machine learning. (See FIG. 8)
  Data: engine data time series for training period
  Result: engine model using machine learning initialization;
  define a predictable range for predictor variables;
  (e.g. rpm greater than 1000);
  create a new Boolean column called isStable that can store true/false
for predictors combined stability;
  compute isStable and store the values in time series;
  (e.g., isStable = true if in last n minutes the change in predictor
variables are within k standard deviation, else isStable = false);
  if predictor variables are within predictable range and isStable = true for
some predetermined time then
  include the record from mode creation;
  else
  exclude the record from mode creation;
  end
  create engine model from the filtered data using machine learning;
  use multiple machine learning algorithms (e.g., splines, support vector
machines, neural networks, and/or generalized additive model) to
build statistical models; select the model with the lowest model bias and
fits the training data most closely (i.e., has the lowest mean squared
error (MSE));
```

```
  Algorithm 2: Convert statistical model to a look-up table (optional step)
  Data: R model from Algorithm 1
  Result: Model look-up table
  initialization;
  if model creation is successful then
  create the model look-up table with n + m columns considering the
  model represents f: [symbol]
ⁿ [symbol] [symbol] ^{m};
  e.g., a lookup table for engine RPM 0-2000 and load 0-100 will have
200,000 + 1 rows assuming an interval of 1 for each independent
variable. The model will have 2 + 6 = 8 columns assuming
independent variables of engine RPM and load and dependent
variables of coolant temperature, coolant pressure, oil temperature, oil
pressure, fuel pressure, fuel actuator percentage. For each engine RPM
and load, the R model is used to predict the values of the dependent
parameters and those predicted values are then stored in the look-up
table.;
  e.g., a lookup table for a bounded region may be between engine
RPM 1000-2000 and load 40-100 will have 60,000 + 1 rows assuming
an interval of 1 for each independent variable;
  else
  No operation
  end
```

```
  Algorithm 3: Create error statistics for the engine parameters of
interest during training period
  Data: R model from Algorithm 1 and training data
  Result: error statistic
  initialization;
  if model creation is successful then
  use the model or look-up table to predict the time series of interest;
calculate the difference between actual value and predicted value;
create error time series;
  else
  No operation
  end
  calculate error mean and error standard deviation;
```

```
  Algorithm 4: compute z-error score
  Data: Deployed model and test data
  Result: z-score of errors
  initialization;
  if model creation is successful then
  use the model to predict the time series of interest;
  create the error time series by calculating the difference between the
actual value and predicted value;
  compute the z-score of the error series by subtracting the training error
mean and dividing the error by the training error standard deviation from
Algorithm 3;
  zₑᵣᵣₒᵣ = (X − μ_{training})/σ_{training};
  Save the z-score of errors as a time series
  else
  No operation
  end
```

```
  Algorithm 5: System algorithm
  Data: engine data training and near real-time test data
  Result: engine parameter anomaly detection at near real-time
  initialization;
  Design Time step 1: Use Algorithm 1 to create engine model from
  training data;
  Design Time step 2: Use Algorithm 3 to create error statistics;
  Design Time step 3: optionally use Algorithm 2 to create model
  look-up table;
  Design Time step 4: deploy the model on edge device and/or cloud
  database;
  Runtime Step 1: while engine data is available and predictors are
within range and engine is in steady state do
  if model deployment is successful then
    step 5: compute and save z-error score(s) from test data using
    algorithm 4;
    if absolute value of z_score > k then
      Send Error Notification;
    else
      No operation
    end
  else
    No operation
  end
  end
```

```
  Algorithm 6: Create Mahalanobis distances and/or robust Mahalanobis
distances for deep learning
  Data: engine data error time series containing timestamps and z-scores
of errors from engine data time series during training period from
algorithm 4
  Result: Robust Mahalanobis distance time series
  step 1: pass input engine data error z-scores through robust Mahalanobis
distance algorithm (e.g., via ‘R’ built-in);
  step 2: optionally: use the maximum of regular and robust Mahalanobis
distance, or compute and use the Bhattacharyya distance as input data
when classifying the training data.
  Rcodesample library (MASS) X_trg ← multi-dimensional standardized
error (z-score of errors) time series from engine data during training
period;
  maha1.X_test ← sqrt(mahalanobis(X_trg, colMeans(X_trg),
  cov(X_trg)));
  covmve.X1_trg ← cov.rob(X1_trg);
  maha2.X_test ←
  sqrt(mahalanobis(X_trg, covmve.X trg$center, covmve.X trg$cov));
  max.maha.X ← max(c(maha1.X, maha2.X));
  step 3: Human tags time periods with known engine issues
  step 4: Compute and save the range of Mahalanobis or Bhattacharyya
distances along with the tags for future evaluation near real-time
classification on engine data anomalies.
```

```
  Algorithm 7: Classify z-scores at real time using robust distances
  Data: engine data error time series containing timestamps and z-scores
of errors from engine data time series during test period from algorithm 4
  Result: engine anomaly detection and classification initialization;
  step 1: pass input engine data error z-scores through robust Mahalanobis
distance algorithm (e.g., via ‘R’ built-in);
  step 2: optionally: use the maximum of regular and robust Mahalanobis
distance, or compute and use the Bhattacharyya distance as input data
when classifying the test data.
  Rcodesample library(MASS) X_trg ← multi-dimensional standardized
error (z-score of errors) time series from engine data during training
period;
  maha1.X_test ← sqrt(mahalanobis(X trg, colMeans(X trg),
  cov(X trg)));
  covmve.X1_trg ← cov.rob(X1_trg);
  maha2.X_test ←
  sqrt(mahalanobis(X_trg, covmve.X trg$center, covmve.X trg$cov));
  max.maha.X ← max(c(maha1.X, maha2.X));
  library(MASS);
  X_test [symbol]  - multi-dimensional error time series from test engine data
during test period;
  X_trg [symbol]  - multi-dimensional error time series from engine data during
training period
  maha1.X test [symbol]  - sqrt(mahalanobis(X_test, colMeans(X_trg),
  cov(X_trg)));
  covmve.X1 trg [symbol]  - cov.rob(X1 trg);
  maha2.X test [symbol]  - sqrt(mahalanobis(X test, covmve.X trgcenter,
  covmve.X trgcov));
  max.maha.X [symbol]  - max(c(maha1.X, maha2.X));
  if the computed Mahalanobis/Bhattacharyya distance is in the same
range as the previously learned time periods then classify the test period
with the same tag from training.
```

1. A method of determining anomalous operation of a system, comprising:
capturing a plurality of streams of training data representing sensor readings over a range of states of the system during a training phase, the range of states including at least a normal state of the system;
determining joint statistical properties of the plurality of streams of data representing sensor readings over the range of states of the system during the training phase, comprising determining (a) a plurality of quantitative standardized errors between a predicted value of a respective training datum, and a measured value of the respective training datum, and (b) a variance of the respective plurality of quantitative standardized errors over time;
determining a statistical norm for the characterized joint statistical properties that distinguishes between the normal state of the system and an anomalous state of the system; and
storing the determined statistical norm in a non-volatile memory.

2. The method according to claim 1, wherein at least one stream of training data is aggregated and/or filtered prior to characterizing the joint statistical properties of the plurality of streams of data representing the sensor readings over the range of states of the system during the training phase.

3. The method according to claim 1, further comprising:
communicating the captured plurality of streams of training data representing sensor readings over a range of states of the system during a training phase from an edge device to a cloud device prior to the cloud device characterizing the joint statistical property of the plurality of streams of operational data;
communicating the determined statistical norm from the cloud device to the edge device; and
wherein the non-volatile memory is provided within the edge device.

4. The method according to claim 3, further comprising:
capturing a plurality of streams of operational data representing sensor readings during an operational phase;
determining a plurality of quantitative standardized errors between a predicted value of a respective operational datum, and a measured value of the respective training datum, and a variance of the respective plurality of quantitative standardized errors over time in the edge device; and
comparing the plurality of quantitative standardized errors and the variance of the respective plurality of quantitative standardized errors with the determined statistical norm, to determine whether the plurality of streams of operational data representing the sensor readings during the operational phase represent an anomalous state of system operation.

5. The method according to claim 1, further comprising determining an anomalous state of operation based on a statistical difference between sensor data obtained during operation of the system subsequent to the training phase and the statistical norm.

6. The method according to claim 5, further comprising performing an analysis on the sensor data obtained during the anomalous state, defining a signature of the sensor data obtained leading to the anomalous state, and communicating the defined signature of the sensor data obtained leading to the anomalous state to a second system.

7. The method according to claim 6, further comprising receiving a defined signature of sensor data obtained leading to an anomalous state of a second system from the second system and performing a signature analysis of a stream of sensor data after the training phase.

8. The method according to claim 6, further comprising receiving a defined signature of sensor data obtained leading to an anomalous state of a second system from the second system, and integrating the defined signature with the determined statistical norm, such that the statistical norm is updated to distinguish a pattern of sensor data preceding the anomalous state from a normal state of operation.

9. The method according to claim 1, further comprising determining a z-score for the plurality of quantitative standardized errors.

10. The method according to claim 1, further comprising at least one of:
transmitting the plurality of streams of training data to a remote server;
transmitting the characterized joint statistical properties to the remote server;
transmitting the statistical norm to the remote server;
transmitting a signal representing a determination whether the system is operating anomalously to the remote server based on the statistical norm;
receiving the characterized joint statistical properties from the remote server;
receiving the statistical norm from the remote server;
receiving a signal representing a determination whether the system is operating anomalously from the remote server based on the statistical norm; and
receiving a signal from the remote server representing a predicted statistical norm for operation of the system, representing a type of operation of the system outside the range of states during the training phase, based on respective statistical norms for other systems.

11. The method according to claim 1, further comprising:
receiving a stream of sensor data received after the training phase;
determining an anomalous state of operation of the system based on differences between the received stream of sensor data received after the training phase;
and tagging a log of sensor data received after the training phase with an annotation of anomalous state of operation.

12. The method according to claim 11, further comprising classifying the anomalous state of operation.

13. The method according to claim 1, further comprising classifying a stream of sensor data received after the training phase by at least performing a k-nearest neighbors analysis.

14. The method according to claim 1, further comprising determining whether a stream of sensor data received after the training phase is in a stable operating state and tagging a log of the stream of sensor data with a characterization of the stability.

15. The method according to claim 1, wherein the joint statistical properties are first joint statistical properties, the training phase is first training phase, and the statistical norm is first statistical norm, the method further comprising:
in response to detecting a threshold number of false positive cases of anomalous state of the system based, at least in part, on the first statistical norm:
determining second joint statistical properties of a plurality of streams of data representing sensor readings over the range of states of the system during second training phase;
determining second statistical norm for the second joint statistical properties that distinguishes between the normal state of the system and the anomalous state of the system; and
storing the determined second statistical norm in a non-volatile memory.

16. The method according to claim 15, wherein the first joint statistical properties are determined in accordance with a first statistical model and the second joint statistical properties are determined in accordance with a second statistical model.

17. The method according to claim 16, further comprising generating a plurality of statistical models for a plurality of streams of data representing sensor readings over the range of states of the system that are obtained during a time window overlapping with one or more anomalous states predicted based, at least in part, on the first statistic norm.

18. The method according to claim 17, further comprising selecting the second statistical model from the plurality of models based on at least one of false positive rate, true positive rate, or lead time.

19. A system for determining anomalous operational state, comprising:
an input port configured to receive a plurality of streams of training data representing sensor readings over a range of states of the system during a training phase;
at least one automated processor, configured to:
characterize joint statistical properties of plurality of streams of data representing sensor readings over the range of states of the system during the training phase, based on a plurality of quantitative standardized errors between a predicted value of a respective training datum, and a measured value of the respective training datum, and a variance of the respective plurality of quantitative standardized errors over time; and
determine a statistical norm for the characterized joint statistical properties that reliably distinguishes between a normal state of the system and an anomalous state of the system; and
a non-volatile memory configured to store the determined statistical norm.

20. The system according to claim 19, wherein the at least one automated processor is further configured to:
capture a plurality of streams of operational data representing sensor readings during an operational phase;
characterize a joint statistical property of the plurality of streams of operational data, comprising determining a plurality of quantitative standardized errors between a predicted value of a respective operational datum, and a measured value of the respective training datum, and a variance of the respective plurality of quantitative standardized errors over time; and
compare the characterized joint statistical property of the plurality of streams of operational data with the determined statistical norm to determine whether the plurality of streams of operational data representing the sensor readings during the operational phase represent an anomalous state of system operation.

21. The system according to claim 19, wherein the at least one automated processor is further configured to:
capture a plurality of streams of operational data representing sensor readings during an operational phase; and
determine at least one of a Mahalanobis distance, a Bhattacharyya distance, Chernoff distance, a Matusita distance, a KL divergence, a Symmetric KL divergence, a Patrick-Fisher distance, a Lissack-Fu distance, a Kolmogorov distance, or a Mahalanobis angle of the captured plurality of streams of operational data with respect to the determined statistical norm.

22. The system according to claim 19, wherein the at least one automated processor is further configured to determine a Mahalanobis distance between the plurality of streams of training data representing sensor readings over the range of states of the system during the training phase and a captured plurality of streams of operational data representing sensor readings during an operational phase of the system.

23. The system according to claim 19, wherein the at least one automated processor is further configured to determine a Bhattacharyya distance between the plurality of streams of training data representing sensor readings over the range of states of the system during the training phase and a captured plurality of streams of operational data representing sensor readings during an operational phase of the system.

24. The system according to claim 19, wherein the at least one automated processor is further configured to determine a z-score for a stream of sensor data received after the training phase.

25. The system according to claim 19, wherein the at least one automated processor is further configured to decimate a stream of sensor data received after the training phase.

26. The system according to claim 19, wherein the at least one automated processor is further configured to decimate and determine a z-score for a stream of sensor data received after the training phase.

27. The system according to claim 19, wherein the plurality of streams of training data representing the sensor readings over the range of states of the system comprise data from a plurality of different types of sensors.

28. The system according to claim 19, wherein the plurality of streams of training data representing the sensor readings over the range of states of the system comprise data from a plurality of different sensors of the same type.

29. A method of determining a statistical norm for non-anomalous operation of a system, comprising:
receiving a plurality of captured streams of training data at a remote server, the captured plurality of streams of training data representing sensor readings over a range of states of a system during a training phase;
processing the received a plurality of captured streams of training data to determine a statistical norm for characterized joint statistical properties that reliably distinguishes between a normal state of the system and an anomalous state of the system, the characterized joint statistical properties being based on a plurality of streams of data representing sensor readings over the range of states of the system during the training phase, comprising quantitative standardized errors between a predicted value of a respective training datum, and a measured value of the respective training datum, and a variance of the respective plurality of quantitative standardized errors over time; and
transmitting the determined statistical norm to the system.

30. The method according to claim 29, further comprising, at the system, capturing a stream of data representing sensor readings over states of the system during an operational phase, and producing a signal selectively dependent on whether the stream of data representing sensor readings over states of the system during the operational phase are within the statistical norm.
